(19) United States
(12) Patent Application Publication
(10) Pub. No.: US 2017/0058160 A1
(43) Pub. Date: Mar. 2, 2017

(54) LIQUID CRYSTAL DISPLAY DEVICE

(71) Applicant: DIC Corporation (Tokyo), Tokyo (JP)

(72) Inventors: Yoshiyuki ONO, Kita-adachi-gun (JP); Jouji KAWAMURA, Kita-adachi-gun (JP); Yoshinori IWASHITA, Kita-adachi-gun (JP); Hiroyuki TAKEDA, Sakura-shi (JP)

(73) Assignee: DIC CORPORATION (TOKYO), Tokyo (JP)

(21) Appl. No.: 15/307,637

(22) PCT Filed: Jul. 23, 2014
(86) PCT No.: PCT/JP2014/069411

§ 371 Date: Oct. 28, 2016

(51) Int. Cl. C09J 163/10; C08G 59/17; C08G 59/14; G02F 1/1333; C09J 135/02; C09K 19/30; C09K 19/32; G02F 1/1339; C08F 220/18; C09J 133/10

(52) U.S. Cl. CPC C09J 163/10; C08F 220/18; C08G 59/1466; C08G 59/1477; C09J 133/10; C09J 135/02; C09K 19/3003; C09K 19/3066; C09K 19/322; G02F 1/1339; G02F 1/133365; C08F 2220/1825; C09K 2019/3004; C09K 2019/3009; C09K 2019/301; C09K 2019/3016

(57) ABSTRACT

The present invention relates to a liquid crystal display device including a particular liquid crystal composition and a cured product of a particular curable resin composition serving as a sealant.

The present invention provides a liquid crystal display device that does not suffer from a decrease in the voltage holding ratio (VHR) or increase in the ion density (ID) of the liquid crystal layer or the problem of display defects such as white spots, alignment unevenness, and image-sticking.

Since the liquid crystal display device according to the present invention does not suffer from a decrease in the voltage holding ratio (VHR) of the liquid crystal layer or display defects such as alignment unevenness and image-sticking, the liquid crystal display device is particularly useful as an active-matrix-driven liquid crystal display device such as a VA, PSVA, IPS, or FFS liquid crystal display device and can be used as a liquid crystal display device for products such as liquid crystal display televisions, monitors, cell phones, and smartphones.

### TECHNICAL FIELD

The present invention relates to liquid crystal display devices.

### BACKGROUND ART

Liquid crystal display devices are used in various products, including clocks, calculators, household electrical appliances, measuring instruments, automotive instrument panels, word processors, electronic organizers, printers, computers, and televisions. Typical types of liquid crystal display devices include twisted nematic (TN), super-twisted nematic (STN), dynamic scattering (DS), guest-host (GH), in-plane switching (IPS), optically compensated birefringence (OCB), electrically controlled birefringence (ECB), vertically aligned (VA), color super-homeotropic (CSH), and ferroelectric liquid crystal (FLC) display devices. Whereas conventional liquid crystal display devices are statically driven, multiplexed liquid crystal display devices are now in widespread use, including passive-matrix display devices and, more recently, active-matrix (AM) display devices, which are driven by elements such as thin-film transistors (TFTs) and thin-film diodes (TFDs).

One of the widely used methods for manufacturing liquid crystal display devices is one-drop filling using photocurable, thermally curable sealants. This method begins by forming a rectangular seal pattern on one of two transparent substrates having electrodes thereon by dispensing or screen printing. Small droplets of liquid crystal are then dispensed over the entire area within the frame pattern of the uncured sealant on the transparent substrate, immediately followed by laminating the other transparent substrate and pre-curing the sealant by exposure to UV radiation. The sealant is then post-cured by heating during the annealing of the liquid crystal to produce a liquid crystal display device. The substrates can be laminated together under reduced pressure, which allows the liquid crystal display device to be significantly efficiently manufactured.

However, if a photocurable, thermally curable sealant is used in a small liquid crystal display panel, a seal pattern formed of the sealant overlaps complicated metal wiring and a black matrix. This leaves an unexposed area that has not been exposed to light for pre-curing. In this area, the uncured sealant may dissolve into and contaminate the liquid crystal during the process from light exposure to thermal curing. Recent liquid crystal display panels for low-power applications such as mobile applications tend to include liquid crystals with low driving voltages (low-voltage liquid crystals). Since low-voltage liquid crystals have high dielectric anisotropy, they have a problem in that they are readily contaminated with residues such as unreacted polymerization initiator and curing agent, ionic impurities such as chlorine, and other impurities such as silane coupling agents present in the sealant. These impurities disturb the alignment and decrease the voltage holding ratio over time.

Accordingly, thermally curable sealants for one-drop filling that require no pre-curing by light exposure have been proposed. However, conventional thermally curable sealants have a problem in that the viscosity of the resin used as a raw material decreases upon heating. This results in partial deformation of the seal pattern and dissolution of the sealant components into the liquid crystal and thus decreases the electrical characteristics of the liquid crystal display device.

To reduce the dissolution of the sealant components into the liquid crystal material, it has been proposed to increase the softening point of the epoxy resin present in the sealant to reduce the contamination of the liquid crystal material due to contact with uncured sealant, thereby reducing color unevenness (PTL 1).

Although epoxy resins generally have high adhesion, they tend to contaminate liquid crystal materials. One solution to this problem is to reduce the contamination of a liquid crystal material by acrylic modification. This technique is expected to reduce the contamination of the liquid crystal material while improving the adhesion. However, acrylic modification may decrease the thermal curability and may thus result in contamination of the liquid crystal material due to dissolution of the sealant components. Accordingly, it has also been proposed to add a tertiary amine, such as imidazole, for curing the acrylic component while adding a small amount of epoxy resin, thereby thermally curing the acrylic resin through the interaction with the epoxy resin (PTL 2).

Conventional thermally curable sealants also have a problem in that the viscosity of the resin used as a raw material decreases upon heating. This results in partial deformation of the seal pattern and leakage of the liquid crystal outside the seal pattern. Accordingly, a composition with improved curability without a decrease in adhesion to substrates has been proposed (PTL 3).

However, the foregoing proposals assume common liquid crystal materials and focus only on the compositions of sealants; that is, they are intended to avoid the problems by modifying the compositions of sealants. These proposals often fail to achieve good display characteristics when applied to specific liquid crystal display devices. In particular, these proposals are not sufficiently effective in reducing image-sticking of liquid crystal display devices.

### CITATION LIST

### Patent Literature

PTL 1: Japanese Unexamined Patent Application Publication No. 2006-23582

PTL 2: Japanese Unexamined Patent Application Publication No. 2008-116825

PTL 3: Japanese Unexamined Patent Application Publication No. 2009-175180

### SUMMARY OF INVENTION

### Technical Problem

The present invention focuses on the interaction between the compositions of liquid crystal materials and sealants, which has not been sufficiently explored in the art, and proposes a combination of a liquid crystal composition and a sealant composition that provides a liquid crystal display device with improved characteristics such as reduced image-sticking.

Specifically, the present invention provides a liquid crystal display device including a particular liquid crystal composition and a cured product of a particular curable resin composition serving as a sealant. This liquid crystal display device has a practical liquid crystal layer temperature limit, a large absolute value of dielectric anisotropy (Δ∈), a low viscosity, and a suitable refractive index anisotropy (Δn) and does not suffer from a decrease in the voltage holding ratio (VHR) of the liquid crystal layer or the problem of display defects such as white spots, alignment unevenness, and image-sticking.

### Solution to Problem

To solve the foregoing problems, the inventors have conducted extensive research on various combinations of curable resin compositions for sealants and liquid crystal materials for liquid crystal layers. As a result, the inventors have discovered that a liquid crystal display device including a liquid crystal material having a particular structure and a cured product of a particular curable resin composition serving as a sealant does not suffer from a decrease in the voltage holding ratio (VHR) of the liquid crystal layer or the problem of display defects such as white spots, alignment unevenness, and image-sticking. This discovery has led to the present invention.

Specifically, the present invention provides a liquid crystal display device including a first substrate, a second substrate, a liquid crystal layer containing a liquid crystal composition between the first and second substrates, and a sealant joining together the first and second substrates. The sealant is a cured product of a thermally curable resin composition. The liquid crystal composition contains 10% to 50% by weight of a compound represented by general formula (I).

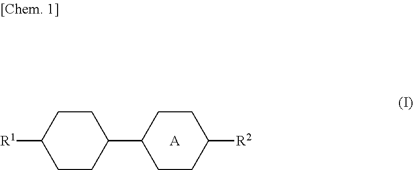

In the formula, R¹ and R² are each independently an alkyl group of 1 to 8 carbon atoms, an alkenyl group of 2 to 8 carbon atoms, an alkoxy group of 1 to 8 carbon atoms, or an alkenyloxy group of 2 to 8 carbon atoms; and A is 1,4-phenylene or trans-1,4-cyclohexylene. The liquid crystal composition further contains 35% to 80% by weight of a compound represented by general formula (II).

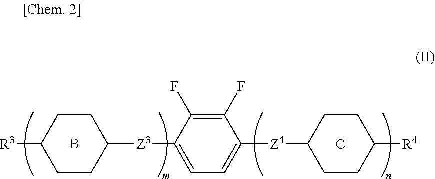

In the formula, R³ and R⁴ are each independently an alkyl group of 1 to 8 carbon atoms, an alkenyl group of 2 to 8 carbon atoms, an alkoxy group of 1 to 8 carbon atoms, or an alkenyloxy group of 2 to 8 carbon atoms; Z³ and Z⁴ are each independently a single bond, —CH═CH—, —C═C—, —CH₂CH₂—, —(CH₂)₄—, —COO—, —OCO—, —OCH₂—, —CH₂O—, —OCF₂—, or —CF₂O—; B and C are each independently optionally fluorinated 1,4-phenylene or trans-1,4-cyclohexylene; and m and n are each independently an integer of 0 to 4, where m+n=1 to 4. The curable resin composition contains a compound containing at least one epoxy group per molecule and having a weight average molecular weight of 300 to 10,000.

### Advantageous Effects of Invention

The liquid crystal display device according to the present invention, which includes a particular liquid crystal composition and a cured product of a particular curable resin composition serving as a sealant, has a practical liquid crystal layer temperature limit, a large absolute value of dielectric anisotropy (Δ∈), a low viscosity, and a suitable refractive index anisotropy (Δn) and does not suffer from a decrease in the voltage holding ratio (VHR) of the liquid crystal layer or display defects such as white spots, alignment unevenness, and image-sticking.

### BRIEF DESCRIPTION OF DRAWINGS

FIG. 1 is a plan view of a liquid crystal display device according to the present invention.

FIG. 2 is an enlarged view of the liquid crystal display device according to the present invention.

### REFERENCE SIGNS LIST

1 substrate
2 sealant
3 liquid crystal
4 driver
5 wiring line from pixel electrode
6 overcoat layer
7 pixel electrode or wiring line
8 alignment layer

### DESCRIPTION OF EMBODIMENTS

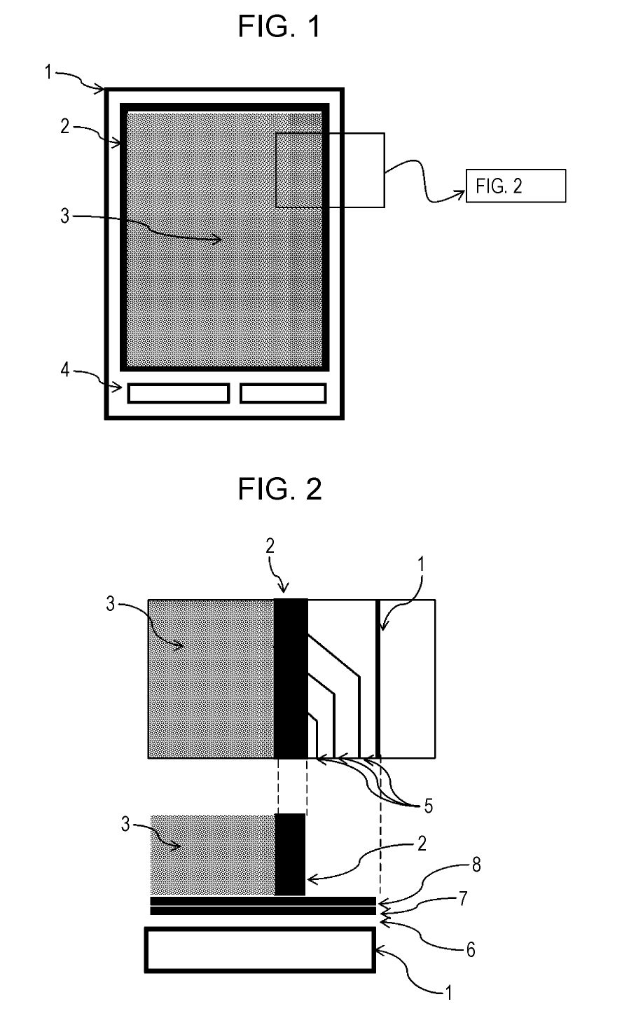

FIG. 1 is a plan view of a liquid crystal display device according to the present invention, where details such as pixel electrodes, TFTs, and wiring lines are not shown. The upper view of FIG. 2 is a partial enlarged view of the plan view, showing that wiring lines extend under a sealant from pixel electrodes to a driver. The lower view of FIG. 2 is a sectional view of the upper view of FIG. 2. The sealant contacts a liquid crystal and an alignment layer. Although not all situations are shown in the drawings, the sealant or the liquid crystal may contact the wiring lines or an overcoat layer depending on the position of the sealant.

### Liquid Crystal Layer

The liquid crystal layer of the liquid crystal display device according to the present invention is formed of a liquid crystal composition containing 10% to 50% by weight of a compound represented by general formula (I).

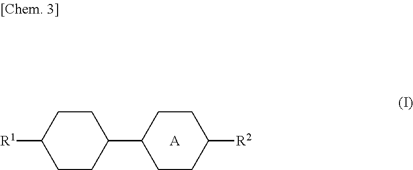

In the formula, R¹ and R² are each independently an alkyl group of 1 to 8 carbon atoms, an alkenyl group of 2 to 8 carbon atoms, an alkoxy group of 1 to 8 carbon atoms, or an alkenyloxy group of 2 to 8 carbon atoms; and A is 1,4-phenylene or trans-1,4-cyclohexylene. The liquid crystal composition further contains 35% to 80% by weight of a compound represented by general formula (II):

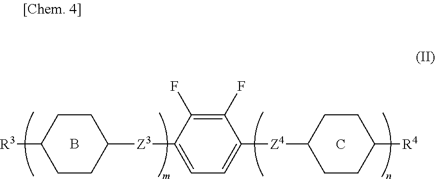

In the formula, R³ and R⁴ are each independently an alkyl group of 1 to 8 carbon atoms, an alkenyl group of 2 to 8 carbon atoms, an alkoxy group of 1 to 8 carbon atoms, or an alkenyloxy group of 2 to 8 carbon atoms; Z³ and Z⁴ are each independently a single bond, —CH═CH—, —C═C—, —CH₂CH₂—, —(CH₂)₄—, —COO—, —OCO—, —OCH₂—, —CH₂O—, —OCF₂—, or —CF₂O—; B and C are each independently optionally fluorinated 1,4-phenylene or trans-1,4-cyclohexylene; and m and n are each independently an integer of 0 to 4, wherein m+n=1 to 4.

The compound represented by general formula (I) is present in the liquid crystal layer of the liquid crystal display device according to the present invention in an amount of 10% to 50% by weight, preferably 15% to 48% by weight, more preferably 20% to 46% by weight.

In general formula (I), R¹ and R² are each independently an alkyl group of 1 to 8 carbon atoms, an alkenyl group of 2 to 8 carbon atoms, an alkoxy group of 1 to 8 carbon atoms, or an alkenyloxy group of 2 to 8 carbon atoms. If A is trans-1,4-cyclohexylene, R¹ and R² are each preferably an alkyl group of 1 to 5 carbon atoms, an alkenyl group of 2 to 5 carbon atoms, an alkoxy group of 1 to 5 carbon atoms, or an alkenyloxy group of 2 to 5 carbon atoms, more preferably an alkyl group of 2 to 5 carbon atoms, an alkenyl group of 2 to 4 carbon atoms, an alkoxy group of 1 to 4 carbon atoms, or an alkenyloxy group of 2 to 4 carbon atoms. R¹ is preferably an alkyl group, more preferably an alkyl group of 2, 3, or 4 carbon atoms. If R¹ is an alkyl group of 3 carbon atoms, R² is preferably an alkyl group of 2, 4, or 5 carbon atoms or an alkenyl group of 2 or 3 carbon atoms, more preferably an alkyl group of 2 carbon atoms.

If A is 1,4-phenylene, R¹ and R² are each preferably an alkyl group of 1 to 5 carbon atoms, an alkenyl group of 4 or 5 carbon atoms, an alkoxy group of 1 to 5 carbon atoms, or an alkenyloxy group of 3 to 5 carbon atoms, more preferably an alkyl group of 2 to 5 carbon atoms, an alkenyl group of 4 or 5 carbon atoms, an alkoxy group of 1 to 4 carbon atoms, or an alkenyloxy group of 2 to 4 carbon atoms. R¹ is preferably an alkyl group, more preferably an alkyl group of 1, 3, or 5 carbon atoms. R² is preferably an alkoxy group of 1 or 2 carbon atoms.

Preferably, compounds represented by general formula (I) where at least one of R¹ and R² is an alkyl group of 3 to 5 carbon atoms are present in an amount of 50% by weight or more, more preferably 70% by weight or more, even more preferably 80% by weight or more, of all the compounds represented by general formula (I). Preferably, compounds represented by general formula (I) where at least one of R¹ and R² is an alkyl group of 3 carbon atoms are present in an amount of 50% by weight or more, more preferably 70% by weight or more, even more preferably 80% by weight or more, most preferably 100% by weight, of all the compounds represented by general formula (I).

The liquid crystal composition may contain one or more compounds represented by general formula (I), preferably at least one compound where A is trans-1,4-cyclohexylene and at least one compound where A is 1,4-phenylene.

Preferably, compounds represented by general formula (I) where A is trans-1,4-cyclohexylene are present in an amount of 50% by weight or more, more preferably 70% by weight or more, even more preferably 80% by weight or more, of all the compounds represented by general formula (I).

Specific preferred compounds represented by general formula (I) include compounds represented by general formulas (Ia) to (Ik) below.

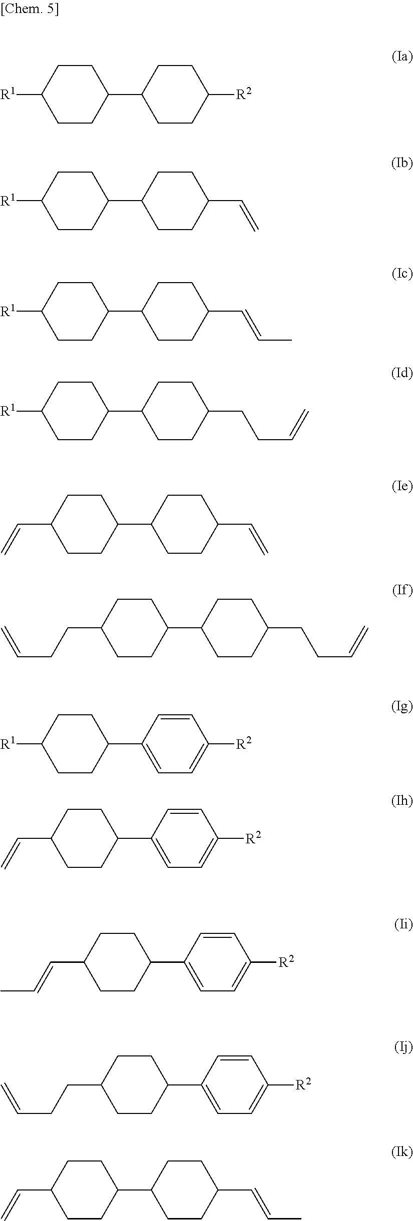

In the formulas, R¹ and R² are each independently an alkyl group of 1 to 5 carbon atoms or an alkoxy group of 1 to 5 carbon atoms, preferably as defined for R¹ and R², respectively, in general formula (I).

Preferred among general formulas (Ia) to (Ik) are general formulas (Ia), (Ib), (Ic), and (Ig), more preferably general formulas (Ia), (Ib), and (Ic), even more preferably general formulas (Ia) and (Ib). General formulas (Ib) and (Ic) are preferred to achieve a faster response time, and it is more preferred to use a combination of general formulas (Ib) and (Ic). General formula (Ia) is preferred to achieve a higher reliability.

With these points in mind, compounds represented by general formulas (Ia), (Ib), and (Ic) are preferably present in an amount of 80% by weight or more, more preferably 90% by weight or more, even more preferably 95% by weight or more, most preferably 100% by weight, of all the compounds represented by general formula (I). Preferably, compounds represented by general formula (Ia) are present in an amount of 65% to 100% by weight of all the compounds represented by general formula (I), and compounds represented by general formulas (Ib) and (Ic) are present in an amount of 0% to 35% by weight of all the compounds represented by general formula (I). Also preferably, compounds represented by general formula (Ia) are present in an amount of 0% to 10% by weight of all the compounds represented by general formula (I), and compounds represented by general formulas (Ib) and (Ic) are present in an amount of 90% to 100% by weight of all the compounds represented by general formula (I).

The compound represented by general formula (II) is present in the liquid crystal layer of the liquid crystal display device according to the present invention in an amount of 35% to 80% by weight, preferably 40% to 75% by weight, more preferably 45% to 70% by weight.

In general formula (II), R³ is an alkyl group of 1 to 8 carbon atoms, an alkenyl group of 2 to 8 carbon atoms, an alkoxy group of 1 to 8 carbon atoms, or an alkenyloxy group of 2 to 8 carbon atoms. Preferably, R³ is an alkyl group of 1 to 5 carbon atoms or an alkenyl group of 2 to 5 carbon atoms, more preferably an alkyl group of 2 to 5 carbon atoms or an alkenyl group of 2 to 4 carbon atoms, even more preferably an alkyl group of 3 to 5 carbon atoms or an alkenyl group of 2 or 3 carbon atoms, still more preferably an alkyl group of 2 or 3 carbon atoms or an alkenyl group of 2 carbon atoms, most preferably an alkyl group of 2 or 3 carbon atoms.

R⁴ is an alkyl group of 1 to 8 carbon atoms, an alkenyl group of 4 to 8 carbon atoms, an alkoxy group of 1 to 8 carbon atoms, or an alkenyloxy group of 3 to 8 carbon atoms. Preferably, R⁴ is an alkyl group of 1 to 5 carbon atoms or an alkoxy group of 1 to 5 carbon atoms, more preferably an alkyl group of 1 to 3 carbon atoms or an alkoxy group of 1 to 4 carbon atoms, even more preferably an alkoxy group of 2 to 4 carbon atoms. Z³ and Z⁴ are each independently a single bond, —CH═CH—, —C═C—, —CH₂CH₂—, —(CH₂)₄—, —COO—, —OCO—, —OCH₂—, —CH₂O—, —OCF₂—, or —CF₂O—. Preferably, Z³ and Z⁴ are each a single bond, —CH₂CH₂—, —COO—, —OCH₂—, —CH₂O—, —OCF₂—, or —CF₂O—, more preferably a single bond or —CH₂O—.

m and n are preferably each independently an integer of 0 to 3, more preferably an integer of 0 to 2, and m+n is preferably 1 to 3, more preferably 1 or 2.

The liquid crystal layer of the liquid crystal display device according to the present invention may contain three to ten, preferably four to nine, even more preferably five to eight, compounds represented by general formula (II).

Preferred compounds represented by general formula (II) include compounds represented by general formulas (II-1) and (II-2) below.

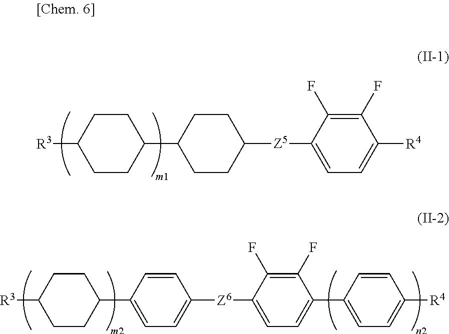

In the formulas, R³ and R⁴ are each independently an alkyl group of 1 to 8 carbon atoms, an alkenyl group of 2 to 8 carbon atoms, an alkoxy group of 1 to 8 carbon atoms, or an alkenyloxy group of 2 to 8 carbon atoms; Z⁵ and Z⁶ are each independently a single bond, —CH═CH—, —C═C—, —CH₂CH₂—, —(CH₂)₄—, —COO—, —OCO—, —OCH₂—, —CH₂O—, —OCF₂—, or —CF₂O—; and m1, m2, and n2 are each independently 0 or 1.

In general formula (II-1), R³ is preferably an alkyl group of 1 to 5 carbon atoms or an alkenyl group of 2 to 5 carbon atoms, more preferably an alkyl group of 2 to 5 carbon atoms or an alkenyl group of 2 to 4 carbon atoms, even more preferably an alkyl group of 3 to 5 carbon atoms or an alkenyl group of 2 carbon atoms, still more preferably an alkyl group of 3 carbon atoms. R⁴ is preferably an alkyl group of 1 to 5 carbon atoms or an alkoxy group of 1 to 5 carbon atoms, more preferably an alkyl group of 1 to 3 carbon atoms or an alkoxy group of 1 to 3 carbon atoms, even more preferably an alkyl group of 3 carbon atoms or an alkoxy group of 2 carbon atoms, still more preferably an alkoxy group of 2 carbon atoms. Z⁵ is preferably a single bond, —CH₂CH₂—, —COO—, —OCH₂—, —CH₂O—, —OCF₂—, or —CF₂O—, more preferably a single bond or —CH₂O—.

The compound represented by general formula (II-1) is preferably present in the liquid crystal layer of the liquid crystal display device according to the present invention in an amount of 15% to 60% by weight, more preferably 17% to 50% by weight, even more preferably 18% to 40% by weight, still more preferably 19% to 30% by weight.

The liquid crystal layer of the liquid crystal display device according to the present invention may contain one or more, preferably one to six, even more preferably two to five, still more preferably three or four, compounds represented by general formula (II-1).

In general formula (II-2), R³ is preferably an alkyl group of 1 to 5 carbon atoms or an alkenyl group of 2 to 5 carbon atoms, more preferably an alkyl group of 2 to 5 carbon atoms or an alkenyl group of 2 to 4 carbon atoms, even more preferably an alkyl group of 3 to 5 carbon atoms or an alkenyl group of 2 carbon atoms, still more preferably an alkyl group of 2 or 3 carbon atoms. R⁴ is preferably an alkyl group of 1 to 5 carbon atoms or an alkoxy group of 1 to 5 carbon atoms, more preferably an alkyl group of 1 to 3 carbon atoms or an alkoxy group of 1 to 3 carbon atoms, even more preferably an alkyl group of 3 carbon atoms or an alkoxy group of 2 carbon atoms. Z⁶ is preferably a single bond, —CH₂CH₂—, —COO—, —OCH₂—, —CH₂O—, —OCF₂—, or —CF₂O—, more preferably a single bond or —CH₂O—.

The compound represented by general formula (II-2) is preferably present in the liquid crystal layer of the liquid crystal display device according to the present invention in an amount of 10% to 50% by weight, more preferably 15% to 45% by weight, even more preferably 20% to 40% by weight, still more preferably 25% to 35% by weight.

The liquid crystal layer of the liquid crystal display device according to the present invention may contain one or more, preferably one to six, even more preferably two to five, still more preferably three or four, compounds represented by general formula (II-2).

Specific preferred compounds represented by general formula (II-1) include compounds represented by general formulas (II-1a) to (II-1d) below.

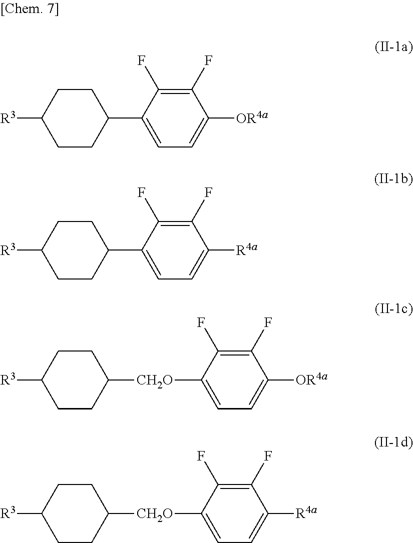

In the formulas, R³ is an alkyl group of 1 to 5 carbon atoms or an alkenyl group of 2 to 5 carbon atoms, and R^{4a} is an alkyl group of 1 to 5 carbon atoms.

In general formulas (II-1a) and (II-1c), R³ is preferably as defined in general formula (II-1). R^{4a} is preferably an alkyl group of 1 to 3 carbon atoms, more preferably an alkyl group of 1 or 2 carbon atoms, even more preferably an alkyl group of 2 carbon atoms.

In general formulas (II-1b) and (II-1d), R³ is preferably as defined in general formula (II-1). R^{4a} is preferably an alkyl group of 1 to 3 carbon atoms, more preferably an alkyl group of 1 or 3 carbon atoms, even more preferably an alkyl group of 3 carbon atoms.

Among general formulas (II-1a) to (II-1d), general formulas (II-1a) and (II-1c) are preferred, more preferably general formula (II-1a), to achieve a larger absolute value of dielectric anisotropy.

The liquid crystal layer of the liquid crystal display device according to the present invention preferably contains one or more, more preferably one or two, compounds represented by any of general formulas (II-1a) to (II-1d), even more preferably one or two compounds represented by general formula (II-1a).

Other specific preferred compounds represented by general formula (II-1) include compounds represented by general formulas (II-1e) to (II-1h) below.

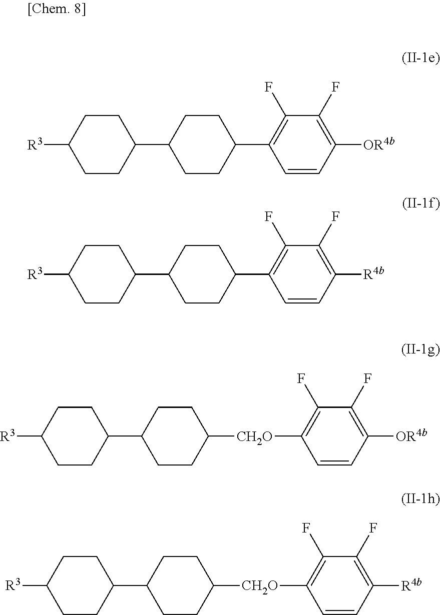

In the formulas, R³ is an alkyl group of 1 to 5 carbon atoms or an alkenyl group of 2 to 5 carbon atoms, and R^{4b} is an alkyl group of 1 to 5 carbon atoms.

In general formulas (II-1e) and (II-1g), R³ is preferably as defined in general formula (II-1). R^{4b} is preferably an alkyl group of 1 to 3 carbon atoms, more preferably an alkyl group of 1 or 2 carbon atoms, even more preferably an alkyl group of 2 carbon atoms.

In general formulas (II-1f) and (II-1h), R³ is preferably as defined in general formula (II-1). R^{4b} is preferably an alkyl group of 1 to 3 carbon atoms, more preferably an alkyl group of 1 or 3 carbon atoms, even more preferably an alkyl group of 3 carbon atoms.

Among general formulas (II-1e) to (II-1h), general formulas (II-1e) and (II-1g) are preferred to achieve a larger absolute value of dielectric anisotropy.

Specific preferred compounds represented by general formula (II-2) include compounds represented by general formulas (II-2a) to (II-2d) below.

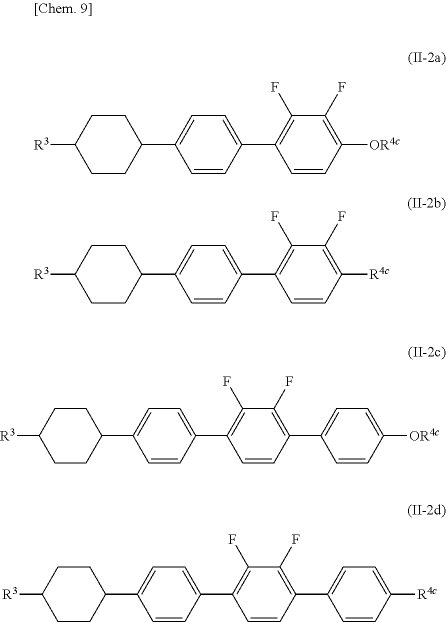

In the formulas, R³ is an alkyl group of 1 to 5 carbon atoms or an alkenyl group of 2 to 5 carbon atoms, and R^{4c} is an alkyl group of 1 to 5 carbon atoms. Preferably, R³ and R^{4c} are as defined for R³ and R⁴, respectively, in general formula (II-2).

In general formulas (II-2a) and (II-2c), R³ is preferably as defined in general formula (II-2). R^{4c} is preferably an alkyl group of 1 to 3 carbon atoms, more preferably an alkyl group of 1 or 2 carbon atoms, even more preferably an alkyl group of 2 carbon atoms.

In general formulas (II-2b) and (II-2d), R³ is preferably as defined in general formula (II-2). R^{4c} is preferably an alkyl group of 1 to 3 carbon atoms, more preferably an alkyl group of 1 or 3 carbon atoms, even more preferably an alkyl group of 3 carbon atoms.

Among general formulas (II-2a) to (II-2d), general formula (II-2a) and (II-2c) are preferred, more preferably general formula (II-2a), to achieve a larger absolute value of dielectric anisotropy.

Other specific preferred compounds represented by general formula (II-2) include compounds represented by general formulas (II-2e) to (II-2j) below.

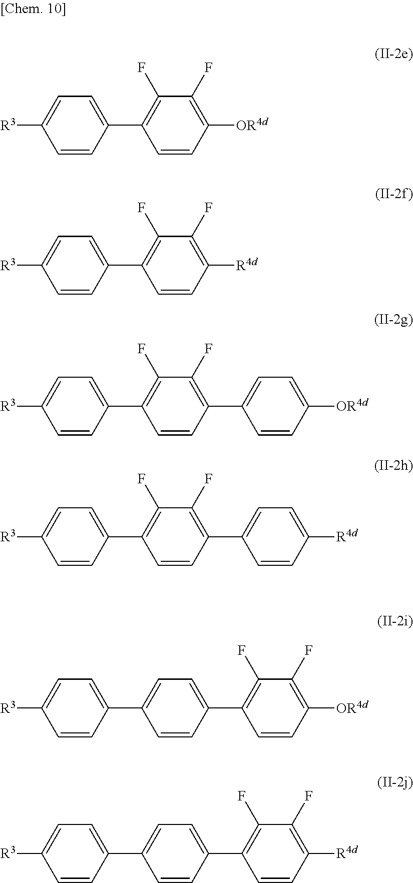

In the formulas, R³ is an alkyl group of 1 to 5 carbon atoms or an alkenyl group of 2 to 5 carbon atoms, and R^{4d} is an alkyl group of 1 to 5 carbon atoms. Preferably, R³ and R^{4d} are as defined for R³ and R⁴, respectively, in general formula (II-2).

In general formulas (II-2e), (II-2g), and (II-2i), R³ is preferably as defined in general formula (II-2). R^{4d} is preferably an alkyl group of 1 to 3 carbon atoms, more preferably an alkyl group of 1 or 2 carbon atoms, even more preferably an alkyl group of 2 carbon atoms.

In general formulas (II-2f), (II-2h), and (II-2j), R³ is preferably as defined in general formula (II-2). R^{4d} is preferably an alkyl group of 1 to 3 carbon atoms, more preferably an alkyl group of 1 or 3 carbon atoms, even more preferably an alkyl group of 2 carbon atoms.

Among general formulas (II-2e) to (II-2i), general formulas (II-2e) and (II-2h) are preferred.

The compounds represented by general formula (I) and (II) are preferably present in the liquid crystal layer of the liquid crystal display device according to the present invention in a total amount of 75% to 100% by weight, more preferably 80% to 100% by weight, even more preferably 85% to 100% by weight, still more preferably 90% to 100% by weight, most preferably 95% to 100% by weight.

The liquid crystal layer of the liquid crystal display device according to the present invention may further contain a compound represented by general formula (III).

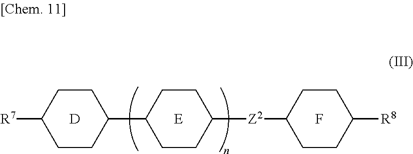

In the formula, R⁷ and R⁸ are each independently an alkyl group of 1 to 8 carbon atoms, an alkenyl group of 2 to 8 carbon atoms, an alkoxy group of 1 to 8 carbon atoms, or an alkenyloxy group of 2 to 8 carbon atoms; D, E, and F are each independently optionally fluorinated 1,4-phenylene or trans-1,4-cyclohexylene; Z² is a single bond, —OCH₂—, —OCO—, —CH₂O—, —COO—, or —OCO—; and n is 0, 1, or 2, with the proviso that compounds represented by general formulas (I), (II-1), and (II-2) are excluded.

The compound represented by general formula (III) is preferably present in an amount of 1% to 20%, more preferably 2% to 15%, even more preferably 4% to 10%.

In general formula (III), R⁷ is an alkyl group of 1 to 8 carbon atoms, an alkenyl group of 2 to 8 carbon atoms, an alkoxy group of 1 to 8 carbon atoms, or an alkenyloxy group of 2 to 8 carbon atoms. If D is trans-1,4-cyclohexylene, R⁷ is preferably an alkyl group of 1 to 5 carbon atoms or an alkenyl group of 2 to 5 carbon atoms, more preferably an alkyl group of 2 to 5 carbon atoms or an alkenyl group of 2 to 4 carbon atoms, even more preferably an alkyl group of 3 to 5 carbon atoms or an alkenyl group of 2 or 3 carbon atoms, still more preferably an alkyl group of 3 carbon atoms. If D is optionally fluorinated 1,4-phenylene, R⁷ is preferably an alkyl group of 1 to 5 carbon atoms or an alkenyl group of 4 or 5 carbon atoms, more preferably an alkyl group of 2 to 5 carbon atoms or an alkenyl group of 4 carbon atoms, even more preferably an alkyl group of 2 to 4 carbon atoms.

R⁸ is an alkyl group of 1 to 8 carbon atoms, an alkenyl group of 2 to 8 carbon atoms, an alkoxy group of 1 to 8 carbon atoms, or an alkenyloxy group of 3 to 8 carbon atoms. If F is trans-1,4-cyclohexylene, R⁸ is preferably an alkyl group of 1 to 5 carbon atoms or an alkenyl group of 2 to 5 carbon atoms, more preferably an alkyl group of 2 to 5 carbon atoms or an alkenyl group of 2 to 4 carbon atoms, even more preferably an alkyl group of 3 to 5 carbon atoms or an alkenyl group of 2 or 3 carbon atoms, still more preferably an alkyl group of 3 carbon atoms. If F is optionally fluorinated 1,4-phenylene, R⁸ is preferably an alkyl group of 1 to 5 carbon atoms or an alkenyl group of 4 or 5 carbon atoms, more preferably an alkyl group of 2 to 5 carbon atoms or an alkenyl group of 4 carbon atoms, even more preferably an alkyl group of 2 to 4 carbon atoms.

If R⁷ or R⁸ is an alkenyl group and D or F to which it is attached is optionally fluorinated 1,4-phenylene, alkenyl groups of 4 or 5 carbon atoms having the following structures are preferred.

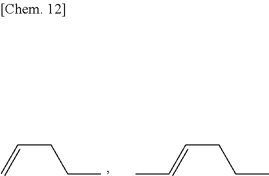

In the formulas, the right end is attached to the cyclic structure. In this case, the alkenyl group of 4 carbon atoms is more preferred.

D, E, and F are each independently optionally fluorinated 1,4-phenylene or trans-1,4-cyclohexylene, preferably 2-fluoro-1,4-phenylene, 2,3-difluoro-1,4-phenylene, 1,4-phenylene, or trans-1,4-cyclohexylene, more preferably 2-fluoro-1,4-phenylene, 2,3-difluoro-1,4-phenylene, or 1,4-phenylene, even more preferably 2,3-difluoro-1,4-phenylene or 1,4-phenylene. Z² is a single bond, —OCH₂—, —OCO—, —CH₂O—, or —COO—, preferably a single bond, —CH₂O—, or —COO—, more preferably a single bond.

n is 0, 1, or 2, preferably 0 or 1. If Z² is a substituent, rather than a single bond, n is preferably 1.

Among compounds represented by general formula (III) where n is 1, compounds represented by general formulas (III-1c) to (III-1e) are preferred to achieve a larger negative dielectric anisotropy, and general formulas (III-1f) to (III-1j) are preferred to achieve a faster response time.

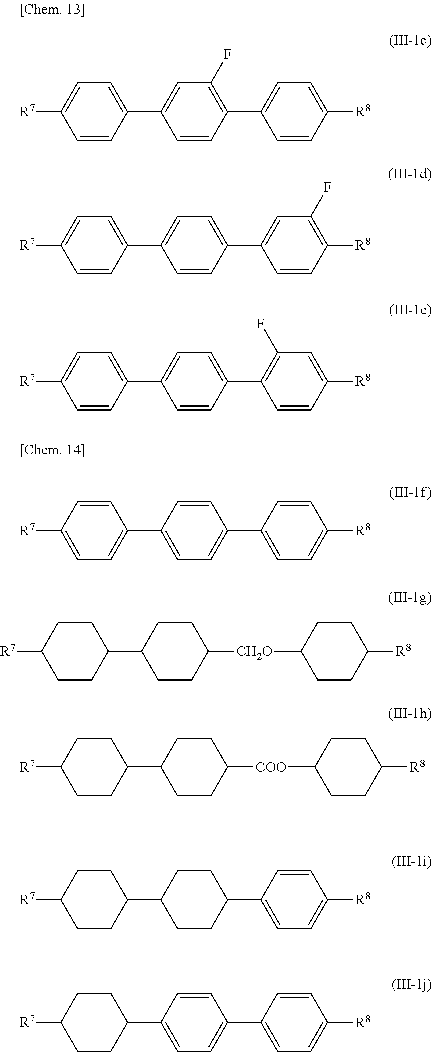

In the formulas, R⁷ and R⁸ are each independently an alkyl group of 1 to 5 carbon atoms, an alkenyl group of 2 to 5 carbon atoms, or an alkoxy group of 1 to 5 carbon atoms, preferably as defined for R⁷ and R⁸, respectively, in general formula (III).

Among compounds represented by general formula (III) where n is 2, compounds represented by general formulas (III-2a) to (III-2h) are preferred to achieve a larger negative dielectric anisotropy, and general formulas (III-2j) to (III-2l) are preferred to achieve a faster response time.

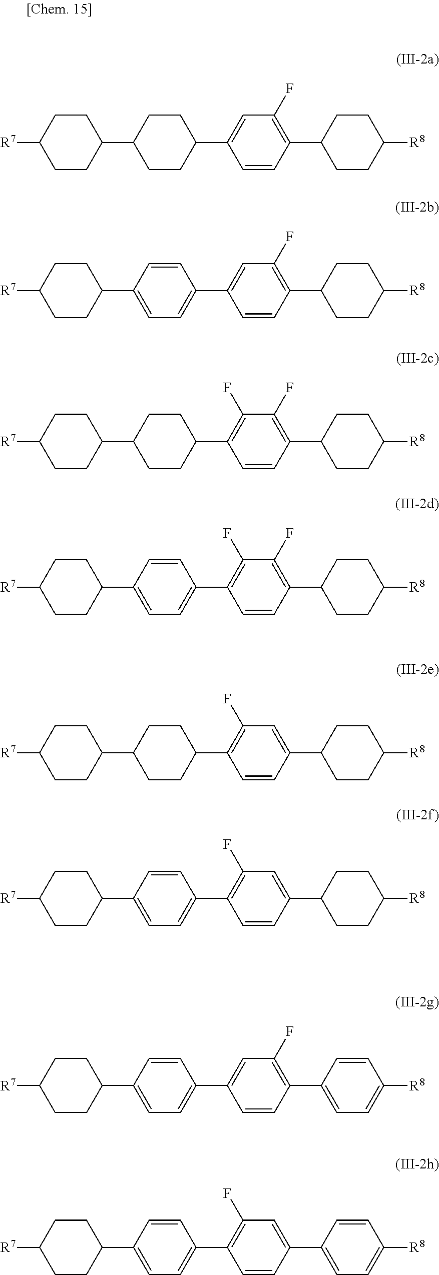

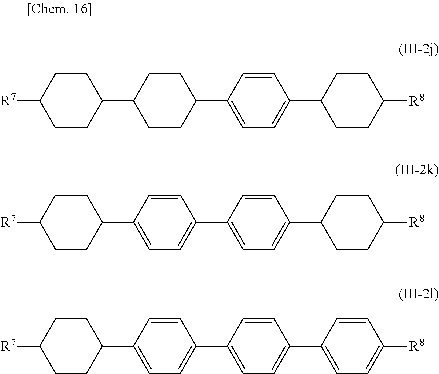

In the formulas, R⁷ and R⁸ are each independently an alkyl group of 1 to 5 carbon atoms, an alkenyl group of 2 to 5 carbon atoms, or an alkoxy group of 1 to 5 carbon atoms, preferably as defined for R⁷ and R⁸, respectively, in general formula (III).

Among compounds represented by general formula (III) where n is O, compounds represented by general formula (III-3b) are preferred to achieve a faster response time.

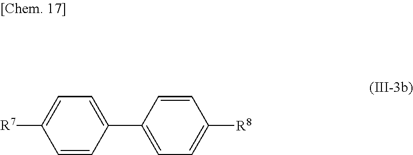

In the formula, R⁷ and R⁸ are each independently an alkyl group of 1 to 5 carbon atoms, an alkenyl group of 2 to 5 carbon atoms, or an alkoxy group of 1 to 5 carbon atoms, preferably as defined for R⁷ and R⁸, respectively, in general formula (III).

R⁷ is preferably an alkyl group of 2 to 5 carbon atoms, more preferably an alkyl group of 3 carbon atoms. R⁸ is preferably an alkoxy group of 1 to 3 carbon atoms, more preferably an alkoxy group of 2 carbon atoms.

The liquid crystal layer of the liquid crystal display device according to the present invention can have a wide range of nematic-isotropic liquid phase transition temperature (Tₙᵢ). Preferably, the liquid crystal layer has a nematic-isotropic liquid phase transition temperature (Tₙᵢ) of 60° C. to 120° C., more preferably 70° C. to 100° C., even more preferably 70° C. to 85° C.

The liquid crystal layer of the liquid crystal display device according to the present invention preferably has a dielectric anisotropy at 25° C. of −2.0 to −6.0, more preferably −2.5 to −5.0, even more preferably −2.5 to −4.0.

The liquid crystal layer of the liquid crystal display device according to the present invention preferably has a refractive index anisotropy at 25° C. of 0.08 to 0.13, more preferably 0.09 to 0.12. For small cell gaps, the liquid crystal layer preferably has a refractive index anisotropy at 25° C. of 0.10 to 0.12. For large cell gaps, the liquid crystal layer preferably has a refractive index anisotropy at 25° C. of 0.08 to 0.10.

The liquid crystal layer of the liquid crystal display device according to the present invention preferably has a rotational viscosity (γ1) of 150 or less, more preferably 130 or less, even more preferably 120 or less.

The liquid crystal layer of the liquid crystal display device according to the present invention preferably has a particular value of Z, which is a function of rotational viscosity and refractive index anisotropy.

Z=γ1/Δn² [Math. 1]

In the equation, γ1 is the rotational viscosity, and Δn is the refractive index anisotropy. Z is preferably 13,000 or less, more preferably 12,000 or less, even more preferably 11,000 or less.

When used in an active-matrix display device, the liquid crystal layer of the liquid crystal display device according to the present invention has to have a resistivity of 10¹² Ω·m or more, preferably 10¹³ Ω·m, more preferably 10¹⁴ Ω·m or more.

In addition to the compounds described above, the liquid crystal layer of the liquid crystal display device according to the present invention may contain other components depending on the application, including common nematic, smectic, and cholesteric liquid crystals, antioxidants, UV absorbers, and polymerizable monomers.

A preferred polymerizable monomer is a difunctional monomer represented by general formula (V).

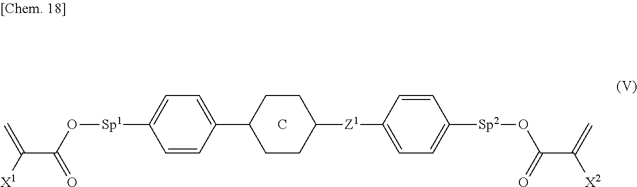

In the formula, X¹ and X² are each independently hydrogen or methyl; Sp¹ and Sp² are each independently a single bond, an alkylene group of 1 to 8 carbon atoms, or —O—(CH₂)ₛ— (where s is an integer of 2 to 7, and the oxygen atom is attached to the aromatic ring); Z is —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²— (where Y¹ and Y² are each independently fluorine or hydrogen), —C≡C—, or a single bond; C is 1,4-phenylene, trans-1,4-cyclohexylene, or a single bond; and any hydrogen atom in any 1,4-phenylene group in the formula is optionally replaced with fluorine.

Preferred difunctional monomers include diacrylate derivatives, where both X¹ and X² are hydrogen, and dimethacrylate derivatives, where both X¹ and X² are methyl. Also preferred are compounds where one of X¹ and X² is hydrogen and the other is methyl. Diacrylate derivatives have the highest rates of polymerization, dimethacrylate derivatives have the lowest rates of polymerization, and asymmetrical compounds have intermediate rates of polymerization, of which any suitable compound may be used depending on the application. Dimethacrylate derivatives are preferred for PSA display devices.

Sp¹ and Sp² above are each independently a single bond, an alkylene group of 1 to 8 carbon atoms, or —O—(CH₂)ₛ—. Compounds where at least one of Sp¹ and Sp² is a single bond are preferred for PSA display devices, including those where both of Sp¹ and Sp² are single bonds and those where one of Sp¹ and Sp² is a single bond and the other is an alkylene group of 1 to 8 carbon atoms or —O—(CH₂)ₛ—. In this case, an alkyl group of 1 to 4 carbon atoms is preferred, and s is preferably 1 to 4.

Z¹ is preferably —OCH₂—, —CH₂O—, —COO—, —OCO—, —CF₂O—, —OCF₂—, —CH₂CH₂—, —CF₂CF₂—, or a single bond, more preferably —COO—, —OCO—, or a single bond, even more preferably a single bond.

C is 1,4-phenylene or trans-1,4-cyclohexylene where any hydrogen atom is optionally replaced with fluorine, or a single bond. Preferably, C is 1,4-phenylene or a single bond. If C is a cyclic structure, rather than a single bond, Z¹ is also preferably a linking group, rather than a single bond. If C is a single bond, Z¹ is preferably a single bond.

With these points in mind, specific preferred cyclic structures between Sp¹ and Sp² in general formula (V) include the following structures.

If C in general formula (V) is a single bond, preferred cyclic structures composed of two rings include those represented by formulas (Va-1) to (Va-5) below, more preferably formulas (Va-1) to (Va-3), even more preferably formula (Va-1).

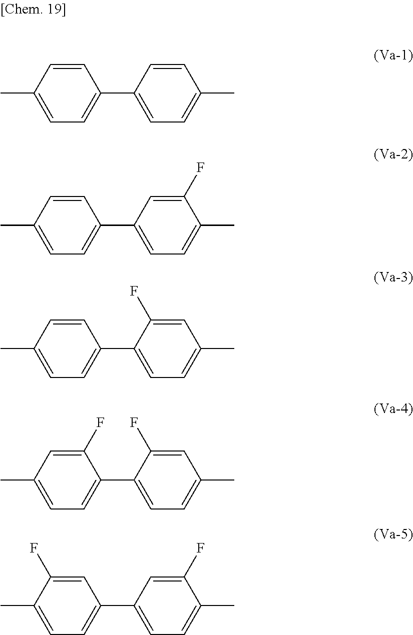

In the formulas, both ends are attached to Sp¹ and Sp².

Polymerizable compounds having these backbones have optimal anchoring force for PSA display devices after polymerization, which results in good alignment with little or no display unevenness.

With the above in mind, preferred polymerizable monomers include those represented by general formulas (V-1) to (V-4), most preferably general formula (V-2).

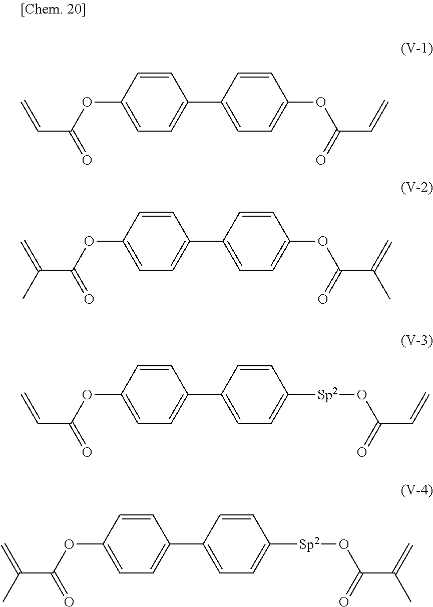

In the formulas, Sp² is an alkylene group of 2 to 5 carbon atoms.

Although a polymerizable monomer, if used, polymerizes without a polymerization initiator, a polymerization initiator may be added to promote the polymerization. Examples of polymerization initiators include benzoin ethers, benzophenones, acetophenones, benzyl ketals, and acylphosphine oxides. A stabilizer may also be added to improve the storage stability. Examples of stabilizers that can be used include hydroquinones, hydroquinone monoalkyl ethers, tert-butylcatechols, pyrogallols, thiophenols, nitro compounds, β-naphthylamines, β-naphthols, and nitroso compounds.

The liquid crystal layer according to the present invention is useful for liquid crystal display devices such as active-matrix liquid crystal display devices (AM-LCDs), twisted nematic (TN) liquid crystal display devices, super-twisted nematic liquid crystal display devices (STN-LCDs), OCB-LCDs, and in-plane switching liquid crystal display devices (IPS-LCDs). In particular, the liquid crystal layer according to the present invention can be used for AM-LCDs such as PSA, PSVA, VA, IPS, and ECB liquid crystal display devices.

### Sealant

The sealant used in the liquid crystal display device according to the present invention is formed of a cured product of a curable resin composition containing a compound containing at least one epoxy group per molecule and having a weight average molecular weight of 300 to 10,000.

Examples of compounds containing at least one epoxy group per molecule include novolac epoxy resins and bisphenol epoxy resins. Specific preferred examples include biphenyl epoxy resins, naphthalene epoxy resins, tris(hydroxyphenyl)alkyl epoxy resins, and tetrakis(hydroxyphenyl)alkyl epoxy resins. More specific examples include bisphenol A epoxy resins, bisphenol E epoxy resins, bisphenol F epoxy resins, bisphenol S epoxy resins, 2,2′-diallyl bisphenol A epoxy resins, hydrogenated bisphenol epoxy resins, polyoxypropylene bisphenol A epoxy resins, propylene oxide adducts of bisphenol A epoxy resins, resorcinol epoxy resins, biphenyl epoxy resins, sulfide epoxy resins, diphenyl ether epoxy resins, dicyclopentadiene epoxy resins, naphthalene epoxy resins, phenol novolac epoxy resins, cresol novolac epoxy resins, trisphenol novolac epoxy resins, dicyclopentadiene novolac epoxy resins, biphenyl novolac epoxy resins, naphthalene phenol novolac epoxy resins, glycidylamine epoxy resins, alkyl polyol epoxy resins, rubber-modified epoxy resins, glycidyl esters, and bisphenol A episulfide resins. Preferred among these are bisphenol A epoxy resins, bisphenol E epoxy resins, bisphenol F epoxy resins, resorcinol epoxy resins, phenol novolac epoxy resins, and diphenyl ether epoxy resins.

Examples of commercially available epoxy compounds include bisphenol A epoxy resins such as jER828EL, jER1004 (available from Mitsubishi Chemical Corporation), and Epiclon 850-S (available from DIC Corporation); bisphenol F epoxy resins such as jER806 and jER4004 (available from Mitsubishi Chemical Corporation); bisphenol E epoxy resins such as R-710; bisphenol S epoxy resins such as Epiclon EXA1514 (available from DIC Corporation); 2,2′-diallyl bisphenol A epoxy resins such as RE-810NM (available from Nippon Kayaku Co., Ltd.); hydrogenated bisphenol epoxy resins such as Epiclon EXA7015 (available from DIC Corporation); propylene oxide adducts of bisphenol A epoxy resins such as EP-4000S (available from Adeka Corporation); resorcinol epoxy resins such as EX-201 (available from Nagase ChemteX Corporation); biphenyl epoxy resins such as jERYX-4000H (available from Mitsubishi Chemical Corporation); sulfide epoxy resins such as YSLV-50TE (available from Nippon Steel Chemical Co., Ltd.); biphenyl ether epoxy resins such as YSLV-80DE (available from Nippon Steel Chemical Co., Ltd.); dicyclopentadiene epoxy resins such as EP-4088S (available from Adeka Corporation); naphthalene epoxy resins such as Epiclon HP4032 and Epiclon EXA-4700 (available from DIC Corporation); phenol novolac epoxy resins such as Epiclon N-740, Epiclon N-770, Epiclon N-775 (available from DIC Corporation), jER152, and jER154 (available from Mitsubishi Chemical Corporation); o-cresol novolac epoxy resins such as Epiclon N-670-EXP-S (available from DIC Corporation); cresol novolac epoxy resins such as Epiclon N660, Epiclon N665, Epiclon N670, Epiclon N673, Epiclon N680, Epiclon N695, Epiclon N665EXP, and Epiclon N672EXP (available from DIC Corporation); dicyclopentadiene novolac epoxy resins such as Epiclon HP7200 (available from DIC Corporation); biphenyl novolac epoxy resins such as NC-3000P (available from Nippon Kayaku Co., Ltd.); naphthalene phenol novolac epoxy resins such as ESN-165S (available from Nippon Steel Chemical Co., Ltd.); glycidylamine epoxy resins such as jER630 (available from Mitsubishi Chemical Corporation), Epiclon 430 (available from DIC Corporation), and TETRAD-X (available from Mitsubishi Gas Chemical Company, Inc.); alkyl polyol epoxy resins such as ZX-1542 (available from Nippon Steel Chemical Co., Ltd.), Epiclon 726 (available from DIC Corporation), Epolight 80MFA (available from Kyoeisha Chemical Co., Ltd.), and Denacol EX-611, (available from Nagase ChemteX Corporation); rubber-modified epoxy resins such as YR-450, YR-207 (available from Nippon Steel Chemical Co., Ltd.), and Epolead PB (available from Daicel Corporation); glycidyl esters such as Denacol EX-147 (available from Nagase ChemteX Corporation); bisphenol A episulfide resins such as jERYL-7000 (available from Mitsubishi Chemical Corporation); and other compounds such as YDC-1312, YSLV-80XY, YSLV-90CR (available from Nippon Steel Chemical Co., Ltd.), XAC4151 (available from Asahi Kasei Corporation), jER1031, jER1032 (available from Mitsubishi Chemical Corporation), EXA-7120 (available from DIC Corporation), and TEPIC (available from Nissan Chemical Industries, Ltd.).

The compound containing at least one epoxy group per molecule has a weight average molecular weight of 300 to 10,000. A compound having a weight average molecular weight of 300 or more is preferred since it is unlikely to contaminate the liquid crystal. A compound having a weight average molecular weight of 10,000 or less is preferred since it facilitates the control of the sealant viscosity. The lower limit of the weight average molecular weight is preferably 500 or more, more preferably 1,000 or more. The upper limit of the weight average molecular weight is preferably 7,000 or less, more preferably 5,000 or less, even more preferably 3,000 or less.

The curable resin composition containing the compound containing at least one epoxy group per molecule preferably has a hydrogen-bonding functional group value of 1×10⁻⁴ to 5×10⁻² mol/g, more preferably 5×10⁻⁴ to 1×10⁻² mol/g, even more preferably 1×10⁻³ to 5×10⁻³ mol/g. Such a curable resin composition is preferred since it forms intramolecular hydrogen bonds and thus, when used as a sealant, does not readily dissolve into the liquid crystal both before and after curing. This reduces the risk of contamination of the liquid crystal and thus reduces the problem of display defects such as white spots, alignment unevenness, and image-sticking.

The hydrogen bonds are formed by compounds containing a hydrogen-bonding functional group or residue. Examples of such compounds include those containing functional groups such as —OH, —SH, —NH₂, —NHR (where R is an aromatic or aliphatic hydrocarbon group or a derivative thereof), —COOH, —CONH₂, and —NHOH groups and those containing residues such as —NHCO—, —NH—, —CONHCO—, and —NH—NH— linkages in the molecule. If the curable resin composition contains a single compound containing hydrogen-bonding functional groups, the hydrogen-bonding functional group value is calculated by the following equation (equation (1)):

Hydrogen-bonding functional group value (HX) (mol/g)=(number of hydrogen-bonding functional groups per molecule of Compound X)/(molecular weight of Compound X) (equation 1)

If the curable resin composition contains a mixture of resins containing hydrogen-bonding functional groups, the hydrogen-bonding functional group value may be calculated by taking into account the contents per unit weight (weight fractions) of the individual compounds containing hydrogen-bonding functional groups. For example, if the compounds containing hydrogen-bonding functional groups are Compounds A, B, and C, the hydrogen-bonding functional group value is represented by the following equation (equation (2)).

Hydrogen-bonding functional group value (H_{ABC})=H_{A}P_{A}+H_{B}P_{B}+H_{C}P_{C} (equation 2)

where Pα is the weight fraction of Compound α.

A curable resin composition having a hydrogen-bonding functional group value of less than 1×10⁻⁴ mol/g readily dissolves into the liquid crystal and thus disturbs the alignment of the liquid crystal. A curable resin composition having a hydrogen-bonding functional group value of more than 5×10⁻² mol/g forms a cured product with high moisture permeability through which moisture readily enters the liquid crystal display device.

The curable resin composition may contain a single compound containing hydrogen-bonding functional groups that itself has a hydrogen-bonding functional group value within the above range or may contain a mixture of compounds containing hydrogen-bonding functional groups that together have a hydrogen-bonding functional group value within the above range. That is, the curable resin composition may contain a single compound or a mixture of compounds containing hydrogen-bonding functional groups that have an average hydrogen-bonding functional group value within the above range.

The curable resin composition containing the compound containing at least one epoxy group per molecule preferably has a volume resistivity of 1×10¹³ Ω·cm or more after curing. A volume resistivity of less than 1×10¹³ Ω·cm indicates that the sealant contains ionic impurities. If such a curable resin composition is used as a sealant, ionic impurities dissolve into the liquid crystal while a voltage is being applied. This decreases the voltage holding ratio (VHR) and increases the ionic density of the liquid crystal layer and causes display defects such as white spots, alignment unevenness, and image-sticking.

The curable resin composition containing the compound containing at least one epoxy group per molecule preferably has a resistivity of 1.0×10⁶ to 1.0×10¹⁰ Ω·cm before curing. A curable resin composition having a resistivity of less than 1.0×10⁶ Ω·cm before curing, when used as a sealant, dissolves into the liquid crystal. This decreases the voltage holding ratio (VHR) and increases the ionic density of the liquid crystal layer and causes display defects such as white spots, alignment unevenness, and image-sticking. A curable resin composition having a resistivity of more than 1.0×10¹⁰ Ω·cm before curing may have poor adhesion to substrates.

The compound containing at least one epoxy group per molecule preferably contains at least one ethylenically unsaturated bond per molecule. Preferred among such compounds are those containing at least one epoxy group and at least one (meth)acrylic group per molecule.

Examples of compounds containing at least one epoxy group and at least one (meth)acrylic group per molecule include, but not limited to, (meth)acrylic-modified epoxy resins and urethane-modified (meth)acrylic epoxy resins.

### 1) (Meth)Acrylic-Modified Epoxy Resins

(Meth)acrylic-modified epoxy resins may be prepared by any method, for example, by reacting (meth)acrylic acid with an epoxy resin in the presence of a basic catalyst in a usual manner.

Examples of (meth)acrylic-modified epoxy resins include partial (meth)acrylates of epoxy resins such as novolac epoxy resins and bisphenol epoxy resins. Preferred epoxy resins include biphenyl epoxy resins, naphthalene epoxy resins, tris(hydroxyphenyl)alkyl epoxy resins, and tetrakis(hydroxyphenyl)alkyl epoxy resins.

Specifically, for example, a (meth)acrylic-modified epoxy resin may be prepared by mixing 360 parts by weight of a resorcinol epoxy resin (EX-201 available from Nagase ChemteX Corporation), 2 parts by weight of p-methoxyphenol, serving as a polymerization inhibitor, 2 parts by weight of triethylamine, serving as a reaction catalyst, and 210 parts by weight of acrylic acid and reacting the mixture with stirring under reflux at 90° C. for five hours while supplying air.

Examples of commercially available (meth)acrylic-modified epoxy resins include Ebecryl 860, Ebecryl 1561, Ebecryl 3700, Ebecryl 3600, Ebecryl 3701, Ebecryl 3703, Ebecryl 3200, Ebecryl 3201, Ebecryl 3702, Ebecryl 3412, Ebecryl 860, Ebecryl RDX63182, Ebecryl 6040, Ebecryl 3800 (available from Daicel-Cytec Co., Ltd.), EA-1020, EA-1010, EA-5520, EA-5323, EA-CHD, EMA-1020 (available from Shin Nakamura Chemical Co., Ltd.), Epoxy Ester M-600A, Epoxy Ester 40EM, Epoxy Ester 70PA, Epoxy Ester 200PA, Epoxy Ester 80MFA, Epoxy Ester 3002M, Epoxy Ester 3002A, Epoxy Ester 1600A, Epoxy Ester 3000M, Epoxy Ester 3000A, Epoxy Ester 200EA, Epoxy Ester 400EA (available from Kyoeisha Chemical Co., Ltd.), Denacol Acrylate DA-141, Denacol Acrylate DA-314, and Denacol Acrylate DA-911 (available from Nagase ChemteX Corporation).

### 2) Urethane-Modified (Meth)Acrylic Epoxy Resins

Urethane-modified (meth)acrylic epoxy resins may be prepared, for example, by reacting a polyol with a di- or higher functional isocyanate and then reacting the resulting compound with a hydroxyl-containing (meth)acrylic monomer and glycidol, by reacting a di- or higher functional isocyanate with a hydroxyl-containing (meth)acrylic monomer and glycidol without a polyol, or by reacting an isocyanate-containing (meth)acrylate with glycidol. Specifically, for example, a urethane-modified (meth)acrylic epoxy resin may be prepared by reacting 1 mol of trimethylolpropane and 3 mol of isophorone diisocyanate in the presence of a tin-based catalyst and reacting the isocyanate groups remaining in the resulting compound with hydroxyethyl acrylate, which is a hydroxyl-containing acrylic monomer, and glycidol, which is a hydroxyl-containing epoxy compound.

Examples of polyols include, but not limited to, ethylene glycol, glycerol, sorbitol, trimethylolpropane, and (poly)propylene glycol.

Examples of di- or higher functional isocyanates include, but not limited to, isophorone diisocyanate, 2,4-tolylene diisocyanate, 2,6-tolylene diisocyanate, hexamethylene diisocyanate, trimethylhexamethylene diisocyanate, diphenylmethane 4,4′-diisocyanate (MDI), hydrogenated MDI, polymeric MDI, 1,5-naphthalene diisocyanate, norbornane diisocyanate, tolidine diisocyanate, xylylene diisocyanate (XDI), hydrogenated XDI, lysine diisocyanate, triphenylmethane triisocyanate, tris(isocyanatophenyl) thiophosphate, tetramethylxylene diisocyanate, and 1,6,10-undecane triisocyanate.

Examples of hydroxyl-containing (meth)acrylic monomers include, but not limited to, monomers containing one hydroxyl group in the molecule, including hydroxyethyl (meth)acrylate, hydroxypropyl (meth)acrylate, and hydroxybutyl (meth)acrylate; and monomers containing two or more hydroxyl groups in the molecule, including epoxy (meth)acrylates such as bisphenol A-modified epoxy (meth)acrylate. These may be used alone or in combination.

The compound containing at least one epoxy group and at least one (meth)acrylic group per molecule preferably contains a hydrogen-bonding group, for example, a hydroxyl group and/or a urethane linkage, to reduce the compatibility with the liquid crystal and thereby to eliminate contamination. This reduces the problem of display defects such as white spots, alignment unevenness, and image-sticking.

The compound containing at least one epoxy group and at least one (meth)acrylic group per molecule preferably contains at least one molecular backbone selected from biphenyl backbones, naphthalene backbones, bisphenol backbones, and partial (meth)acrylates of novolac epoxy resins. This improves the heat resistance of the curable resin composition according to the present invention.

The curable resin composition containing the compound containing at least one epoxy group per molecule may contain a compound containing an ethylenically unsaturated bond, preferably a compound containing a (meth)acryloyloxy group. Examples of compounds containing a (meth)acryloyloxy group include esters obtained by reacting (meth)acrylic acid with a hydroxyl-containing compound and urethane (meth)acrylates obtained by reacting an isocyanate with a hydroxyl-containing (meth)acrylic acid derivative.

(1) Esters Obtained by Reacting (Meth)Acrylic Acid with Hydroxyl-Containing Compound

Examples of monofunctional esters obtained by reacting (meth)acrylic acid with a hydroxyl-containing compound include, but not limited to, 2-hydroxyethyl (meth)acrylate, 2-hydroxypropyl (meth)acrylate, 4-hydroxybutyl (meth)acrylate, 2-hydroxybutyl (meth)acrylate, isobutyl (meth)acrylate, t-butyl (meth)acrylate, isooctyl (meth)acrylate, lauryl (meth)acrylate, stearyl (meth)acrylate, isobornyl (meth)acrylate, cyclohexyl (meth)acrylate, 2-methoxyethyl (meth)acrylate, methoxyethylene glycol (meth)acrylate, 2-ethoxyethyl (meth)acrylate, tetrahydrofurfuryl (meth)acrylate, benzyl (meth)acrylate, ethylcarbitol (meth)acrylate, phenoxyethyl (meth)acrylate, phenoxy diethylene glycol (meth)acrylate, phenoxy polyethylene glycol (meth)acrylate, methoxy polyethylene glycol (meth)acrylate, 2,2,2-trifluoroethyl (meth)acrylate, 2,2,3,3-tetrafluoropropyl (meth)acrylate, 1H,1H,5H-octafluoropentyl (meth)acrylate, imide (meth)acrylate, methyl (meth)acrylate, ethyl (meth)acrylate, n-butyl (meth)acrylate, propyl (meth)acrylate, n-butyl (meth)acrylate, cyclohexyl (meth)acrylate, 2-ethylhexyl (meth)acrylate, n-octyl (meth)acrylate, isononyl (meth)acrylate, isomyristyl (meth)acrylate, 2-butoxyethyl (meth)acrylate, 2-phenoxyethyl (meth)acrylate, bicyclopentenyl (meth)acrylate, isodecyl (meth)acrylate, diethylaminoethyl (meth)acrylate, dimethylaminoethyl (meth)acrylate, 2-(meth)acryloyloxyethylsuccinic acid, 2-(meth)acryloyloxyethylhexahydrophthalic acid, 2-(meth)acryloyloxyethyl 2-hydroxypropyl phthalate, glycidyl (meth)acrylate, and 2-(meth)acryloyloxyethyl phosphate.

Examples of difunctional esters obtained by reacting (meth)acrylic acid with a hydroxyl-containing compound include, but not limited to, 1,4-butanediol di(meth)acrylate, 1,3-butanediol di(meth)acrylate, 1,6-hexanediol di(meth)acrylate, 1,9-nonanediol di(meth)acrylate, 1,10-decanediol di(meth)acrylate, 2-n-butyl-2-ethyl-1,3-propanediol di(meth)acrylate, dipropylene glycol di(meth)acrylate, tripropylene glycol di(meth)acrylate, polypropylene glycol di(meth)acrylate, ethylene glycol di(meth)acrylate, diethylene glycol di(meth)acrylate, tetraethylene glycol di(meth)acrylate, polyethylene glycol di(meth)acrylate, propylene oxide adducts of bisphenol A di(meth)acrylate, ethylene oxide adducts of bisphenol A di(meth)acrylate, ethylene oxide adducts of bisphenol F di(meth)acrylate, dimethyloldicyclopentadiene di(meth)acrylate, 1,3-butylene glycol di(meth)acrylate, neopentyl glycol di(meth)acrylate, ethylene-oxide-modified isocyanurate di(meth)acrylate, 2-hydroxy-3-acryloyloxypropyl di(meth)acrylate, carbonate diol di(meth)acrylate, polyether diol di(meth)acrylate, polyester diol di(meth)acrylate, polycaprolactone diol di(meth)acrylate, and polybutadiene diol di(meth)acrylate.

Examples of tri- and higher functional esters obtained by reacting (meth)acrylic acid with a hydroxyl-containing compound include, but not limited to, pentaerythritol tri(meth)acrylate, trimethylolpropane tri(meth)acrylate, propylene oxide adducts of trimethylolpropane tri(meth)acrylate, ethylene oxide adducts of trimethylolpropane tri(meth)acrylate, caprolactone-modified trimethylolpropane tri(meth)acrylate, ethylene oxide adducts of isocyanurate tri(meth)acrylate, dipentaerythritol penta(meth)acrylate, dipentaerythritol hexa(meth)acrylate, ditrimethylolpropane tetra(meth)acrylate, pentaerythritol tetra(meth)acrylate, glycerol tri(meth)acrylate, propylene oxide adducts of glycerol tri(meth)acrylate, and tris(meth)acryloyloxyethyl phosphate.

(2) Urethane (Meth)Acrylates Obtained by Reacting Isocyanate with Hydroxyl-Containing Acrylic Acid Derivative

(Meth)acrylates obtained by reacting an isocyanate with a hydroxyl-containing (meth)acrylic acid derivative may be prepared by any method, for example, by reacting one equivalent of a compound containing two isocyanate groups with two equivalents of a hydroxyl-containing (meth)acrylic acid derivative in the presence of a tin compound serving as a catalyst.

Examples of isocyanates that can be used as a raw material for urethane (meth)acrylates obtained by reacting an isocyanate with a hydroxyl-containing (meth)acrylic acid derivative include, but not limited to, isophorone diisocyanate, 2,4-tolylene diisocyanate, 2,6-tolylene diisocyanate, hexamethylene diisocyanate, trimethylhexamethylene diisocyanate, diphenylmethane 4,4′-diisocyanate (MDI), hydrogenated MDI, polymeric MDI, 1,5-naphthalene diisocyanate, norbornane diisocyanate, tolidine diisocyanate, xylylene diisocyanate (XDI), hydrogenated XDI, lysine diisocyanate, triphenylmethane triisocyanate, tris(isocyanatophenyl) thiophosphate, tetramethylxylene diisocyanate, and 1,6,10-undecane triisocyanate.

Other examples of isocyanates that can be used as a raw material for urethane (meth)acrylates obtained by reacting an isocyanate with a hydroxyl-containing (meth)acrylic acid derivative include chain-extended isocyanates obtained by reacting, with excess isocyanate, polyols such as ethylene glycol, glycerol, sorbitol, trimethylolpropane, (poly)propylene glycol, carbonate diols, polyether diols, polyester diols, and polycaprolactone diols.

Examples of hydroxyl-containing (meth)acrylic acid derivatives include, but not limited to, commercially available compounds such as 2-hydroxyethyl (meth)acrylate, 2-hydroxypropyl (meth)acrylate, 4-hydroxybutyl (meth)acrylate, and 2-hydroxybutyl (meth)acrylate; mono(meth)acrylates of dihydric alcohols such as ethylene glycol, propylene glycol, 1,3-propanediol, 1,3-butanediol, 1,4-butanediol, and polyethylene glycol; mono(meth)acrylates and di(meth)acrylates of trihydric alcohols such as trimethylolethane, trimethylolpropane, and glycerol; and epoxy (meth)acrylates such as bisphenol A-modified epoxy (meth)acrylates.

Specifically, for example, a urethane (meth)acrylate may be prepared by mixing 134 parts by weight of trimethylolpropane, 0.2 part by weight of BHT, serving as a polymerization inhibitor, 0.01 part by weight of dibutyltin dilaurate, serving as a reaction catalyst, and 666 parts by weight of isophorone diisocyanate, reacting the mixture with stirring under reflux at 60° C. for two hours, adding 51 parts by weight of 2-hydroxyethyl acrylate, and reacting the mixture with stirring under reflux at 90° C. for two hours while supplying air.

Examples of commercially available urethane (meth)acrylates include M-1100, M-1200, M-1210, M-1600 (available from Toagosei Co., Ltd.), Ebecryl 230, Ebecryl 270, Ebecryl 4858, Ebecryl 8402, Ebecryl 8804, Ebecryl 8803, Ebecryl 8807, Ebecryl 9260, Ebecryl 1290, Ebecryl 5129, Ebecryl 4842, Ebecryl 210, Ebecryl 4827, Ebecryl 6700, Ebecryl 220, Ebecryl 2220 (available from Daicel-Cytec Co., Ltd.), Art Resin UN-9000H, Art Resin UN-9000A, Art Resin UN-7100, Art Resin UN-1255, Art Resin UN-330, Art Resin UN-3320HB, Art Resin UN-1200TPK, Art Resin SH-500B (available from Negami Chemical Industrial Co., Ltd.), U-122P, U-108A, U-340P, U-4HA, U-6HA, U-324A, U-15HA, UA-5201P, UA-W2A, U-1084A, U-6LPA, U-2HA, U-2PHA, UA-4100, UA-7100, UA-4200, UA-4400, UA-340P, U-3HA, UA-7200, U-2061BA, U-10H, U-122A, U-340A, U-108, U-6H, UA-4000 (available from Shin Nakamura Chemical Co., Ltd.), AH-600, AT-600, UA-306H, AI-600, UA-101T, UA-101I, UA-306T, and UA-306I.

Thermally curable sealants have a problem in that the viscosity of the resin used as a raw material decreases upon heating. This results in dissolution of ionic impurities from the sealant into the liquid crystal in contact with the sealant and leakage of the liquid crystal due to deformation of the seal pattern. To reduce the decrease in resin viscosity upon heating, it is effective to improve the curing rate so that the sealant can be quickly cured before its viscosity decreases. As discussed above, it is preferred that the curable resin composition according to the present invention contain a compound containing an ethylenically unsaturated bond. More preferably, the curable resin composition contains a combination of a (meth)acrylic-containing resin, which can react with radicals, and (2) a thermal radical polymerization initiator and has a carbon-carbon double bond content of 0.002 to 0.006 mol/g. This allows adjacent carbon-carbon double bonds to react with each other quickly and thus improves the curing rate of the resin composition, which results in good leakage resistance.

Although a curable resin composition having a carbon-carbon double bond content of more than 0.006 mol/g has a higher curing rate, the resulting cured product may have a higher crosslink density and may thus have a lower adhesion strength with the substrates that form liquid crystal display panels. A curable resin composition having a carbon-carbon double bond content of less than 0.002 mol/g has a low curing rate. Thus, a resin composition having a carbon-carbon double bond content within the above range has a good balance of curability and adhesion to substrates. A carbon-carbon double bond content of 0.002 to 0.003 mol/g is preferred to achieve a better balance of curability and adhesion to substrates.

If the curable resin composition contains a mixture of resins containing carbon-carbon double bonds, the carbon-carbon double bond content may be calculated by taking into account the contents per unit weight (weight fractions) of the individual compounds containing carbon-carbon double bonds. For example, if the compounds containing carbon-carbon double bonds are Compounds A, B, and C, the carbon-carbon double bond content is represented by the following equation (equation (3)):

Carbon-carbon double bond content (N_{ABC})=N_{A}P_{A}+N_{B}P_{B}+N_{C}P_{C} (equation 3)

where Nα is the carbon-carbon double bond content (mol/g) of Compound α, and Pα is the weight fraction of Compound α in Compounds A, B, and C.

The carbon-carbon double bond content of a curable resin can be calculated as the number of carbon-carbon double bonds in the molecule divided by the molecular weight of the resin and is expressed in mol/g. The molecular weight of each curing resin is preferably measured by GPC using polystyrene standards. Although the number average molecular weight and the weight average molecular weight are calculated in this case, the carbon-carbon double bond content is preferably calculated from the number average molecular weight.

The curable resin composition may contain a single resin that itself has a carbon-carbon double bond content within the above range or may contain a mixture of resins that together have a carbon-carbon double bond content within the above range. That is, the curable resin composition may contain a single compound or a mixture of compounds having an average carbon-carbon double bond within the above range.

The curable resin composition according to the present invention may contain a compound containing at least one epoxy group and at least one (meth)acrylic group per molecule or may contain a compound containing a (meth)acryloyloxy group. In this case, the curable resin composition preferably has an epoxy-to-(meth)acrylic mixing ratio of 15:85 to 95:5, more preferably 25:75 to 90:10, even more preferably 25:75 to 70:30. A curable resin composition having a (meth)acrylic equivalent ratio of less than 30 may have low reactivity and thus, when used as a sealant, may fail to cure quickly upon heating after coating and may dissolve considerably into the liquid crystal. A curable resin composition having a (meth)acrylic equivalent ratio of more than 85 may have insufficient adhesion and moisture resistance. More preferably, the curable resin composition has an epoxy-to-(meth)acrylic equivalent ratio of 50:50 to 30:70.

The curable resin composition containing the compound containing at least one epoxy group per molecule preferably contains a thermal curing agent. The thermal curing agent is used to react and crosslink the epoxy groups and/or ethylenically unsaturated bonds in the curable resin composition upon heating, thereby improving the adhesion and moisture resistance of the curable resin composition after curing.

Although any thermal curing agent may be used to react epoxy groups, it is preferred to use a latent thermal curing agent having a melting point of 100° C. or higher. A thermal curing agent having a melting point of 100° C. or lower may noticeably decrease the storage stability.

If the curable resin composition contains a compound containing at least one ethylenically unsaturated bond such as a (meth)acrylic group per molecule, it preferably contains a thermal radical initiator. The thermal radical initiator is used to react and crosslink the ethylenically unsaturated bonds in the curable resin composition upon heating. In particular, the thermal radical initiator contributes to improving the curing rate and serves to reduce the permeation of ionic impurities. Although any thermal radical initiator may be used, it is preferred to use a thermal radical initiator having a 10-hour half-life temperature of 40° C. to 80° C. A thermal radical initiator having a 10-hour half-life temperature of 40° C. or lower may noticeably decrease the storage stability.

Examples of thermal curing agents include dihydrazides such as 1,3-bis[hydrazinocarbonoethyl-5-isopropylhydantoin](melting point: 120° C.), adipic acid dihydrazide (melting point: 181° C.), 7,11-octadecadiene-1,18-dicarbohydrazide (melting point: 160° C.), dodecanedioic acid dihydrazide (melting point: 190° C.), and sebacic acid dihydrazide (melting point: 189° C.); dicyandiamides such as dicyandiamide (melting point: 209° C.); guanidines; imidazoles such as 1-cyanoethyl-2-phenylimidazole, N-[2-(2-methyl-1-imidazolyl)ethyl]urea, 2,4-diamino-6-[2′-methylimidazolyl-(1′)]-ethyl-s-triazine, N,N′-bis(2-methyl-1-imidazolylethyl)urea, N,N′-(2-methyl-1-imidazolylethyl)-adipamide, 2-phenyl-4-methyl-5-hydroxymethylimidazole, 2-phenyl-4,5-dihydroxymethylimidazole, 2-hydroxymethylimidazole (molecular weight: 98.1, melting point: 115° C.), 2-phenyl-4,5-dihydroxymethylimidazole (molecular weight: 204, solid, melting point: over 230° C. (degraded)), and 2-methylimidazole (molecular weight: 82, solid, melting point: 137° C. to 145° C.), preferably those containing a hydroxyl group, which reduces the dissolution of the sealant into the liquid crystal; acid anhydrides such as modified aliphatic polyamines, tetrahydrophthalic anhydride, and ethylene glycol bis(anhydrotrimellitate); and phenol compounds such as adducts of various amines and epoxy resins, phenol novolac resins, cresol novolac resins, and xyloc novolac resins. These may be used alone or in combination.

If the compound containing at least one (meth)acrylic group and at least one epoxy group per molecule is an acrylic-modified epoxy resin, the reactivity of the acrylic epoxy resin varies greatly depending on the structure. Whereas urethane-modified epoxy resins have high stability and thus provide good storage stability when used in combination with highly reactive thermal curing agents, (Meth)acrylic-modified epoxy resins have high reactivity and are therefore preferably used in combination with less reactive thermal curing agents having melting points of 100° C. or higher.

The thermal curing agent is preferably added in an amount of 5 to 60 parts by weight, more preferably 10 to 50 parts by weight, per 100 parts by weight of the curable compound. If the thermal curing agent is added in an amount outside this range, the resulting cured product may have low adhesion and chemical resistance. This may result in an earlier decrease in the characteristics of the liquid crystal in a high-temperature high-humidity operation test.

A preferred thermal curing agent is a coated thermal curing agent, described below. The coated thermal curing agent according to the present invention can be used to obtain a one-component sealant with significantly high storage stability.

Specifically, the coated thermal curing agent, which is composed of solid thermal curing agent particles coated with fine particles that are poorly volatile and poorly soluble in organic materials, can be used to obtain a sealant containing a curing agent with high storage stability.

As used herein, the term “solid thermal curing agent” refers to a curing agent that is solid at room temperature and that melts or softens upon heating and starts reacting with a curable resin. The solid thermal curing agent may be any thermal curing agent having a melting point or softening point higher than room temperature. Examples of solid thermal curing agents include solid amines, phenol compounds, and acid anhydrides. Particularly preferred are solid amines, which have good reactivity at low temperature.

The term “solid amine” refers to a solid compound having one or more primary to tertiary amino groups in the molecule. Examples of solid amines include aromatic amines such as m-phenylenediamine and diaminodiphenylmethane; imidazoles such as 2-methylimidazole, 1,2-dimethylimidazole, and 1-cyanoethyl-2-methylimidazole; imidazolines such as 2-methylimidazoline; and dihydrazides such as sebacic acid dihydrazide and isophthalic acid dihydrazide. Examples of commercially available solid amines include amine adducts and dicyandiamides such as Amicure PN-23 and Amicure MY-24 (available from Ajinomoto Fine-Techno Co., Inc.).

Examples of polyhydric phenol compounds include polyphenols and novolac phenol resins. Examples of commercially available polyhydric phenol compounds include jERCURE 170, jERCURE YL6065, and jERCURE MP402FPI (available from Mitsubishi Chemical Corporation).

Examples of acid anhydrides include glycerol bis(anhydrotrimellitate), ethylene glycol bis(anhydrotrimellitate), tetrahydrophthalic anhydride, hexahydrophthalic anhydride, 4-methylhexahydrophthalic anhydride, and 3-methyltetrahydrophthalic anhydride.

Examples of commercially available acid anhydrides include jERCURE YH-306 and YH-307 (available from Mitsubishi Chemical Corporation).

The solid thermal curing agent particles preferably, but not necessarily, have an average particle size of 0.1 to 50 μm. Solid thermal curing agent particles having an average particle size of less than 0.1 μm may be inefficiently coated with the fine particles. Solid thermal curing agent particles having an average particle size of more than 50 μm, when added to a sealant, may settle during storage and may unevenly cure the resin. More preferably, the solid thermal curing agent particles have an average particle size of 0.5 to 10 μm.

Examples of fine particles for coating the surface of the solid thermal curing agent particles include oxides, hydroxides, and halides of silicon, aluminum, titanium, iron, manganese, and magnesium as well as styrene beads and rubber particles. These fine particles may be used alone or in combination.

The fine particles preferably have an average particle size of 0.05 μm or less. Fine particles having an average particle size of more than 0.05 μm may inefficiently coat the surface of the solid thermal curing agent particles. More preferably, the fine particles have an average particle size of 0.03 μm or less. The fine particles preferably have a particle size of 10% or less of that of the solid thermal curing agent particles. Fine particles having a particle size of 10% or more may be insufficiently effective in controlling the reactivity.

The weight ratio of the solid thermal curing agent particles to the fine particles in the coated thermal curing agent is preferably 50:1 to 3:1. If the solid thermal curing agent particles are present in a weight ratio of more than 50, the fine particles may be insufficiently effective in controlling the reactivity. If the solid thermal curing agent particles are present in a weight ratio of less than 3, the fine particles are present in excess and may thus decrease the curing function. More preferably, the weight ratio of the solid thermal curing agent particles to the fine particles is 20:1 to 5:1.

The surface of the solid thermal curing agent particles may be coated with the fine particles by any method, for example, by homogeneously mixing the solid thermal curing agent particles and the fine particles in a container using a commercially available blender.

The coated thermal curing agent is preferably added to the curable resin composition in an amount of 1 to 100 parts by weight per 100 parts by weight of the curable resin composition. If the coated thermal curing agent is added in an amount of less than 1 part by weight, the curable resin composition may be insufficiently cured. If the coated thermal curing agent is added in an amount of more than 100 parts by weight, excess residual thermal curing agent may decrease the properties, such as toughness, of the resulting cured product.

The coated thermal curing agent, when added to the curable resin composition, exhibits high storage stability since the fine particles on the surface of the solid thermal curing agent particles minimize the contact between the solid thermal curing agent and the polymerizable resin during storage at room temperature. During curing, the solid thermal curing agent liquefies upon heating and contacts the curable resin without being blocked by the fine particles, thus quickly initiating a curing reaction. This improves the storage stability of the curable resin composition. The coated thermal curing agent can be significantly easily manufactured at room temperature within a short period of time without the use of a special reaction.

The curable resin composition according to the present invention preferably contains a thermal radical polymerization initiator. The term “thermal radical polymerization initiator” refers to a compound that produces radicals when heated, i.e., a compound that is degraded to produce radical species as it absorbs thermal energy. The thermal radical polymerization initiator is preferably present in an amount of 0.01 to 3.0 parts by mass per 100 parts by mass of the resin units. An excessive amount of thermal radical polymerization initiator results in low viscosity stability, whereas an insufficient amount of thermal radical polymerization initiator results in low curability.

As discussed above, if the curable resin composition according to the present invention is used as a liquid crystal sealant, it is preferred to minimize the decrease in the viscosity of the curable resin composition upon heating since an excessive decrease in the viscosity of the liquid crystal sealant upon heating results in dissolution of impurities and leakage of the liquid crystal. To reduce the decrease in resin viscosity upon heating, as discussed above, it is advantageous to control the carbon-carbon double bond content of the curable resin composition within a predetermined range. This improves the curing rate of the resin composition and thus promotes gelation. The decrease in resin viscosity can be further reduced by the proper use of a thermal radical polymerization initiator.

The gelation of the curable resin composition is promoted by the use of a thermal radical polymerization initiator having a low 10-hour half-life temperature. The term “10-hour half-life temperature” refers to the temperature required for the concentration of a thermal radical polymerization initiator to decrease to one half of its initial concentration after a pyrolysis reaction is performed at constant temperature in the presence of an inert gas for 10 hours. A curable resin composition containing a thermal radical polymerization initiator having a low 10-hour half-life temperature cures readily at low temperatures since radicals are readily produced at relatively low temperatures. A curable resin composition containing a thermal radical polymerization initiator having a high 10-hour half-life temperature has low curability since radicals are not readily produced.

To promote the gelation of the curable resin composition, therefore, the thermal radical polymerization initiator preferably has a 10-hour half-life temperature of 40° C. to 80° C., more preferably 50° C. to 70° C. A thermal radical polymerization initiator having a 10-hour half-life temperature of 80° C. or lower, or 70° C. or lower, readily produces radicals during the curing of the composition (the curing temperature is typically 80° C. to 150° C.). This promotes the curing reaction and thus reduces the decrease in viscosity during thermal curing.

A thermal radical polymerization initiator having an extremely low 10-hour half-life temperature, however, induces a curing reaction even at room temperature. This decreases the stability of the liquid crystal sealant. A curable resin composition containing a thermal radical polymerization initiator having a 10-hour half-life temperature of 40° C. or higher, preferably 50° C. or higher, exhibits good stability during storage and the application of the sealant to substrates (which is typically performed at room temperature).

Specifically, the 10-hour half-life temperature of the thermal radical polymerization initiator is determined as follows.

Assuming that the pyrolysis reaction is a first-order reaction gives the following equation.

ln(C₀/Cₜ)=kd×t [Math. 1]

where

C₀: initial concentration of thermal radical polymerization initiator

Cₜ: concentration of thermal radical polymerization initiator after t hours

kd: rate constant of pyrolysis

t: reaction time

The half-life is the time required for the concentration of a thermal radical polymerization initiator to decrease to one-half of its initial concentration, i.e., the time at which Cₜ−C₀/2. Hence, assuming that the thermal radical polymerization initiator has a half-life of t hours gives the following equation.

kd=(1/t)·ln 2 [Math. 2]

Substituting the Arrhenius equation, which describes the temperature dependence of the rate constant, gives the following equation.

kd=Aexp (−ΔE/RT)

(1/t)·ln 2:=Aexp(−ΔE/RT) [Math. 3]

where

A: frequency factor

ΔE: activation energy

R: gas constant (8.314 J/mol·K)

T: absolute temperature (K)

The values of A and ΔE are disclosed in J. Brandrup et al., “Polymer Handbook, 4th Edition, Volume 1, pages II-2 to 11-69, John & Wiley (1999)”. Hence, substituting t=10 hours give the 10-hour half-life temperature T.

Preferred thermal radical polymerization initiators include organic peroxides and azo compounds. Examples of organic peroxides include ketone peroxides, peroxyketals, hydroperoxides, dialkyl peroxides, peroxyesters, diacyl peroxides, and peroxydicarbonates.

Specific examples are shown below, where the numbers in parentheses beside the individual compounds are their respective 10-hour half-life temperatures (see catalogues available from Wako Pure Chemical Industries, Ltd. and API Corporation and the polymer handbook shown above).

Examples of ketone peroxides include methyl ethyl ketone peroxide (109° C.) and cyclohexanone peroxide (100° C.).

Examples of peroxyketals include 1,1-bis(t-hexylperoxy)-3,3,5-trimethylcyclohexane (87° C.), 1,1-bis(t-hexylperoxy)cyclohexane (87° C.), 1,1-bis(t-butylperoxy)cyclohexane (91° C.), 2,2-bis(t-butylperoxy)butane (103° C.), 1,1-(t-amylperoxy)cyclohexane (93° C.), n-butyl 4,4-bis(t-butylperoxy)valerate (105° C.), and 2,2-bis(4,4-di-t-butylperoxycyclohexyl)propane (95° C.).

Examples of hydroperoxides include P-methane hydroperoxide (128° C.), diisopropylbenzene peroxide (145° C.), 1,1,3,3-tetramethylbutyl hydroperoxide (153° C.), cumene hydroperoxide (156° C.), and t-butyl hydroperoxide (167° C.).

Examples of dialkyl peroxides include α,α-bis(t-butylperoxy)diisopropylbenzene (119° C.), dicumyl peroxide (116° C.), 2,5-dimethyl-2,5-bis(t-butylperoxy)hexane (118° C.), t-butyl cumyl peroxide (120° C.), t-amyl peroxide (123° C.), di-t-butyl peroxide (124° C.), and 2,5-dimethyl-2,5-bis(t-butylperoxy)hexane-3 (129° C.).

Examples of peroxyesters include cumyl peroxyneodecanoate (37° C.), 1,1,3,3-tetramethylbutyl peroxyneodecanoate (41° C.), t-hexyl peroxyneodecanoate (45° C.), t-butyl peroxyneodecanoate (46° C.), t-amyl peroxyneodecanoate (46° C.), t-hexyl peroxypivalate (53° C.), t-butyl peroxypivalate (55° C.), t-amyl peroxypivalate (55° C.), 1,1,3,3-tetramethylbutyl peroxy-2-ethylhexanoate (65° C.), 2,5-dimethyl-2,5-bis(2-ethylhexanoylperoxy)hexane (66° C.), t-hexyl peroxy-2-ethylhexanoate (70° C.), t-butyl peroxy-2-ethylhexanoate (72° C.), t-amyl peroxy-2-ethylhexanoate (75° C.), t-butyl peroxyisobutyrate (82° C.), t-hexylperoxyisopropyl monocarbonate (95° C.), t-butylperoxymaleic acid (96° C.), t-amyl peroxy-n-octoate (96° C.), t-amyl peroxyisononanoate (96° C.), t-butyl peroxy-3,5,5-trimethylhexanoate (97° C.), t-butyl peroxylaurate (98° C.), t-butylperoxyisopropyl monocarbonate (99° C.), t-butylperoxy-2-ethylhexyl monocarbonate (99° C.), t-hexyl peroxybenzoate (99° C.), 2,5-dimethyl-2,5-bis(benzoylperoxy)hexane (100° C.), t-amyl peroxyacetate (100° C.), t-amyl peroxybenzoate (100° C.), t-butyl peroxyacetate (102° C.), and t-butyl peroxybenzoate (104° C.).

Examples of diacyl peroxides include diisobutyryl peroxide (33° C.), di-3,5,5-trimethylhexanoyl peroxide (60° C.), dilauroyl peroxide (62° C.), disuccinoyl peroxide (66° C.), and dibenzoyl peroxide (73° C.).

Examples of peroxydicarbonates include di-n-propyl peroxydicarbonate (40° C.), diisopropyl peroxydicarbonate (41° C.), bis(4-t-butylcyclohexyl) peroxydicarbonate (41° C.), di-2-ethylhexyl peroxydicarbonate (44° C.), t-amyl peroxypropyl carbonate (96° C.), and t-amyl peroxy-2-ethylhexyl carbonate (99° C.).

The curable resin composition containing the compound containing at least one epoxy group per molecule may contain a radical polymerization inhibitor.

Examples of radical polymerization inhibitors include 2,6-di-t-butylcresol, butylated hydroxyanisole, 2,6-di-t-butyl-4-ethylphenol, stearyl 0-(3,5-di-t-butyl-4-hydroxyphenyl)propionate, 2,2′-methylenebis(4-methyl-6-t-butylphenol), 2,2′-methylenebis(4-ethyl-6-t-butylphenol), 4,4′-thiobis(3-methyl-6-t-butylphenol), 4,4-butylidenebis(3-methyl-6-t-butylphenol), 3,9-bis[1,1-dimethyl-2-[β-(3-t-butyl-4-hydroxy-5-methylphenyl)propionyloxy]ethyl], 2,4,8,10-tetraoxaspiro[5,5]undecane, tetrakis[methylene-3-(3′,5′-di-t-butyl-4′-hydroxyphenyl) propionate]methane, 1,3,5-tris(3′,5′-di-t-butyl-4′-hydroxybenzyl)-sec-triazine-2,4,6-(1H,3H,5H)trione, hydroquinone, p-methoxyphenol, p-benzoquinone, toluquinone, t-butyl-p-benzoquinone, 2,5-di-t-butyl-p-benzoquinone, and 2,5-diphenyl-p-benzoquinone, preferably p-benzoquinone, toluquinone, and t-butyl-p-benzoquinone. These radical polymerization inhibitors may be used alone or in combination.

The radical polymerization inhibitor is preferably added in an amount of 0.1 to 0.4 part by weight per 100 parts by weight of the curable resin composition. If the radical polymerization inhibitor is added in an amount of less than 0.1 part by weight, the curable resin composition may accidentally undergo a curing reaction in the event of unintentional heating during the storage of the sealant or during the manufacture of the liquid crystal display device. This induces changes in properties such as increased thickness. If the radical polymerization inhibitor is added in an amount of more than 0.4 part by weight, the resulting sealant may exhibit noticeably low thermal curability and may thus fail to cure when heated to cure the sealant.

The curable resin composition containing the compound containing at least one epoxy group per molecule may further contain a silane coupling agent. The silane coupling agent serves mainly as an adhesion aid to improve the adhesion between the sealant and the liquid crystal display substrate. The silane coupling agent may also be used to treat the surface of an inorganic or organic filler that is added, for example, to improve the adhesion through a stress dispersion effect or to improve the linear expansion coefficient. This improves the interaction between the filler and the resins that form the sealant.

The silane coupling agent is preferably a silane containing at least one functional group selected from Group (2-A) and at least one functional group selected from Group (2-B) below.

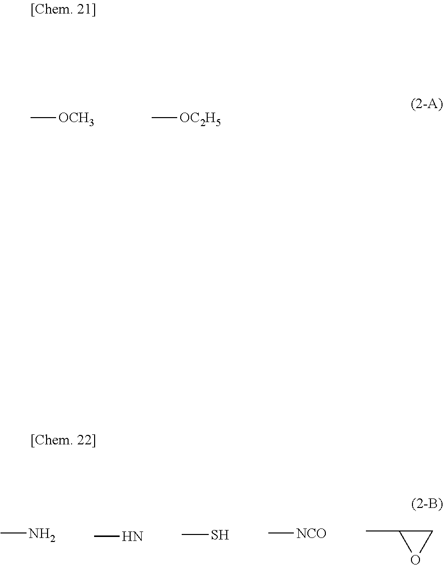

Specific examples of such silanes include γ-aminopropyltrimethoxysilane, γ-mercaptopropyltrimethoxysilane, γ-glycidoxypropyltrimethoxysilane, and γ-isocyanatopropyltrimethoxysilane. These silanes may be used alone or in combination.

A silane having such a structure, when used as a silane coupling agent, improves the adhesion to substrates and also reduces the dissolution of the curable resin into the liquid crystal by combining chemically with the curable resin through the functional group from Group (2-B).

To treat the surface of the filler with the silane coupling agent, the silane is mixed with the curable resin components, and the mixture is heated. Upon heating, the silane combines chemically with the curable resin components via the functional group from Group (2-B). To improve the reaction efficiency, it is preferred to stir the resin mixture during heating. The resin mixture may be stirred by any method, typically by rotating a stirrer or stirring impeller with a motor. The preferred heating temperature is 30° C. to 70° C. A heating temperature of lower than 30° C. may result in insufficient reaction between the silane and the curable resins. A heating temperature of higher than 70° C. may trigger thermal curing. A more preferred heating temperature is 40° C. to 60° C. The preferred heating time is one to two hours. A heating time of less than one hour may be insufficient to react all functional groups in the silane and may thus leave unreacted silane.

After heating, 10% or less of the at least one functional group selected from Group (2-B) should remain. If more than 10% of the at least one functional group selected from Group (2-B) remains, it may react with and thicken the resin components during storage and may dissolve into and contaminate the liquid crystal. The amount of at least one functional group selected from Group (2-B) remaining may be determined by 1H-NMR from the ratio of the peak intensity of the functional group in the silane to the peak intensity after heating.

A filler may be added to the curable resin composition containing the compound containing at least one epoxy group per molecule to control the viscosity and to improve the adhesion through a stress dispersion effect.

Examples of fillers include, but not limited to, inorganic fillers such as talc, asbestos, silica, diatomite, smectite, bentonite, calcium carbonate, magnesium carbonate, alumina, montmorillonite, diatomite, zinc oxide, iron oxide, magnesium oxide, tin oxide, titanium oxide, magnesium hydroxide, aluminum hydroxide, glass beads, silicon nitride, barium sulfate, gypsum, calcium silicate, sericite, activated clay, and aluminum nitride; and organic fillers such as polyester particles, polyurethane particles, vinyl polymer particles, acrylic polymer particles, and rubber particles.

These fillers may have any shape, including regular shapes such as spheres, needles, and plates and irregular shapes.

The curable resin composition containing the compound containing at least one epoxy group per molecule may contain resin particles.

The resin particles include a core particle made of a resin having rubber elasticity and a glass transition temperature of −10° C. or lower and a shell layer formed on the surface of the core particle and made of a resin having a glass transition temperature of 50° C. to 150° C.

Unless otherwise specified, the term “glass transition temperature” as used herein refers to the temperature measured by normal DSC at a heating rate of 10° C./min.

Examples of resins having rubber elasticity and a glass transition temperature of −10° C. or lower include, but not limited to, polymers of (meth)acrylic monomers.

Examples of (meth)acrylic monomers include ethyl acrylate, propyl acrylate, n-butyl acrylate, cyclohexyl acrylate, 2-ethylhexyl acrylate, ethyl methacrylate, and butyl methacrylate. These (meth)acrylic monomers may be homopolymerized or copolymerized.

Examples of resins having a glass transition temperature of 50° C. to 150° C. include, but not limited to, polymers of isopropyl methacrylate, t-butyl methacrylate, cyclohexyl methacrylate, phenyl methacrylate, methyl methacrylate, styrene, 4-chlorostyrene, 2-ethylstyrene, acrylonitrile, and vinyl chloride. These monomers may be used alone or in combination.

Although the particle size of the resin particles may be selected depending on the purpose of use, it is preferably 0.01 to 5 μm. Resin particles having a particle size within this range have a sufficient surface area with the photocurable resin to cause the core layer to swell effectively. When used in a sealant for liquid crystal displays, such resin particles also facilitate the procedure of defining the gap between substrates.

The resin particles may be manufactured by any method, for example, by forming core particles through emulsion polymerization using the monomer for the core alone and then adding and polymerizing the monomer for the shell to form a shell layer on the surface of the core particles.

The resin particles are preferably added to the curable resin composition in an amount of 15 to 50 parts by weight per 100 parts by weight of the photocurable resin. If the resin particles are added in an amount of less than 15 parts by weight, they may be insufficiently effective in improving the adhesion. If the resin particles are added in an amount of more than 50 parts by weight, they may thicken the curable resin composition more than necessary. More preferably, the resin particles are added in an amount of 20 parts by weight or less.

The curable resin composition containing the compound containing at least one epoxy group per molecule is cured with heat. Preferably, the curable resin composition is cured only with heat.

### Alignment Layer

The liquid crystal display device according to the present invention may include alignment layers for aligning the liquid crystal composition on the surfaces of the first and second substrates adjacent to the liquid crystal composition.

Examples of alignment layer materials that can be used include transparent organic materials such as polyimides, polyamides, benzocyclobutene (BCB) polymers, and polyvinyl alcohol. Particularly preferred are polyimide alignment layers, which are formed by the imidation of polyamic acids synthesized from diamines such as aliphatic and alicyclic diamines, including p-phenylenediamine and 4,4′-diaminodiphenylmethane, and aliphatic and alicyclic tetracarboxylic anhydrides such as butanetetracarboxylic anhydride and 2,3,5-tricarboxycyclopentylacetic anhydride or aromatic tetracarboxylic anhydrides such as pyromellitic dianhydride. Although rubbing is a typical alignment process, photoalignment by photodegradation may instead be used in this case. Alternatively, polyimide alignment layers may be used without an alignment process, for example, if they are used as vertical alignment layers.

Other alignment layer materials include compounds containing functional groups such as chalcone, cinnamate, cinnamoyl, and azo groups. These alignment layer materials may be used in combination with other materials such as polyimides and polyamides. In this case, either rubbing or photoalignment may be used.

Although the alignment layers are typically formed by applying the alignment layer material to the substrates using a process such as spin coating to form a resin layer, other processes such as uniaxial drawing and the Langmuir-Blodgett technique may be used instead.

### Transparent Electrode

The liquid crystal display device according to the present invention may include transparent electrodes made of conductive metal oxides. Examples of metal oxides that can be used include indium oxide (In₂O₃), tin oxide (SnO₂), zinc oxide (ZnO), indium tin oxide (In₂O₃—SnO₂), indium zinc oxide (In₂O₃—ZnO), niobium-doped titanium dioxide (Ti₁₋ₓNbₓO₂), fluorine-doped tin oxide, graphene nanoribbons, and metal nanowires, preferably zinc oxide (ZnO), indium tin oxide (In₂O₃—SnO₂), and indium zinc oxide (In₂O₃—ZnO). These transparent conductive films may be patterned by techniques such as photoetching and mask patterning.

The liquid crystal display device according to the present invention is particularly useful as an active-matrix-driven liquid crystal display device and can be used as a VA, PSVA, PSA, IPS, FFS, or ECB liquid crystal display device.

This liquid crystal display device can be used in combination with backlights for various applications, including liquid crystal display televisions, personal computer monitors, cell phone and smartphone displays, notebook personal computers, portable information terminals, and digital signage. Examples of backlights include cold cathode fluorescent lamp backlights and pseudo-white backlights with two or three wavelength peaks that include inorganic light-emitting diodes or organic EL devices.

### EXAMPLES

The present invention is further illustrated by the following examples, although these examples are not intended to limit the invention. In the following Examples and Comparative Examples, percentages for compositions are by mass.

The properties measured in the examples are as follows:

Tₙᵢ: nematic-isotropic liquid phase transition temperature (° C.)

Δn: refractive index anisotropy at 25° C.

Δ∈: dielectric anisotropy at 25° C.

η: viscosity (mPa·s) at 20° C.

γ1: rotational viscosity (mPa·s) at 25° C.

VHR: voltage holding ratio (%) at 70° C. (as determined by applying a voltage of 5 V to a cell having a cell thickness of 3.5 μm and filled with a liquid crystal composition for a pulse duration of 64 μs, measuring the voltage after a frame time of 200 ms, and calculating the percentage of the measured voltage to the initial applied voltage)

### Alignment Unevenness

Each liquid crystal display device was visually inspected for alignment unevenness around the contact area between the sealant and the liquid crystal with and without a voltage being applied. The liquid crystal display device was rated on the following four-level scale:

A: no alignment unevenness

B: slight and acceptable alignment unevenness

C: unacceptable alignment unevenness

D: severe alignment unevenness

### Image-Sticking

Each liquid crystal display device was evaluated for image-sticking as follows. After a predetermined fixed pattern was displayed within the display area for 1,000 hours, a uniform image was displayed over the entire screen and was visually inspected for image-sticking of the fixed pattern. The liquid crystal display device was rated on the following four-level scale:

A: no image-sticking

B: slight and acceptable image-sticking

C: unacceptable image-sticking

D: severe image-sticking

Volume Resistivity of Sealant after Curing

Each sealant was thinly and uniformly applied to the chromium-coated surface of a chromium-coated glass substrate and was cured with UV radiation to form a UV-cured coating having a size of 85 mm×85 mm and a thickness of 3 m. Another chromium-coated glass substrate was placed on the UV-cured coating with the chromium-coated surface thereof facing the UV-cured coating. These substrates were heated and pressed under a load on a hot plate at 120° C. for one hour to obtain a test sample. The area (S (cm²)) of the sealant on the test sample was measured. A predetermined voltage (V (V)) was applied between the chromium-coated surfaces of the opposing chromium-coated glass substrates using a constant-voltage generator (PA36-2A regulated DC power supply available from Kenwood Corporation). The current (A (A)) flowing through the coating was measured using an ammeter (R644C digital multimeter available from Advantest Corporation). The volume resistivity (Q·cm) was calculated by the following equation:

Volume resistivity (Ω·cm)=(V·S)/(A·T)

where T (cm) is the thickness of the sealant. A DC voltage of 500 V was applied for one minute.

### Resistivity of Sealant Before Curing

The resistivity of each sealant before curing was measured under standard temperature and humidity conditions (20° C., 65% RH) using a resistivity meter (SR-6517 available from Toyo Corporation) and electrodes for liquids (LE-21 available from Ando Electric Co., Ltd.).

The compounds used in the examples are represented by the following abbreviations:

### Side Chains and Linking Groups

-n: —CₙH₂ₙ₊₁ linear alkyl group of n carbon atoms

n-: CₙH₂ₙ₊₁-linear alkyl group of n carbon atoms

—On: —OCₙH₂ₙ₊₁ linear alkoxy group of n carbon atoms

nO—: CₙH₂ₙ₊₁O— linear alkoxy group of n carbon atoms

—V: —CH—CH₂

V—: CH₂—CH—

—V1: —CH═CH—CH₃

1V—: CH₃—CH═CH—

-2V: —CH₂—CH₂—CH═CH₃

V2-: CH₃═CH—CH₂—CH₂—

-2V1: —CH₂—CH₂—CH═CH—CH₃

1V2-: CH₃—CH═CH—CH₂—CH₂

-1O—: —CH₂O—

—O1-: —OCH₂—

### Cyclic Structures

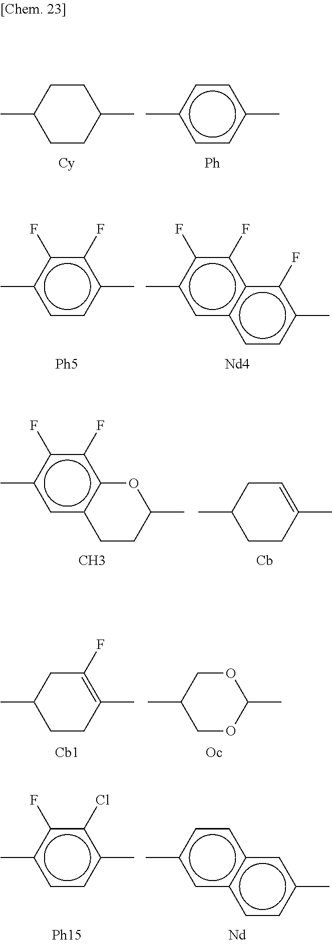

### Preparation of Curable Resin Composition

### Synthesis Example A

### Synthesis of Modified Epoxy Resin (A)

A solvent was heated to the reflux temperature with nitrogen purging. To the solvent was added dropwise over five hours a solution containing 100 parts by weight of glycidyl methacrylate, 40 parts by weight of methyl methacrylate, 20 parts by weight of hydroxyethyl methacrylate, 40 parts by weight of styrene, 200 parts by weight of n-butyl methacrylate, and 40 parts by weight of a polymerization initiator (Perbutyl O available from NOF Corporation, 10-hour half-life temperature: 72.1° C., t-butyl peroxy-2-ethylhexanoate). The solution was maintained at 100° C. for additional five hours. A hundred parts by weight of the resulting resin was filtered through a column filled with 30 parts by weight of a natural combination of quartz and kaolin (Sillitin V 85 available from Hoffmann Mineral GmbH) to allow it to adsorb ionic impurities from the reaction product. The solvent was removed to obtain Modified Epoxy Resin (A), which contained glycidyl and hydroxyl groups.

Modified Epoxy Resin (A) had a weight average molecular weight Mw of 4,020 (as measured by GPC), an epoxy equivalent weight of 640 g/eq, and a hydrogen-bonding functional group value of 3.4×10⁴ mol/g.

### Synthesis Example B

### Synthesis of Acrylic-Modified Epoxy Resin (B)

A solution was prepared by uniformly dissolving, in a solvent, 100 parts by weight of a bisphenol F epoxy resin (YDF-8170C available from Nippon Steel Chemical Co., Ltd.), 22.5 parts by weight of acrylic acid, and 0.125 parts by weight of triethanolamine. The solution was stirred under reflux at 110° C. for five hours. A hundred parts by weight of the resulting resin was filtered through a column filled with 30 parts by weight of a natural combination of quartz and kaolin (Sillitin V 85 available from Hoffmann Mineral GmbH) to allow it to adsorb ionic impurities from the reaction product. The solvent was removed to obtain Acrylic-Modified Epoxy Resin (B).

Acrylic-Modified Epoxy Resin (B) had a weight average molecular weight Mw of 392 (as measured by GPC), a hydrogen-bonding functional group value of 2.6×10⁻³ mol/g, and a carbon-carbon double bond content of 2.6×10⁻³ mol/g.

### Synthesis Example C

### Synthesis of Monoacrylate-Modified Epoxy Resin (C)

A solution was prepared by uniformly dissolving, in a solvent, 100 parts by weight of a bisphenol F epoxy resin (YDF-8170C available from Nippon Steel Chemical Co., Ltd.), 22.5 parts by weight of acrylic acid, and 0.125 part by weight of triethanolamine. The solution was stirred under reflux at 110° C. for five hours. A hundred parts by weight of the resulting resin was filtered through a column filled with 30 parts by weight of a natural combination of quartz and kaolin (Sillitin V 85 available from Hoffmann Mineral GmbH) to allow it to adsorb ionic impurities from the reaction product. The solvent was removed to obtain Monoacrylate-Modified Epoxy Resin (C).

Monoacrylate-Modified Epoxy Resin (C) had a weight average molecular weight Mw of 398 (as measured by GPC), a hydrogen-bonding functional group value of 2.5×10⁻³ mol/g, and a carbon-carbon double bond content of 2.5×10⁻³ mol/g.

### Synthesis Example D

### Synthesis of Diacrylate-Modified Epoxy Resin (D)

A solution was prepared by uniformly dissolving, in a solvent, 100 parts by weight of a bisphenol F epoxy resin (YDF-8170C available from Nippon Steel Chemical Co., Ltd.), 45 parts by weight of acrylic acid, and 0.20 part by weight of triethanolamine. The solution was stirred under reflux at 110° C. for five hours. A hundred parts by weight of the resulting resin was filtered through a column filled with 30 parts by weight of a natural combination of quartz and kaolin (Sillitin V 85 available from Hoffmann Mineral GmbH) to allow it to adsorb ionic impurities from the reaction product. The solvent was removed to obtain Diacrylate-Modified Epoxy Resin (D).

Diacrylate-Modified Epoxy Resin (D) had a weight average molecular weight Mw of 484 (as measured by GPC), a hydrogen-bonding functional group value of 4.3×10⁻³ mol/g, and a carbon-carbon double bond content of 4.3×10⁻³ mol/g.

### Synthesis Example E

### Synthesis of Diacrylate-Modified Epoxy Resin (E)

A solution was prepared by uniformly dissolving, in a solvent, 117 parts by weight of resorcinol diglycidyl ether (Denacol EX-201 available from Nagase ChemteX Corporation, epoxy equivalent weight: 117 eq/g), 79 parts by weight of acrylic acid, and 1 part by weight of t-butylammonium bromide. The solution was stirred at 90° C. for two hours and was then stirred under reflux for six hours to perform the reaction. The reaction solution was washed with ultrapure water, and the solvent was removed. A hundred parts by weight of the resulting resin was filtered through a column filled with 30 parts by weight of a natural combination of quartz and kaolin (Sillitin V 85 available from Hoffmann Mineral GmbH) to allow it to adsorb ionic impurities from the reaction product. The solvent was removed to obtain Diacrylate-Modified Epoxy Resin (E).

Diacrylate-Modified Epoxy Resin (E) had a weight average molecular weight Mw of 366 (as measured by GPC), a hydrogen-bonding functional group value of 5.3×10⁻³ mol/g, and a carbon-carbon double bond content of 5.3×10⁻³ mol/g.

### Synthesis Example F

### Synthesis of Diacrylate-Modified Epoxy Resin (F)

A solution was prepared by uniformly dissolving, in a solvent, 100 parts by weight of a diphenyl ether epoxy resin (YSLV-80DE available from Nippon Steel Chemical Co., Ltd., melting point: 84° C.), 0.2 part by weight of a polymerization inhibitor (p-methoxyphenol), 0.2 part by weight of a reaction catalyst (triethylamine), and 40 parts by weight of acrylic acid. While air was supplied, the solution was stirred at 80° C. for two hours and was then stirred under reflux for 36 hours to perform the reaction. The reaction solution was washed with ultrapure water, and the solvent was removed. A hundred parts by weight of the resulting resin was filtered through a column filled with 30 parts by weight of a natural combination of quartz and kaolin (Sillitin V 85 available from Hoffmann Mineral GmbH) to allow it to adsorb ionic impurities from the reaction product. The solvent was removed to obtain Diacrylate-Modified Epoxy Resin (F).

Diacrylate-Modified Epoxy Resin (F) had a weight average molecular weight Mw of 459 (as measured by GPC), a hydrogen-bonding functional group value of 3.7×10⁻³ mol/g, and a carbon-carbon double bond content of 3.7×10³ mol/g.

### Synthesis Example G

### Synthesis of Diacrylate-Modified Epoxy Resin (G)

A solution was prepared by uniformly dissolving, in a solvent, 296.2 g (2 mol) of phthalic anhydride, 917.0 g (2 mol) of an adduct of 2-hydroxyethyl acrylate and 6-hexanolide (Placcel FA3 available from Daicel Corporation, molecular weight: 459 g/mol), 4 g of triethylamine, and 0.9 g of hydroquinone. The solution was stirred at 110° C. to perform the reaction. The reaction temperature was adjusted to 90° C. when the acid value of the reaction mixture reached 96 mg KOH/g. To the reaction mixture were added 680.82 g (2 mol) of bisphenol A diglycidyl ether and 1.6 g of tetrabutylammonium bromide. The reaction was performed at 90° C. until the acid value of the reaction mixture reached 2 mg KOH/g.

To the reaction mixture were added 144.1 g (2 mol) of acrylic acid and 1.8 g of hydroquinone. The mixture was reacted at 80° C. for two hours while air was supplied to the flask. The temperature was increased to 90° C., and the reaction was continued. The reaction was performed until the acid value of the reaction mixture reached 2 mg KOH/g. After the reaction was complete, the reaction mixture was washed with ultrapure water, and the solvent was removed. A hundred parts by weight of the resulting resin was filtered through a column filled with 30 parts by weight of a natural combination of quartz and kaolin (Sillitin V 85 available from Hoffmann Mineral GmbH) to allow it to adsorb ionic impurities from the reaction product. The solvent was removed to obtain Diacrylate-Modified Epoxy Resin (G).

Diacrylate-Modified Epoxy Resin (G) had a weight average molecular weight Mw of 1,005 (as measured by GPC), a hydrogen-bonding functional group value of 1.9×10⁻³ mol/g, and a carbon-carbon double bond content of 1.9×10⁻³ mol/g.

### Synthesis Example H

### Synthesis of Partially Acrylic-Modified Epoxy Resin (H)

A solution was prepared by uniformly dissolving, in a solvent, 100 parts by weight of a diphenyl ether epoxy resin (YSLV-80DE available from Nippon Steel Chemical Co., Ltd., melting point: 84° C.), 0.2 part by weight of a polymerization inhibitor (p-methoxyphenol), 20 parts by weight of acrylic acid, and 0.2 part by weight of a reaction catalyst (triethylamine). While air was supplied, the solution was stirred at 80° C. for two hours and was then stirred under reflux for 24 hours to perform the reaction. After the reaction was complete, the reaction mixture was purified through a column and was washed with ultrapure water, and the solvent was removed. A hundred parts by weight of the resulting resin was filtered through a column filled with 30 parts by weight of a natural combination of quartz and kaolin (Sillitin V 85 available from Hoffmann Mineral GmbH) to allow it to adsorb ionic impurities from the reaction product. The solvent was removed to obtain Partially Acrylic-Modified Epoxy Resin (H), in which 50% of the epoxy groups were acrylated.

Partially Acrylic-Modified Epoxy Resin (H) had a weight average molecular weight Mw of 386 (as measured by GPC), a hydrogen-bonding functional group value of 2.2×10⁻³ mol/g, and a carbon-carbon double bond content of 2.2×10³ mol/g.

### Synthesis Example I

### Synthesis of Partially Methacrylic-Modified Epoxy Resin (I)

A solution was prepared by uniformly dissolving, in a solvent, 163 parts by weight of a bisphenol E epoxy resin (R-1710 available from Printec Corporation). To the solution were added 0.5 part by weight of p-methoxyphenol, serving as a polymerization inhibitor, 0.5 part by weight of triethylamine, serving as a reaction catalyst, and 40 parts by weight of methacrylic acid. While air was supplied, the mixture was stirred under reflux at 90° C. for five hours to perform the reaction.

After the reaction was complete, the reaction mixture was purified through a column and was washed with ultrapure water, and the solvent was removed. A hundred parts by weight of the resulting resin was filtered through a column filled with 30 parts by weight of a natural combination of quartz and kaolin (Sillitin V 85 available from Hoffmann Mineral GmbH) to allow it to adsorb ionic impurities from the reaction product. The solvent was removed to obtain Partially Methacrylic-Modified Epoxy Resin (I), in which 50% of the epoxy groups were methacrylated.

Partially Methacrylic-Modified Epoxy Resin (I) had a weight average molecular weight Mw of 436 (as measured by GPC), a hydrogen-bonding functional group value of 4.6×10⁻³ mol/g, and a carbon-carbon double bond content of 2.3×10⁻³ mol/g.

### Synthesis Example J

### Synthesis of Urethane-Modified Methacrylic Epoxy Resin (J)

A mixture was prepared from 1,100 parts by weight of trimethylolpropane, 1.6 parts by weight of 3,5-dibutyl-4-hydroxytoluene, serving as a polymerization inhibitor, 0.08 part by weight of dibutyltin dilaurate, serving as a reaction catalyst, and 6,080 parts by weight of diphenylmethane diisocyanate. The mixture was stirred under reflux at 60° C. for two hours to perform the reaction. To the mixture were added 235 parts by weight of 2-hydroxyethyl methacrylate and 910 parts by weight of glycidol. While air was supplied, the mixture was stirred under reflux at 90° C. for two hours to perform the reaction.

After the reaction was complete, the reaction mixture was purified through a column and was washed with ultrapure water, and the solvent was removed. A hundred parts by weight of the resulting resin was filtered through a column filled with 30 parts by weight of a natural combination of quartz and kaolin (Sillitin V 85 available from Hoffmann Mineral GmbH) to allow it to adsorb ionic impurities from the reaction product. The solvent was removed to obtain Urethane-Modified Methacrylic Epoxy Resin (J).

Urethane-Modified Methacrylic Epoxy Resin (J) had a weight average molecular weight Mw of 4,188 (as measured by GPC), a hydrogen-bonding functional group value of 2.9×10⁻³ mol/g, and a carbon-carbon double bond content of 2.2×10⁻⁴ mol/g.

### Preparation of Sealant

### Sealant (1)

In 160 parts by weight of Modified Epoxy Resin (A), 100 parts by weight of an o-cresol novolac epoxy resin (EOCN-1020-20 available from Nippon Kayaku Co., Ltd.) was dissolved by heating to obtain a homogeneous solution. After cooling, to the solution were added 60 parts by weight of a hydrazide curing agent (Amicure VDH-J available from Ajinomoto Fine-Techno Co., Inc.), serving as a latent thermal curing agent, 4 parts by weight of an imidazole curing agent (Curezol 2E4MZ-A available from Shikoku Chemicals Corporation), serving as a latent thermal curing agent, 72 parts by weight of spherical silica (Admafine AO-802 available from Admatechs Co., Ltd.), serving as a filler, and 4 parts by weight of a silane coupling agent (7-glycidoxypropyltrimethoxysilane, KBM-403 available from Shin-Etsu Chemical Co., Ltd.), serving as an additive. The mixture was stirred in a planetary stirrer, was milled on a ceramic three-roll mill, and was degassed and stirred in a planetary stirrer to obtain Sealant (1). The properties of Sealant (1) thus obtained are as follows:

Hydrogen-bonding functional group value (mol/g): 2.1×10⁻⁴

Resistivity of sealant before curing (Ω·cm): 4.8×10⁶

Volume resistivity of sealant after curing (Q·cm): 1.2×10¹³

### Sealant (2)

A mixture was prepared from 100 parts by weight of a solid o-cresol novolac epoxy resin (EOCN-1020-75 available from Nippon Kayaku Co., Ltd., epoxy equivalent weight: 215 g/eq), 433 parts by weight of PO-modified trisphenol triacrylate (molecular weight: 802, carbon-carbon double bond content: 0.0037 mol/g), and 217 parts by weight of Acrylic-Modified Epoxy Resin (B). The mixture was dissolved by heating. To the solution were added 42 parts by weight of a hydrazide curing agent (Amicure VDH available from Ajinomoto Fine-Techno Co., Inc.), serving as a latent thermal curing agent, 167 parts by weight of spherical silica (Seahostar S-30 available from Nippon Shokubai Co., Ltd.), serving as a filler, and 42 parts by weight of alkyl methacrylate copolymer particles (F-325 available from Zeon Corporation). The mixture was stirred in a planetary stirrer, was milled on a ceramic three-roll mill, and was degassed and stirred in a planetary stirrer. To the mixture was added 8.3 parts by weight of a thermal radical polymerization initiator (Luperox 575 available from Arkema Yoshitomi Ltd., 10-hour half-life temperature: 75° C.). The mixture was degassed and stirred in a planetary stirrer to obtain Sealant (2). The properties of Sealant (2) thus obtained are as follows:

Epoxy-to-(meth)acrylic equivalent ratio: 31:69

Hydrogen-bonding functional group value (mol/g): 7.4×10⁻⁴

Carbon-carbon double bond content (mol/g): 2.9×10⁻³

Resistivity of sealant before curing (Q·cm): 7.7×10⁸

Volume resistivity of sealant after curing (Q·cm): 1.5×10¹³

### Sealant (3)

In 700 parts by weight of Monoacrylate-Modified Epoxy Resin (C), 100 parts by weight of an o-cresol novolac epoxy resin (EOCN-1020-55 available from Nippon Kayaku Co., Ltd.) was dissolved by heating at 100° C. for one hour to obtain a homogeneous solution. After cooling, to the solution were added 800 parts by weight of Diacrylate-Modified Epoxy Resin (D), 0.2 part of p-benzoquinone (available from Seiko Chemical Co., Ltd.), 300 parts by weight of spherical silica (Admafine A-802 available from Admatechs Co., Ltd.), serving as an inorganic filler, 60 parts by weight of a thermal latent epoxy curing agent (Amicure VDH-J available from available from Ajinomoto Fine-Techno Co., Inc.), and 20 parts by weight of a silane coupling agent (γ-glycidoxypropyltrimethoxysilane, KBM-403 available from Shin-Etsu Chemical Co., Ltd.), serving as an additive. The mixture was stirred in a planetary stirrer, was milled on a ceramic three-roll mill, and was degassed and stirred in a planetary stirrer. To the mixture was added 20 parts by weight of a thermal radical polymerization initiator (V-601 available from Wako Pure Chemical Industries, Ltd., dimethyl 2,2′-azobis(isobutyrate), 10-hour half-life temperature: 66° C.). The mixture was degassed and stirred in a planetary stirrer to obtain 10 parts by weight of Sealant (3). The properties of Sealant (3) thus obtained are as follows:

Epoxy-to-(meth)acrylic equivalent ratio: 31:69

Hydrogen-bonding functional group value (mol/g): 3.2×10⁻³

Carbon-carbon double bond content (mol/g): 3.2×10⁻³

Resistivity of sealant before curing (Ω·cm): 4.9×109

Volume resistivity of sealant after curing (Ω·cm): 2.3×10¹³

### Sealant (4)

A mixture was prepared from 70 parts by weight of a bisphenol A epoxy resin (Epikote 828EL available from JER, epoxy equivalent weight: 190 g/eq), 10 parts by weight of a thermal latent epoxy curing agent (Amicure VDH available from Ajinomoto Fine-Techno Co., Inc.), 3 parts by weight of an imidazole curing agent (2-hydroxymethylimidazole), 30 parts by weight of Acrylic-Modified Epoxy Resin (B), 15 parts by weight of silicon dioxide (S-100 available from Nippon Shokubai Co., Ltd.), 20 parts by weight of polymer particles (F₃₂₅ available from Zeon Kasei Co., Ltd., primary particle size: 0.5 μm), and 0.5 part by weight of a silane coupling agent (γ-glycidoxypropyltrimethoxysilane, KBM-403 available from Shin-Etsu Chemical Co., Ltd.). The mixture was stirred in a planetary stirrer, was milled on a ceramic three-roll mill, and was degassed and stirred in a planetary stirrer to obtain Sealant (4). The properties of Sealant (4) thus obtained are as follows:

Epoxy-to-(meth)acrylic equivalent ratio: 88:12

Hydrogen-bonding functional group value (mol/g): 7.7×10⁻⁴

Carbon-carbon double bond content (mol/g): 7.7×10⁻⁴

Resistivity of sealant before curing (Ω·cm): 8.6×10⁷

Volume resistivity of sealant after curing (Q·cm): 1.3×10¹³

### Sealant (5)

A mixture was prepared from 25 parts by weight of a diacrylate-modified bisphenol A epoxy resin (Epoxy Ester 3002A available from Kyoeisha Chemical Co., Ltd., molecular weight: 600), 70 parts by weight of Acrylic-Modified Epoxy Resin (B), 5 parts by weight of a solid o-cresol novolac epoxy resin (EOCN-1020-75 available from Nippon Kayaku Co., Ltd., epoxy equivalent weight: 215 g/eq), 5 parts by weight of a latent epoxy curing agent (Amicure VDH available from Ajinomoto Fine-Techno Co., Inc., melting point: 120° C.), and 20 parts by weight of spherical silica (Seahostar S-30 available from Nippon Shokubai Co., Ltd.). The mixture was stirred in a planetary stirrer, was milled on a ceramic three-roll mill, and was degassed and stirred in a planetary stirrer. To the mixture was added 1 part by weight of a thermal radical polymerization initiator (Luperox 575 available from Arkema Yoshitomi Ltd., 10-hour half-life temperature: 75° C.). The mixture was degassed and stirred in a planetary stirrer to obtain Sealant (5). The properties of Sealant (5) thus obtained are as follows:

Epoxy-to-(meth)acrylic equivalent ratio: 43:57

Hydrogen-bonding functional group value (mol/g): 2.6×10⁻³

Carbon-carbon double bond content (mol/g): 2.6×10⁻³

Resistivity of sealant before curing (Q·cm): 3.1×10⁹

Volume resistivity of sealant after curing (Ω·cm): 2.1×10¹³

### Sealant (6)

A mixture was prepared from 15 parts by weight of a solid o-cresol novolac epoxy resin (EOCN-1020-75 available from Nippon Kayaku Co., Ltd., epoxy equivalent weight: 215 g/eq) and 45 parts by weight of a diacrylate-modified bisphenol A epoxy resin (Epoxy Ester 3002A available from Kyoeisha Chemical Co., Ltd. molecular weight: 600). The mixture was dissolved by heating at 100° C. for one hour to obtain a homogeneous solution. After cooling, to the solution were added 20 parts by weight of Acrylic-Modified Epoxy Resin (B), 0.5 part by weight of a radical chain transfer agent (Karenz MT NR-1 available from Showa Denko K.K., 1,3,5-tris(3-mercaptobutyloxyethyl)-1,3,5-triazine-2,4,6(1H,3H,5H)-trione), 15 parts by weight of spherical silica (Seahostar S-30 available from Nippon Shokubai Co., Ltd.), 3 parts by weight of a latent epoxy curing agent (Amicure VDH available from Ajinomoto Fine-Techno Co., Inc., melting point: 120° C.), and 1 part by weight of a silane coupling agent (γ-glycidoxypropyltrimethoxysilane, KBM-403 available from Shin-Etsu Chemical Co., Ltd.), serving as an additive. The mixture was stirred in a planetary stirrer, was milled on a ceramic three-roll mill, and was degassed and stirred in a planetary stirrer. To the mixture was added 0.5 part by weight of a thermal radical polymerization initiator (V-601 available from Wako Pure Chemical Industries, Ltd., dimethyl 2,2′-azobis(isobutyrate), 10-hour half-life temperature: 66° C.). The mixture was vacuum-degassed and stirred in a planetary stirrer to obtain Sealant (6). The properties of Sealant (6) thus obtained are as follows:

Epoxy-to-(meth)acrylic equivalent ratio: 37:63

Hydrogen-bonding functional group value (mol/g): 2.51×10⁻³

Carbon-carbon double bond content (mol/g): 2.51×10⁻³

Resistivity of sealant before curing (Ω·cm): 1.3×10⁹

Volume resistivity of sealant after curing (Q·cm): 1.9×10¹³

### Sealant (7)

A mixture was prepared from 20 parts by weight of Diacrylate-Modified Epoxy Resin (E), 25 parts by weight of Diacrylate-Modified Epoxy Resin (F), 25 parts by weight of Diacrylate-Modified Epoxy Resin (G), 25 parts by weight of Partially Acrylic-Modified Epoxy Resin (H), 5 parts by weight of a solid o-cresol novolac epoxy resin (available from Nippon Kayaku Co., Ltd., EOCN-1020-75, epoxy equivalent weight: 215 g/eq), 25 parts by weight of spherical silica (Seahostar S-30 available from Nippon Shokubai Co., Ltd.), 8 parts by weight of a latent epoxy curing agent (Amicure VDH available from Ajinomoto Fine-Techno Co., Inc.), and 2 parts by weight of alkyl methacrylate copolymer particles (F-325 available from Zeon Corporation). The mixture was stirred in a planetary stirrer, was milled on a ceramic three-roll mill, and was degassed and stirred in a planetary stirrer. To the mixture was added 1 part by weight of a thermal radical polymerization initiator (V-65 available from Wako Pure Chemical Industries, Ltd., 2,2′-azobis(2,4-dimethylvaleronitrile), 10-hour half-life temperature: 51° C.) The mixture was vacuum-degassed and stirred in a planetary stirrer to obtain Sealant (7). The properties of Sealant (7) thus obtained are as follows:

Epoxy-to-(meth)acrylic equivalent ratio: 19:81

Carbon-carbon double bond content (mol/g): 3.01×10⁻³

Hydrogen-bonding functional group value (mol/g): 3.01×10⁻³

Resistivity of sealant before curing (Ω·cm): 3.5×10⁹

Volume resistivity of sealant after curing (Q·cm): 2.2×10¹³

### Sealant (8)

A mixture was prepared from 50 parts by weight of Methacrylic-Modified Bisphenol E Epoxy Resin (I), 50 parts by weight of Urethane-Modified Methacrylic Epoxy Resin (J), 35 parts by weight of spherical silica (SO—C1 available from Admatechs Co., Ltd.), 8 parts by weight of a latent epoxy curing agent (Amicure VDH available from Ajinomoto Fine-Techno Co., Inc.), 1.5 parts by weight of a silane coupling agent (γ-acryloxypropyltrimethoxysilane, KBM5103 available from Shin-Etsu Chemical Co., Ltd.), and alkyl methacrylate copolymer particles (F-325 available from Zeon Corporation). The mixture was stirred in a planetary stirrer, was milled on a ceramic three-roll mill, and was degassed and stirred in a planetary stirrer. To the mixture was added 0.5 part by weight of a thermal radical polymerization initiator (V-65 available from Wako Pure Chemical Industries, Ltd., 10-hour half-life temperature: 51° C.). The mixture was vacuum-degassed and stirred in a planetary stirrer to obtain Sealant (8). The properties of Sealant (8) thus obtained are as follows:

Epoxy-to-(meth)acrylic equivalent ratio: 60:40

Carbon-carbon double bond content (mol/g): 1.26×10⁻³

Hydrogen-bonding functional group value (mol/g): 3.75×10⁻³

Resistivity of sealant before curing (Ω·cm): 1.2×10⁹

Volume resistivity of sealant after curing (Q·cm): 1.8×10⁻³

### Comparative Sealant (C1)

A curable resin composition was prepared from 35 parts by weight of urethane acrylate (AH-600 available from Kyoeisha Chemical Co., Ltd.), 15 parts by weight of 2-hydroxybutyl acrylate, 50 parts by weight of isobornyl acrylate, and 0.5 part by weight of a thermal radical polymerization initiator (V-65 available from Wako Pure Chemical Industries, Ltd., 10-hour half-life temperature: 51° C.). The curable resin composition was stirred in a planetary stirrer and was uniformly milled on a ceramic three-roll mill to obtain Comparative Sealant (C1), which was photocurable. The properties of Comparative Sealant (C1) thus obtained are as follows:

Hydrogen-bonding functional group value: 2.2×10⁻⁵

Resistivity of sealant before curing (Q·cm): 5.0×10⁶

Volume resistivity of sealant after curing (Ω·cm): 2.3×10¹³

### Comparative Sealant (C2)

A curable resin composition was prepared from 50 parts by weight of a bisphenol A epoxy resin (jER828US available from Mitsubishi Chemical Corporation) and 25 parts by weight of a hydrazide curing agent (NDH available from Japan Hydrazine Co., Ltd.). The curable resin composition was stirred in a planetary stirrer and was uniformly milled on a ceramic three-roll mill to obtain Comparative Sealant (C2). The properties of Comparative Sealant (C2) thus obtained are as follows:

Hydrogen-bonding functional group value: 2.7×10⁻⁷

Resistivity of sealant before curing (Ω·cm): 5.0×10¹⁰

Volume resistivity of sealant after curing (Ω·cm): 3.0×10¹³

### Examples 1 to 8

Transparent electrodes were formed on first and second substrates. A black matrix (BM) was formed on the second substrate. Vertical alignment layers (SE-5300) were formed on the opposing surfaces of the two substrates and were subjected to an alignment process. One of Sealants (1) to (8) was loaded into a syringe for dispensing and was degassed. The sealant was applied to the alignment layer on the first substrate using a dispenser to form a rectangular frame pattern. Small droplets of Liquid Crystal Composition 1 shown in the following table were dispensed over the entire area within the frame pattern of the uncured sealant on the first substrate, immediately followed by laminating the second substrate in a vacuum of 5 Pa using a vacuum lamination system. The drawing conditions and the gap between the substrates were controlled so that, after the vacuum was released, the pressed sealant had a line width of about 1.2 mm and overlapped the BM by 0.3 mm. The laminate was immediately heated in a constant-temperature unit at 150° C. for 90 minutes to cure the sealant. In this way, VA liquid crystal display devices of Examples 1 to 5 were fabricated (d_{gap}=3.5 μm). The resulting liquid crystal display devices were tested for VHR and were evaluated for alignment unevenness and image-sticking. The results are shown in the following tables.

TABLE 1
Liquid Crystal Composition 1

| | |
|---|---|
| T_{NI}/° C. | 81.0 |
| Δn | 0.103 |
| Δ∈ | −2.9 |
| η/mPa · s | 20.3 |
| γ₁/mPa · s | 112 |
| γ₁/Δn² × 10⁻² | 105 |
| 3-Cy-Cy-2 | 24% |
| 3-Cy-Cy-4 | 10% |
| 3-Cy-Cy-5 | 5% |
| 3-Cy-Ph—O1 | 2% |
| 3-Cy-Ph5—O2 | 13% |
| 2-Cy-Ph—Ph5—O2 | 9% |
| 3-Cy-Ph—Ph5—O2 | 9% |
| 3-Cy-Cy-Ph5—O3 | 5% |
| 4-Cy-Cy-Ph5—O2 | 6% |
| 5-Cy-Cy-Ph5—O2 | 5% |
| 3-Ph—Ph5—Ph-2 | 6% |
| 4-Ph—Ph5—Ph-2 | 6% |

TABLE 2

| | Example 1 | Example 2 | Example 3 | Example 4 | Example 5 |
|---|---|---|---|---|---|
| Liquid | Liquid Crystal | Liquid Crystal | Liquid Crystal | Liquid Crystal | Liquid Crystal |
| crystal | Composition1 | Composition1 | Composition1 | Composition1 | Composition1 |
| composition | | | | | |
| Sealant | Sealant (1) | Sealant (2) | Sealant (3) | Sealant (4) | Sealant (5) |
| VHR | 99.0 | 99.2 | 99.5 | 99.1 | 99.4 |
| Alignment | B | A | A | B | A |
| unevenness | | | | | |
| Image- | B | B | A | A | A |
| sticking | | | | | |

TABLE 3

| | Example 6 | Example 7 | Example 8 |
|---|---|---|---|
| Liquid | Liquid Crystal | Liquid Crystal | Liquid Crystal |
| crystal | Composition1 | Composition1 | Composition1 |
| composition | | | |
| Sealant | Sealant (6) | Sealant (7) | Sealant (8) |
| VHR | 99.3 | 99.5 | 99.3 |
| Alignment | A | A | A |
| unevenness | | | |
| Image- | B | A | B |
| sticking | | | |

Liquid Crystal Composition 1 was found to have a liquid crystal layer temperature limit of 81.0° C., which is practical for television applications, a large absolute value of dielectric anisotropy, a low viscosity, and a suitable Δn.

The liquid crystal display devices of Examples 1 to 8 had high VHRs and exhibited no or only slight and acceptable alignment unevenness and image-sticking.

### Examples 9 to 24

Liquid crystal display devices of Examples 9 to 24 were fabricated using Sealants (1) to (8) as in Example 1 except that Liquid Crystal Compositions 2 and 3 shown in the following tables were sandwiched therein. The resulting liquid crystal display devices were tested for VHR and were evaluated for alignment unevenness and image-sticking. The results are shown in the following tables.

TABLE 4
Liquid Crystal Composition 2

| | |
|---|---|
| T_{NI}/° C. | 76.0 |
| Δn | 0.103 |
| Δ∈ | −2.9 |
| η/mPa · s | 19.8 |
| γ₁/mPa · s | 110 |
| γ₁/Δn² × 10⁻² | 103 |
| 3-Cy-Cy-2 | 24% |
| 3-Cy-Cy-4 | 10% |
| 3-Cy-Ph—O1 | 7% |
| 3-Cy-Ph5—O2 | 14% |
| 2-Cy-Ph—Ph5—O2 | 7% |
| 3-Cy-Ph—Ph5—O2 | 9% |
| 3-Cy-Cy-Ph5—O3 | 5% |
| 4-Cy-Cy-Ph5—O2 | 7% |
| 5-Cy-Cy-Ph5—O2 | 5% |
| 3-Ph—Ph5—Ph-2 | 6% |
| 4-Ph—Ph5—Ph-2 | 6% |

Liquid Crystal Composition 3

| | |
|---|---|
| T_{NI}/° C. | 84.8 |
| Δn | 0.103 |
| Δ∈ | −2.9 |
| η/mPa · s | 21.4 |
| γ₁/mPa · s | 119 |
| γ₁/Δn² × 10⁻² | 112 |
| 3-Cy-Cy-2 | 24% |
| 3-Cy-Cy-4 | 11% |
| 3-Cy-Ph5—O2 | 12% |
| 2-Cy-Ph—Ph5—O2 | 5% |
| 3-Cy-Ph—Ph5—O2 | 6% |
| 3-Cy-Cy-Ph5—O3 | 8% |
| 4-Cy-Cy-Ph5—O2 | 8% |
| 5-Cy-Cy-Ph5—O2 | 8% |
| 3-Ph—Ph5—Ph-2 | 6% |
| 4-Ph—Ph5—Ph-2 | 6% |
| 5-Ph—Ph-1 | 3% |
| 3-Cy-Cy-Ph-1 | 3% |

TABLE 5

| | Example 9 | Example 10 | Example 11 | Example 12 | Example 13 |
|---|---|---|---|---|---|
| Liquid | Liquid Crystal | Liquid Crystal | Liquid Crystal | Liquid Crystal | Liquid Crystal |
| crystal | Composition 2 | Composition 2 | Composition 2 | Composition 2 | Composition 2 |
| composition | | | | | |
| Sealant | Sealant (1) | Sealant (2) | Sealant (3) | Sealant (4) | Sealant (5) |
| VHR | 99.1 | 99.3 | 99.6 | 99.2 | 99.5 |
| Alignment | B | A | A | B | A |
| unevenness | | | | | |
| Image- | B | B | A | B | A |
| sticking | | | | | |

TABLE 6

| | Example 14 | Example 15 | Example 16 |
|---|---|---|---|
| Liquid | Liquid Crystal | Liquid Crystal | Liquid Crystal |
| crystal | Composition 2 | Composition 2 | Composition 2 |
| composition | | | |
| Sealant | Sealant (6) | Sealant (7) | Sealant (8) |
| VHR | 99.5 | 99.6 | 99.4 |
| Alignment | B | A | B |
| unevenness | | | |
| Image- | A | A | A |
| sticking | | | |

TABLE 7

| | Example 17 | Example 18 | Example 19 | Example 20 | Example 21 |
|---|---|---|---|---|---|
| Liquid | Liquid Crystal | Liquid Crystal | Liquid Crystal | Liquid Crystal | Liquid Crystal |
| crystal | Composition 3 | Composition 3 | Composition 3 | Composition 3 | Composition 3 |
| composition | | | | | |
| Sealant | Sealant (1) | Sealant (2) | Sealant (3) | Sealant (4) | Sealant (5) |
| VHR | 99.0 | 99.2 | 99.6 | 99.1 | 99.4 |
| Alignment | B | A | A | B | A |
| unevenness | | | | | |
| Image- | B | B | A | B | B |
| sticking | | | | | |

TABLE 8

| | Example 22 | Example 23 | Example 24 |
|---|---|---|---|
| Liquid | Liquid Crystal | Liquid Crystal | Liquid Crystal |
| crystal | Composition 3 | Composition 3 | Composition 3 |
| composition | | | |
| Sealant | Sealant (6) | Sealant (7) | Sealant (8) |
| VHR | 99.4 | 99.5 | 99.3 |
| Alignment | A | A | B |
| unevenness | | | |
| Image- | A | A | A |
| sticking | | | |

Liquid Crystal Compositions 2 and 3 were found to have practical liquid crystal layer temperature limits for television applications, large absolute values of dielectric anisotropy, low viscosities, and suitable Δn.

The liquid crystal display devices of Examples 9 to 24 had high VHRs and exhibited no or only slight and acceptable alignment unevenness and image-sticking.

### Examples 25 to 48

Liquid crystal display devices of Examples 25 to 48 were fabricated using Sealants (1) to (8) as in Example 1 except that Liquid Crystal Compositions 4 to 6 shown in the following tables were sandwiched therein. The resulting liquid crystal display devices were tested for VHR and were evaluated for alignment unevenness and image-sticking. The results are shown in the following tables.

TABLE 9
Liquid Crystal Composition 4

| | |
|---|---|
| T_{NI}/° C. | 74.9 |
| Δn | 0.102 |
| Δ∈ | −2.9 |
| η/mPa · s | 21.1 |
| γ₁/mPa · s | 118 |
| γ₁/Δn² × 10⁻² | 111 |
| 3-Cy-Cy-2 | 22% |
| 3-Cy-Cy-4 | 11% |
| 3-Cy-Ph5—O2 | 7% |
| 3-Cy-Ph5—O4 | 8% |
| 2-Cy-Ph—Ph5—O2 | 6% |
| 3-Cy-Ph—Ph5—O2 | 7% |
| 3-Cy-Cy-Ph5—O3 | 7% |
| 4-Cy-Cy-Ph5—O2 | 7% |
| 5-Cy-Cy-Ph5—O2 | 7% |
| 3-Ph—Ph5—Ph-2 | 4% |
| 4-Ph—Ph5—Ph-2 | 4% |
| 5-Ph—Ph-1 | 8% |
| 3-Cy-Cy-Ph-1 | 2% |

Liquid Crystal Composition 5

| | |
|---|---|
| T_{NI}/° C. | 80.2 |
| Δn | 0.105 |
| Δ∈ | −2.9 |
| η/mPa · s | 22.7 |
| γ₁/mPa · s | 124 |
| γ₁/Δn² × 10⁻² | 112 |
| 3-Cy-Cy-2 | 20% |
| 3-Cy-Cy-4 | 10% |
| 3-Cy-Ph5—O2 | 7% |
| 3-Cy-Ph5—O4 | 7% |
| 2-Cy-Ph—Ph5—O2 | 6% |
| 3-Cy-Ph—Ph5—O2 | 7% |
| 3-Cy-Cy-Ph5—O3 | 7% |
| 4-Cy-Cy-Ph5—O2 | 8% |
| 5-Cy-Cy-Ph5—O2 | 7% |
| 3-Ph—Ph5—Ph-2 | 4% |
| 4-Ph—Ph5—Ph-2 | 4% |
| 5-Ph—Ph-1 | 8% |
| 3-Cy-Cy-Ph-1 | 5% |

Liquid Crystal Composition 6

| | |
|---|---|
| T_{NI}/° C. | 85.7 |
| Δn | 0.104 |
| Δ∈ | −3.0 |
| η/mPa · s | 22.9 |
| γ₁/mPa · s | 126 |
| γ₁/Δn² × 10⁻² | 116 |
| 3-Cy-Cy-2 | 20% |
| 3-Cy-Cy-4 | 10% |
| 3-Cy-Ph5—O2 | 7% |
| 3-Cy-Ph5—O4 | 7% |
| 2-Cy-Ph—Ph5—O2 | 6% |
| 3-Cy-Ph—Ph5—O2 | 7% |
| 3-Cy-Cy-Ph5—O3 | 7% |
| 4-Cy-Cy-Ph5—O2 | 8% |
| 5-Cy-Cy-Ph5—O2 | 7% |
| 3-Ph—Ph5—Ph-2 | 4% |
| 4-Ph—Ph5—Ph-2 | 4% |
| 5-Ph—Ph-1 | 5% |
| 3-Cy-Cy-Ph-1 | 8% |

TABLE 10

| | Example 25 | Example 26 | Example 27 | Example 28 | Example 29 |
|---|---|---|---|---|---|
| Liquid | Liquid Crystal | Liquid Crystal | Liquid Crystal | Liquid Crystal | Liquid Crystal |
| crystal | Composition 4 | Composition 4 | Composition 4 | Composition 4 | Composition 4 |
| composition | | | | | |
| Sealant | Sealant (1) | Sealant (2) | Sealant (3) | Sealant (4) | Sealant (5) |
| VHR | 99.1 | 99.2 | 99.5 | 99.1 | 99.3 |
| Alignment | B | B | A | B | A |
| unevenness | | | | | |
| Image- | B | A | A | B | A |
| sticking | | | | | |

TABLE 11

| | Example 30 | Example 31 | Example 32 |
|---|---|---|---|
| Liquid | Liquid Crystal | Liquid Crystal | Liquid Crystal |
| crystal | Composition 4 | Composition 4 | Composition 4 |
| composition | | | |
| Sealant | Sealant (6) | Sealant (7) | Sealant (8) |
| VHR | 99.3 | 99.4 | 99.2 |
| Alignment | A | A | B |
| unevenness | | | |
| Image- | B | A | A |
| sticking | | | |

TABLE 12

| | Example 33 | Example 34 | Example 35 | Example 36 | Example 37 |
|---|---|---|---|---|---|
| Liquid | Liquid Crystal | Liquid Crystal | Liquid Crystal | Liquid Crystal | Liquid Crystal |
| crystal | Composition 5 | Composition 5 | Composition 5 | Composition 5 | Composition 5 |
| composition | | | | | |
| Sealant | Sealant (1) | Sealant (2) | Sealant (3) | Sealant (4) | Sealant (5) |
| VHR | 98.9 | 99.1 | 99.4 | 99.0 | 99.3 |
| Alignment | B | B | A | B | A |
| unevenness | | | | | |
| Image- | B | A | A | B | A |
| sticking | | | | | |

TABLE 13

| | Example 38 | Example 39 | Example 40 |
|---|---|---|---|
| Liquid | Liquid Crystal | Liquid Crystal | Liquid Crystal |
| crystal | Composition 5 | Composition 5 | Composition 5 |
| composition | | | |
| Sealant | Sealant (6) | Sealant (7) | Sealant (8) |
| VHR | 99.2 | 99.3 | 99.1 |
| Alignment | A | A | A |
| unevenness | | | |
| Image- | B | A | B |
| sticking | | | |

TABLE 14

| | Example 41 | Example 42 | Example 43 | Example 44 | Example 45 |
|---|---|---|---|---|---|
| Liquid | Liquid Crystal | Liquid Crystal | Liquid Crystal | Liquid Crystal | Liquid Crystal |
| crystal | Composition 6 | Composition 6 | Composition 6 | Composition 6 | Composition 6 |
| composition | | | | | |
| Sealant | Sealant (1) | Sealant (2) | Sealant (3) | Sealant (4) | Sealant (5) |
| VHR | 99.0 | 99.2 | 99.6 | 99.1 | 99.4 |
| Alignment | B | B | A | A | A |
| unevenness | | | | | |
| Image- | B | A | A | B | A |
| sticking | | | | | |

TABLE 15

| | Example 46 | Example 47 | Example 48 |
|---|---|---|---|
| Liquid | Liquid Crystal | Liquid Crystal | Liquid Crystal |
| crystal | Composition 6 | Composition 6 | Composition 6 |
| composition | | | |
| Sealant | Sealant (6) | Sealant (7) | Sealant (8) |
| VHR | 99.3 | 99.5 | 99.3 |
| Alignment | A | A | A |
| unevenness | | | |
| Image- | A | A | B |
| sticking | | | |

Liquid Crystal Compositions 4 to 6 were found to have practical liquid crystal layer temperature limits for television applications, large absolute values of dielectric anisotropy, low viscosities, and suitable Δn.

The liquid crystal display devices of Examples 25 to 48 had high VHRs and exhibited no or only slight and acceptable alignment unevenness and image-sticking.

### Examples 49 to 72

Liquid crystal display devices of Examples 49 to 72 were fabricated using Sealants (1) to (8) as in Example 1 except that Liquid Crystal Compositions 7 to 9 shown in the following tables were sandwiched therein. The resulting liquid crystal display devices were tested for VHR and were evaluated for alignment unevenness and image-sticking. The results are shown in the following tables.

TABLE 16
Liquid Crystal Composition 7

| | |
|---|---|
| T_{NI}/° C. | 75.1 |
| Δn | 0.103 |
| Δ∈ | −2.6 |
| η/mPa · s | 20.5 |
| γ₁/mPa · s | 117 |
| γ₁/Δn² × 10⁻² | 110 |
| 3-Cy-Cy-2 | 15% |
| 3-Cy-Cy-4 | 12% |
| 3-Cy-Cy-5 | 7% |
| 3-Cy-Ph—O1 | 12% |
| 3-Cy-Ph5—O2 | 6% |
| 3-Cy-Ph5—O4 | 7% |
| 2-Cy-Ph—Ph5—O2 | 11% |
| 3-Cy-Ph—Ph5—O2 | 12% |
| 3-Cy-Cy-Ph5—O3 | 3% |
| 4-Cy-Cy-Ph5—O2 | 4% |
| 5-Cy-Cy-Ph5—O2 | 3% |
| 3-Ph—Ph5—Ph-2 | 4% |
| 4-Ph—Ph5—Ph-2 | 4% |

Liquid Crystal Composition 8

| | |
|---|---|
| T_{NI}/° C. | 80.4 |
| Δn | 0.103 |
| Δ∈ | −2.6 |
| η/mPa · s | 21.6 |
| γ₁/mPa · s | 125 |
| γ₁/Δn² × 10⁻² | 117 |
| 3-Cy-Cy-2 | 15% |
| 3-Cy-Cy-4 | 12% |
| 3-Cy-Cy-5 | 7% |
| 3-Cy-Ph—O1 | 12% |
| 3-Cy-Ph5—O2 | 5% |
| 3-Cy-Ph5—O4 | 5% |
| 2-Cy-Ph—Ph5—O2 | 11% |
| 3-Cy-Ph—Ph5—O2 | 11% |
| 3-Cy-Cy-Ph5—O3 | 4% |
| 4-Cy-Cy-Ph5—O2 | 6% |
| 5-Cy-Cy-Ph5—O2 | 4% |
| 3-Ph—Ph5—Ph-2 | 4% |
| 4-Ph—Ph5—Ph-2 | 4% |

Liquid Crystal Composition 9

| | |
|---|---|
| T_{NI}/° C. | 85.1 |
| Δn | 0.103 |
| Δ∈ | −2.6 |
| η/mPa · s | 22.7 |
| γ₁/mPa · s | 130 |
| γ₁/Δn² × 10⁻² | 122 |
| 3-Cy-Cy-2 | 10% |
| 3-Cy-Cy-4 | 15% |
| 3-Cy-Cy-5 | 12% |
| 3-Cy-Ph—O1 | 9% |
| 3-Cy-Ph5—O2 | 5% |
| 3-Cy-Ph5—O4 | 5% |
| 2-Cy-Ph—Ph5—O2 | 11% |
| 3-Cy-Ph—Ph5—O2 | 11% |
| 3-Cy-Cy-Ph5—O3 | 4% |
| 4-Cy-Cy-Ph5—O2 | 6% |
| 5-Cy-Cy-Ph5—O2 | 4% |
| 3-Ph—Ph5—Ph-2 | 4% |
| 4-Ph—Ph5—Ph-2 | 4% |

TABLE 17

| | Example 49 | Example 50 | Example 51 | Example 52 | Example 53 |
|---|---|---|---|---|---|
| Liquid | Liquid Crystal | Liquid Crystal | Liquid Crystal | Liquid Crystal | Liquid Crystal |
| crystal | Composition 7 | Composition 7 | Composition 7 | Composition 7 | Composition 7 |
| composition | | | | | |
| Sealant | Sealant (1) | Sealant (2) | Sealant (3) | Sealant (4) | Sealant (5) |
| VHR | 99.2 | 99.4 | 99.7 | 99.3 | 99.6 |
| Alignment | B | B | A | B | A |
| unevenness | | | | | |
| Image- | B | A | A | A | A |
| sticking | | | | | |

TABLE 18

| | Example 54 | Example 55 | Example 56 |
|---|---|---|---|
| Liquid | Liquid Crystal | Liquid Crystal | Liquid Crystal |
| crystal | Composition 7 | Composition 7 | Composition 7 |
| composition | | | |
| Sealant | Sealant (6) | Sealant (7) | Sealant (8) |
| VHR | 99.5 | 99.6 | 99.4 |
| Alignment | A | A | B |
| unevenness | | | |
| Image- | A | A | A |
| sticking | | | |

TABLE 19

| | Example 57 | Example 58 | Example 59 | Example 60 | Example 61 |
|---|---|---|---|---|---|
| Liquid | Liquid Crystal | Liquid Crystal | Liquid Crystal | Liquid Crystal | Liquid Crystal |
| crystal | Composition 8 | Composition 8 | Composition 8 | Composition 8 | Composition 8 |
| composition | | | | | |
| Sealant | Sealant (1) | Sealant (2) | Sealant (3) | Sealant (4) | Sealant (5) |
| VHR | 99.1 | 99.2 | 99.5 | 99.1 | 99.4 |
| Alignment | B | A | A | B | A |
| unevenness | | | | | |
| Image- | B | B | A | B | A |
| sticking | | | | | |

TABLE 20

| | Example 62 | Example 63 | Example 64 |
|---|---|---|---|
| Liquid | Liquid Crystal | Liquid Crystal | Liquid Crystal |
| crystal | Composition 8 | Composition 8 | Composition 8 |
| composition | | | |
| Sealant | Sealant (6) | Sealant (7) | Sealant (8) |
| VHR | 99.4 | 99.5 | 99.3 |
| Alignment | A | A | A |
| unevenness | | | |
| Image- | A | A | B |
| sticking | | | |

TABLE 21

| | Example 65 | Example 66 | Example 67 | Example 68 | Example 69 |
|---|---|---|---|---|---|
| Liquid | Liquid Crystal | Liquid Crystal | Liquid Crystal | Liquid Crystal | Liquid Crystal |
| crystal | Composition 9 | Composition 9 | Composition 9 | Composition 9 | Composition 9 |
| composition | | | | | |
| Sealant | Sealant (1) | Sealant (2) | Sealant (3) | Sealant (4) | Sealant (5) |
| VHR | 99.0 | 99.1 | 99.5 | 99.0 | 99.4 |
| Alignment | B | B | A | B | A |
| unevenness | | | | | |
| Image- | B | B | A | B | B |
| sticking | | | | | |

TABLE 22

| | Example 70 | Example 71 | Example 72 |
|---|---|---|---|
| Liquid | Liquid Crystal | Liquid Crystal | Liquid Crystal |
| crystal | Composition 9 | Composition 9 | Composition 9 |
| composition | | | |
| Sealant | Sealant (6) | Sealant (7) | Sealant (8) |
| VHR | 99.3 | 99.4 | 99.3 |
| Alignment | A | A | B |
| unevenness | | | |
| Image- | B | A | A |
| sticking | | | |

Liquid Crystal Compositions 7 to 9 were found to have practical liquid crystal layer temperature limits for television applications, large absolute values of dielectric anisotropy, low viscosities, and suitable Δn.

The liquid crystal display devices of Examples 49 to 72 had high VHRs and exhibited no or only slight and acceptable alignment unevenness and image-sticking.

### Examples 73 to 96

Liquid crystal display devices of Examples 73 to 96 were fabricated using Sealants (1) to (8) as in Example 1 except that Liquid Crystal Compositions 10 to 12 shown in the following tables were sandwiched therein. The resulting liquid crystal display devices were tested for VHR and were evaluated for alignment unevenness and image-sticking. The results are shown in the following tables.

TABLE 23
Liquid Crystal Composition 10

| | |
|---|---|
| T_{NI}/° C. | 76.7 |
| Δn | 0.109 |
| Δ∈ | −3.0 |
| η/mPa · s | 22.4 |
| γ₁/mPa · s | 131 |
| γ₁/Δn² × 10⁻² | 110 |
| 3-Cy-Cy-2 | 24% |
| 3-Cy-Cy-4 | 6% |
| 3-Cy-Ph—O1 | 5% |
| 3-Cy-Ph5—O4 | 6% |
| 3-Ph—Ph5—O2 | 6% |
| 2-Cy-Ph—Ph5—O2 | 8% |
| 3-Cy-Ph—Ph5—O2 | 8% |
| 3-Cy-Cy-Ph5—O3 | 7% |
| 4-Cy-Cy-Ph5—O2 | 9% |
| 5-Cy-Cy-Ph5—O2 | 7% |
| 3-Ph—Ph5—Ph-2 | 4% |
| 4-Ph—Ph5—Ph-2 | 4% |
| 5-Ph—Ph-1 | 6% |

Liquid Crystal Composition 11

| | |
|---|---|
| T_{NI}/° C. | 80.3 |
| Δn | 0.105 |
| Δ∈ | −3.1 |
| η/mPa · s | 21.8 |
| γ₁/mPa · s | 126 |
| γ₁/Δn² × 10⁻² | 114 |
| 3-Cy-Cy-2 | 24% |
| 3-Cy-Cy-4 | 10% |
| 3-Cy-Ph—O1 | 4% |
| 3-Cy-Ph5—O4 | 6% |
| 3-Ph—Ph5—O2 | 6% |
| 2-Cy-Ph—Ph5—O2 | 8% |
| 3-Cy-Ph—Ph5—O2 | 8% |
| 3-Cy-Cy-Ph5—O3 | 7% |
| 4-Cy-Cy-Ph5—O2 | 9% |
| 5-Cy-Cy-Ph5—O2 | 7% |
| 3-Ph—Ph5—Ph-2 | 4% |
| 4-Ph—Ph5—Ph-2 | 4% |
| 5-Ph—Ph-1 | 3% |

Liquid Crystal Composition 12

| | |
|---|---|
| T_{NI}/° C. | 85.8 |
| Δn | 0.104 |
| Δ∈ | −3.2 |
| η/mPa · s | 22.0 |
| γ₁/mPa · s | 128 |
| γ₁/Δn² × 10⁻² | 119 |
| 3-Cy-Cy-2 | 24% |
| 3-Cy-Cy-4 | 10% |
| 3-Cy-Ph—O1 | 4% |
| 3-Cy-Ph5—O4 | 6% |
| 3-Ph—Ph5—O2 | 6% |
| 2-Cy-Ph—Ph5—O2 | 8% |
| 3-Cy-Ph—Ph5—O2 | 8% |
| 3-Cy-Cy-Ph5—O3 | 7% |
| 4-Cy-Cy-Ph5—O2 | 9% |
| 5-Cy-Cy-Ph5—O2 | 7% |
| 3-Ph—Ph5—Ph-2 | 4% |
| 4-Ph—Ph5—Ph-2 | 4% |
| 3-Cy-Cy-Ph-1 | 3% |

TABLE 24

| | Example 73 | Example 74 | Example 75 | Example 76 | Example 77 |
|---|---|---|---|---|---|
| Liquid | Liquid Crystal | Liquid Crystal | Liquid Crystal | Liquid Crystal | Liquid Crystal |
| crystal | Composition 10 | Composition 10 | Composition 10 | Composition 10 | Composition 10 |
| composition | | | | | |
| Sealant | Sealant (1) | Sealant (2) | Sealant (3) | Sealant (4) | Sealant (5) |
| VHR | 99.2 | 99.3 | 99.6 | 99.3 | 99.5 |
| Alignment | B | B | A | A | A |
| unevenness | | | | | |
| Image- | B | A | A | B | A |
| sticking | | | | | |

TABLE 25

| | Example 78 | Example 79 | Example 80 |
|---|---|---|---|
| Liquid | Liquid Crystal | Liquid Crystal | Liquid Crystal |
| crystal | Composition 10 | Composition 10 | Composition 10 |
| composition | | | |
| Sealant | Sealant (6) | Sealant (7) | Sealant (8) |
| VHR | 99.4 | 99.6 | 99.4 |
| Alignment | A | A | B |
| unevenness | | | |
| Image- | A | A | A |
| sticking | | | |

TABLE 26

| | Example 81 | Example 82 | Example 83 | Example 84 | Example 85 |
|---|---|---|---|---|---|
| Liquid | Liquid Crystal | Liquid Crystal | Liquid Crystal | Liquid Crystal | Liquid Crystal |
| crystal | Composition 11 | Composition 11 | Composition 11 | Composition 11 | Composition 11 |
| composition | | | | | |
| Sealant | Sealant (1) | Sealant (2) | Sealant (3) | Sealant (4) | Sealant (5) |
| VHR | 99.3 | 99.3 | 99.6 | 99.2 | 99.5 |
| Alignment | B | A | A | B | A |
| unevenness | | | | | |
| Image- | A | B | A | B | A |
| sticking | | | | | |

TABLE 27

| | Example 86 | Example 87 | Example 88 |
|---|---|---|---|
| Liquid | Liquid Crystal | Liquid Crystal | Liquid Crystal |
| crystal | Composition 11 | Composition 11 | Composition 11 |
| composition | | | |
| Sealant | Sealant (6) | Sealant (7) | Sealant (8) |
| VHR | 99.4 | 99.5 | 99.4 |
| Alignment | A | A | A |
| unevenness | | | |
| Image- | B | A | B |
| sticking | | | |

TABLE 28

| | Example 89 | Example 90 | Example 91 | Example 92 | Example 93 |
|---|---|---|---|---|---|
| Liquid | Liquid Crystal | Liquid Crystal | Liquid Crystal | Liquid Crystal | Liquid Crystal |
| crystal | Composition 12 | Composition 12 | Composition 12 | Composition 12 | Composition 12 |
| composition | | | | | |
| Sealant | Sealant (1) | Sealant (2) | Sealant (3) | Sealant (4) | Sealant (5) |
| VHR | 99.3 | 99.4 | 99.7 | 99.4 | 99.6 |
| Alignment | B | A | A | A | A |
| unevenness | | | | | |
| Image- | B | B | A | B | A |
| sticking | | | | | |

TABLE 29

| | Example 94 | Example 95 | Example 96 |
|---|---|---|---|
| Liquid | Liquid Crystal | Liquid Crystal | Liquid Crystal |
| crystal | Composition 12 | Composition 12 | Composition 12 |
| composition | | | |
| Sealant | Sealant (6) | Sealant (7) | Sealant (8) |
| VHR | 99.5 | 99.6 | 99.5 |
| Alignment | A | A | A |
| unevenness | | | |
| Image- | A | A | B |
| sticking | | | |

Liquid Crystal Compositions 10 to 12 were found to have practical liquid crystal layer temperature limits for television applications, large absolute values of dielectric anisotropy, low viscosities, and suitable Δn.

The liquid crystal display devices of Examples 73 to 96 had high VHRs and exhibited no or only slight and acceptable alignment unevenness and image-sticking.

### Examples 97 to 120

Liquid crystal display devices of Examples 97 to 120 were fabricated using Sealants (1) to (8) as in Example 1 except that Liquid Crystal Compositions 13 to 15 shown in the following tables were sandwiched therein. The resulting liquid crystal display devices were tested for VHR and were evaluated for alignment unevenness and image-sticking. The results are shown in the following tables.

TABLE 30
Liquid Crystal Composition 13

| | |
|---|---|
| T_{NI}/° C. | 71.9 |
| Δn | 0.116 |
| Δ∈ | −3.6 |
| η/mPa · s | 21.2 |
| γ₁/mPa · s | 123 |
| γ₁/Δn² × 10⁻² | 92 |
| 3-Cy-Cy-2 | 24% |
| 3-Cy-Ph—O1 | 7% |
| 2-Cy-Ph5—O2 | 6% |
| 3-Cy-Ph5—O4 | 6% |
| 3-Ph—Ph5—O2 | 5% |
| 5-Ph—Ph5—O2 | 5% |
| 2-Cy-Ph—Ph5—O2 | 7% |
| 3-Cy-Ph—Ph5—O2 | 9% |
| 3-Cy-Cy-Ph5—O3 | 5% |
| 4-Cy-Cy-Ph5—O2 | 5% |
| 5-Cy-Cy-Ph5—O2 | 4% |
| 3-Ph—Ph5—Ph-2 | 5% |
| 4-Ph—Ph5—Ph-2 | 6% |
| 3-Cy-Cy-Ph-1 | 6% |

Liquid Crystal Composition 14

| | |
|---|---|
| T_{NI}/° C. | 78.8 |
| Δn | 0.113 |
| Δ∈ | −3.5 |
| η/mPa · s | 21.1 |
| γ₁/mPa · s | 122 |
| γ₁/Δn² × 10⁻² | 95 |
| 3-Cy-Cy-2 | 23% |
| 3-Cy-Cy-4 | 5% |
| 3-Cy-Ph—O1 | 3% |
| 2-Cy-Ph5—O2 | 5% |
| 3-Cy-Ph5—O4 | 5% |
| 3-Ph—Ph5—O2 | 5% |
| 5-Ph—Ph5—O2 | 5% |
| 2-Cy-Ph—Ph5—O2 | 7% |
| 3-Cy-Ph—Ph5—O2 | 7% |
| 3-Cy-Cy-Ph5—O3 | 5% |
| 4-Cy-Cy-Ph5—O2 | 6% |
| 5-Cy-Cy-Ph5—O2 | 5% |
| 3-Ph—Ph5—Ph-2 | 5% |
| 4-Ph—Ph5—Ph-2 | 6% |
| 3-Cy-Cy-Ph-1 | 8% |

Liquid Crystal Composition 15

| | |
|---|---|
| T_{NI}/° C. | 73.8 |
| Δn | 0.113 |
| Δ∈ | −3.9 |
| η/mPa · s | 21.8 |
| γ₁/mPa · s | 123 |
| γ₁/Δn² × 10⁻² | 97 |
| 3-Cy-Cy-2 | 16% |
| 3-Cy-Cy-4 | 9% |
| 3-Cy-Ph—O1 | 6% |
| 2-Cy-Ph5—O2 | 6% |
| 3-Cy-Ph5—O4 | 6% |
| 3-Ph—Ph5—O2 | 6% |
| 5-Ph—Ph5—O2 | 6% |
| 2-Cy-Ph—Ph5—O2 | 5% |
| 3-Cy-Ph—Ph5—O2 | 7% |
| 3-Cy-Cy-Ph5—O3 | 5% |
| 4-Cy-Cy-Ph5—O2 | 6% |
| 5-Cy-Cy-Ph5—O2 | 6% |
| 3-Ph—Ph5—Ph-2 | 5% |
| 4-Ph—Ph5—Ph-2 | 5% |
| 3-Cy-Cy-Ph-1 | 6% |

TABLE 31

| | Example 97 | Example 98 | Example 99 | Example 100 | Example 101 |
|---|---|---|---|---|---|
| Liquid | Liquid Crystal | Liquid Crystal | Liquid Crystal | Liquid Crystal | Liquid Crystal |
| crystal | Composition 13 | Composition 13 | Composition 13 | Composition 13 | Composition 13 |
| composition | | | | | |
| Sealant | Sealant (1) | Sealant (2) | Sealant (3) | Sealant (4) | Sealant (5) |
| VHR | 99.1 | 99.2 | 99.6 | 99.1 | 99.4 |
| Alignment | B | B | A | A | B |
| unevenness | | | | | |
| Image- | B | A | A | B | A |
| sticking | | | | | |

TABLE 32

| | Example 102 | Example 103 | Example 104 |
|---|---|---|---|
| Liquid | Liquid Crystal | Liquid Crystal | Liquid Crystal |
| crystal | Composition 13 | Composition 13 | Composition 13 |
| composition | | | |
| Sealant | Sealant (6) | Sealant (7) | Sealant (8) |
| VHR | 99.4 | 99.6 | 99.3 |
| Alignment | B | A | A |
| unevenness | | | |
| Image- | A | A | B |
| sticking | | | |

TABLE 33

| | Example 105 | Example 106 | Example 107 | Example 108 | Example 109 |
|---|---|---|---|---|---|
| Liquid Crystal | Liquid Crystal | Liquid Crystal | Liquid Crystal | Liquid Crystal | Liquid Crystal |
| composition | Composition 14 | Composition 14 | Composition | Composition | Composition |
| | | | 14 | 14 | 14 |
| Sealant | Sealant (1) | Sealant (2) | Sealant (3) | Sealant (4) | Sealant (5) |
| VHR | 99.2 | 99.3 | 99.5 | 99.2 | 99.4 |
| Alignment | B | A | A | B | A |
| unevenness | | | | | |
| Image- | B | B | A | B | A |
| sticking | | | | | |

TABLE 34

| | Example 110 | Example 111 | Example 112 |
|---|---|---|---|
| Liquid crystal | Liquid Crystal | Liquid Crystal | Liquid Crystal |
| composition | Composition 14 | Composition 14 | Composition 14 |
| Sealant | Sealant (6) | Sealant (7) | Sealant (8) |
| VHR | 99.4 | 99.5 | 99.3 |
| Alignment | A | A | A |
| unevenness | | | |
| Image-sticking | A | A | B |

TABLE 35

| | Example 113 | Example 114 | Example 115 | Example 116 | Example 117 |
|---|---|---|---|---|---|
| Liquid crystal | Liquid Crystal | Liquid Crystal | Liquid Crystal | Liquid Crystal | Liquid Crystal |
| composition | Composition 15 | Composition 15 | Composition | Composition | Composition |
| | | | 15 | 15 | 15 |
| Sealant | Sealant (1) | Sealant (2) | Sealant (3) | Sealant (4) | Sealant (5) |
| VHR | 99.0 | 99.1 | 99.5 | 99.0 | 99.4 |
| Alignment | B | B | A | A | A |
| unevenness | | | | | |
| Image- | B | B | A | B | A |
| sticking | | | | | |

TABLE 36

| | Example 118 | Example 119 | Example 120 |
|---|---|---|---|
| Liquid crystal | Liquid Crystal | Liquid Crystal | Liquid Crystal |
| composition | Composition 15 | Composition 15 | Composition 15 |
| Sealant | Sealant (6) | Sealant (7) | Sealant (8) |
| VHR | 99.3 | 99.5 | 99.3 |
| Alignment | A | A | A |
| unevenness | | | |
| Image-sticking | A | A | B |

Liquid Crystal Compositions 13 to 15 were found to have practical liquid crystal layer temperature limits for television applications, large absolute values of dielectric anisotropy, low viscosities, and suitable Δn.

The liquid crystal display devices of Examples 97 to 120 had high VHRs and exhibited no or only slight and acceptable alignment unevenness and image-sticking.

### Examples 121 to 144

Liquid crystal display devices of Examples 121 to 144 were fabricated using Sealants (1) to (8) as in Example 1 except that Liquid Crystal Compositions 16 to 18 shown in the following tables were sandwiched therein. The resulting liquid crystal display devices were tested for VHR and were evaluated for alignment unevenness and image-sticking. The results are shown in the following tables.

TABLE 37

| Liquid Crystal | | Liquid Crystal | | Liquid Crystal | |
|---|---|---|---|---|---|
| Composition 16 | | Composition 17 | | Composition 18 | |
| T_{NI}/° C. | 75.9 | T_{NI}/° C. | 82.3 | T_{NI}/° C. | 85.7 |
| Δn | 0.112 | Δn | 0.111 | Δn | 0.112 |
| Δε | −2.8 | Δε | −2.7 | Δε | −2.8 |
| η/mPa · s | 19.8 | η/mPa · s | 19.2 | η/mPa · s | 20.1 |
| γ₁/mPa · s | 121 | γ₁/mPa · s | 114 | γ₁/mPa · s | 119 |
| γ₁/Δn² × 10⁻² | 96 | γ₁/Δn² × 10⁻² | 94 | γ₁/Δn² × 10⁻² | 95 |
| 3-Cy-Cy-2 | 19% | 3-Cy-Cy-2 | 21% | 3-Cy-Cy-2 | 19% |
| 3-Cy-Cy-4 | 12% | 3-Cy-Cy-4 | 12% | 3-Cy-Cy-4 | 12% |
| 3-Cy-Cy-5 | 5% | 3-Cy-Cy-5 | 5% | 3-Cy-Cy-5 | 4% |
| 3-Cy-Ph-O1 | 5% | 2-Cy-Ph5-O2 | 4% | 2-Cy-Ph5-O2 | 4% |
| 2-Cy-Ph5-O2 | 4% | 3-Cy-Ph5-O4 | 4% | 3-Cy-Ph5-O4 | 4% |
| 3-Cy-Ph5-O4 | 4% | 3-Ph-Ph5-O2 | 3% | 3-Ph-Ph5-O2 | 3% |
| 3-Ph-Ph5-O2 | 3% | 5-Ph-Ph5-O2 | 4% | 5-Ph-Ph5-O2 | 4% |
| 5-Ph-Ph5-O2 | 4% | 2-Cy-Ph-Ph5-O2 | 6% | 2-Cy-Ph-Ph5-O2 | 6% |
| 2-Cy-Ph-Ph5-O2 | 6% | 3-Cy-Ph-Ph5-O2 | 6% | 3-Cy-Ph-Ph5-O2 | 6% |
| 3-Cy-Ph-Ph5-O2 | 6% | 3-Cy-Cy-Ph5-O3 | 5% | 3-Cy-Cy-Ph5-O3 | 5% |
| 3-Cy-Cy-Ph5-O3 | 5% | 4-Cy-Cy-Ph5-O2 | 5% | 4-Cy-Cy-Ph5-O2 | 5% |
| 4-Cy-Cy-Ph5-O2 | 5% | 5-Cy-Cy-Ph5-O2 | 4% | 5-Cy-Cy-Ph5-O2 | 4% |
| 5-Cy-Cy-Ph5-O2 | 5% | 3-Ph-Ph5-Ph-2 | 7% | 3-Ph-Ph5-Ph-2 | 7% |
| 3-Ph-Ph5-Ph-2 | 8% | 4-Ph-Ph5-Ph-2 | 8% | 4-Ph-Ph5-Ph-2 | 8% |
| 4-Ph-Ph5-Ph-2 | 9% | 3-Cy-Cy-Ph-1 | 6% | 3-Cy-Cy-Ph-1 | 9% |

TABLE 38

| | Example 121 | Example 122 | Example 123 | Example 124 | Example 125 |
|---|---|---|---|---|---|
| Liquid crystal | Liquid Crystal | Liquid Crystal | Liquid Crystal | Liquid Crystal | Liquid Crystal |
| composition | Composition 16 | Composition 16 | Composition | Composition | Composition |
| | | | 16 | 16 | 16 |
| Sealant | Sealant (1) | Sealant (2) | Sealant (3) | Sealant (4) | Sealant (5) |
| VHR | 99.1 | 99.3 | 99.5 | 99.2 | 99.4 |
| Alignment | B | A | A | B | A |
| unevenness | | | | | |
| Image- | B | B | A | A | A |
| sticking | | | | | |

TABLE 39

| | Example 126 | Example 127 | Example 128 |
|---|---|---|---|
| Liquid crystal | Liquid Crystal | Liquid Crystal | Liquid Crystal |
| composition | Composition 16 | Composition 16 | Composition 16 |
| Sealant | Sealant (6) | Sealant (7) | Sealant (8) |
| VHR | 99.3 | 99.4 | 99.3 |
| Alignment | B | A | A |
| unevenness | | | |
| Image-sticking | A | A | B |

TABLE 40

| | Example 129 | Example 130 | Example 131 | Example 132 | Example 133 |
|---|---|---|---|---|---|
| Liquid crystal | Liquid Crystal | Liquid Crystal | Liquid Crystal | Liquid Crystal | Liquid Crystal |
| composition | Composition 17 | Composition 17 | Composition | Composition | Composition |
| | | | 17 | 17 | 17 |
| Sealant | Sealant (1) | Sealant (2) | Sealant (3) | Sealant (4) | Sealant (5) |
| VHR | 99.0 | 99.2 | 99.4 | 99.1 | 99.3 |
| Alignment | B | A | A | A | A |
| unevenness | | | | | |
| Image- | B | B | A | B | B |
| sticking | | | | | |

TABLE 41

| | Example 134 | Example 135 | Example 136 |
|---|---|---|---|
| Liquid crystal | Liquid Crystal | Liquid Crystal | Liquid Crystal |
| composition | Composition 17 | Composition 17 | Composition 17 |
| Sealant | Sealant (6) | Sealant (7) | Sealant (8) |
| VHR | 99.3 | 99.4 | 99.2 |
| Alignment | A | A | B |
| unevenness | | | |
| Image-sticking | A | A | A |

TABLE 42

| | Example 137 | Example 138 | Example 139 | Example 140 | Example 141 |
|---|---|---|---|---|---|
| Liquid crystal | Liquid Crystal | Liquid Crystal | Liquid Crystal | Liquid Crystal | Liquid Crystal |
| composition | Composition 18 | Composition 18 | Composition | Composition | Composition |
| | | | 18 | 18 | 18 |
| Sealant | Sealant (1) | Sealant (2) | Sealant (3) | Sealant (4) | Sealant (5) |
| VHR | 99.1 | 99.2 | 99.5 | 99.1 | 99.3 |
| Alignment | A | B | A | A | A |
| unevenness | | | | | |
| Image- | B | A | A | B | B |
| sticking | | | | | |

TABLE 43

| | Example 142 | Example 143 | Example 144 |
|---|---|---|---|
| Liquid crystal | Liquid Crystal | Liquid Crystal | Liquid Crystal |
| composition | Composition 18 | Composition 18 | Composition 18 |
| Sealant | Sealant (6) | Sealant (7) | Sealant (8) |
| VHR | 99.3 | 99.4 | 99.2 |
| Alignment | A | A | A |
| unevenness | | | |
| Image-sticking | A | A | B |

Liquid Crystal Compositions 16 to 18 were found to have practical liquid crystal layer temperature limits for television applications, large absolute values of dielectric anisotropy, low viscosities, and suitable Δn.

The liquid crystal display devices of Examples 121 to 144 had high VHRs and exhibited no or only slight and acceptable alignment unevenness and image-sticking.

### Examples 145 to 168

Liquid crystal display devices of Examples 145 to 168 were fabricated using Sealants (1) to (8) as in Example 1 except that Liquid Crystal Compositions 19 to 21 shown in the following tables were sandwiched therein. The resulting liquid crystal display devices were tested for VHR and were evaluated for alignment unevenness and image-sticking. The results are shown in the following tables.

TABLE 44

| Liquid Crystal | | Liquid Crystal | | Liquid Crystal | |
|---|---|---|---|---|---|
| Composition 19 | | Composition 20 | | Composition 21 | |
| T_{NI}/° C. | 77.1 | T_{NI}/° C. | 82.7 | T_{NI}/° C. | 86.4 |
| Δn | 0.104 | Δn | 0.107 | Δn | 0.106 |
| Δε | −3.5 | Δε | −3.0 | Δε | −3.0 |
| η/mPa · s | 25.1 | η/mPa · s | 24.2 | η/mPa · s | 24.4 |
| γ₁/mPa · s | 141 | γ₁/mPa · s | 141 | γ₁/mPa · s | 142 |
| γ₁/Δn² × 10⁻² | 131 | γ₁/Δn² × 10⁻² | 123 | γ₁/Δn² × 10⁻² | 126 |
| 3-Cy-Cy-2 | 22% | 3-Cy-Cy-2 | 24% | 3-Cy-Cy-2 | 24% |
| 3-Cy-Ph-O1 | 14% | 3-Cy-Cy-4 | 5% | 3-Cy-Cy-4 | 5% |
| 2-Cy-Ph5-O2 | 7% | 3-Cy-Ph-O1 | 6% | 3-Cy-Ph-O1 | 6% |
| 3-Cy-Ph5-O4 | 8% | 2-Cy-Ph5-O2 | 5% | 2-Cy-Ph5-O2 | 5% |
| 2-Cy-Ph-Ph5-O2 | 7% | 3-Cy-Ph5-O4 | 5% | 3-Cy-Ph5-O4 | 5% |
| 3-Cy-Ph-Ph5-O2 | 9% | 2-Cy-Ph-Ph5-O2 | 7% | 2-Cy-Ph-Ph5-O2 | 7% |
| 3-Cy-Cy-Ph5-O3 | 8% | 3-Cy-Ph-Ph5-O2 | 9% | 3-Cy-Ph-Ph5-O2 | 9% |
| 4-Cy-Cy-Ph5-O2 | 8% | 3-Cy-Cy-Ph5-O3 | 8% | 3-Cy-Cy-Ph5-O3 | 8% |
| 5-Cy-Cy-Ph5-O2 | 8% | 4-Cy-Cy-Ph5-O2 | 8% | 4-Cy-Cy-Ph5-O2 | 8% |
| 3-Ph-Ph5-Ph-2 | 5% | 5-Cy-Cy-Ph5-O2 | 8% | 5-Cy-Cy-Ph5-O2 | 8% |
| 4-Ph-Ph5-Ph-2 | 4% | 3-Ph-Ph5-Ph-2 | 5% | 3-Ph-Ph5-Ph-2 | 5% |
| | | 4-Ph-Ph5-Ph-2 | 5% | 4-Ph-Ph5-Ph-2 | 5% |
| | | 5-Ph-Ph-1 | 5% | 5-Ph-Ph-1 | 3% |
| | | | | 3-Cy-Cy-Ph-1 | 2% |

TABLE 45

| | Example 145 | Example 146 | Example 147 | Example 148 | Example 149 |
|---|---|---|---|---|---|
| Liquid crystal | Liquid Crystal | Liquid Crystal | Liquid Crystal | Liquid Crystal | Liquid Crystal |
| composition | Composition 19 | Composition 19 | Composition | Composition | Composition |
| | | | 19 | 19 | 19 |
| Sealant | Sealant (1) | Sealant (2) | Sealant (3) | Sealant (4) | Sealant (5) |
| VHR | 99.2 | 99.3 | 99.6 | 99.3 | 99.5 |
| Alignment | B | A | A | A | A |
| unevenness | | | | | |
| Image- | B | B | A | B | A |
| sticking | | | | | |

TABLE 46

| | Example 150 | Example 151 | Example 152 |
|---|---|---|---|
| Liquid crystal | Liquid Crystal | Liquid Crystal | Liquid Crystal |
| composition | Composition 19 | Composition 19 | Composition 19 |
| Sealant | Sealant (6) | Sealant (7) | Sealant (8) |
| VHR | 99.4 | 99.5 | 99.4 |
| Alignment | A | A | A |
| unevenness | | | |
| Image-sticking | B | A | B |

TABLE 47

| | Example 153 | Example 154 | Example 155 | Example 156 | Example 157 |
|---|---|---|---|---|---|
| Liquid crystal | Liquid Crystal | Liquid Crystal | Liquid Crystal | Liquid Crystal | Liquid Crystal |
| composition | Composition 20 | Composition 20 | Composition | Composition | Composition |
| | | | 20 | 20 | 20 |
| Sealant | Sealant (1) | Sealant (2) | Sealant (3) | Sealant (4) | Sealant (5) |
| VHR | 99.3 | 99.4 | 99.7 | 99.4 | 99.6 |
| Alignment | B | B | A | A | A |
| unevenness | | | | | |
| Image- | B | A | A | B | A |
| sticking | | | | | |

TABLE 48

| | Example 158 | Example 159 | Example 160 |
|---|---|---|---|
| Liquid crystal | Liquid Crystal | Liquid Crystal | Liquid Crystal |
| composition | Composition 20 | Composition 20 | Composition 20 |
| Sealant | Sealant (6) | Sealant (7) | Sealant (8) |
| VHR | 99.5 | 99.6 | 99.5 |
| Alignment | A | A | B |
| unevenness | | | |
| Image-sticking | A | A | A |

TABLE 49

| | Example 161 | Example 162 | Example 163 | Example 164 | Example 165 |
|---|---|---|---|---|---|
| Liquid crystal | Liquid Crystal | Liquid Crystal | Liquid Crystal | Liquid Crystal | Liquid Crystal |
| composition | Composition 21 | Composition 21 | Composition | Composition | Composition |
| | | | 21 | 21 | 21 |
| Sealant | Sealant (1) | Sealant (2) | Sealant (3) | Sealant (4) | Sealant (5) |
| VHR | 99.0 | 99.1 | 99.4 | 99.1 | 99.3 |
| Alignment | A | A | A | B | A |
| unevenness | | | | | |
| Image- | B | B | A | B | A |
| sticking | | | | | |

TABLE 50

| | Example 166 | Example 167 | Example 168 |
|---|---|---|---|
| Liquid crystal | Liquid Crystal | Liquid Crystal | Liquid Crystal |
| composition | Composition 21 | Composition 21 | Composition 21 |
| Sealant | Sealant (6) | Sealant (7) | Sealant (8) |
| VHR | 99.3 | 99.4 | 99.2 |
| Alignment | B | A | B |
| unevenness | | | |
| Image-sticking | A | A | A |

Liquid Crystal Compositions 19 to 21 were found to have practical liquid crystal layer temperature limits for television applications, large absolute values of dielectric anisotropy, low viscosities, and suitable Δn.

The liquid crystal display devices of Examples 145 to 168 had high VHRs and exhibited no or only slight and acceptable alignment unevenness and image-sticking.

### Examples 169 to 192

Liquid crystal display devices of Examples 169 to 192 were fabricated using Sealants (1) to (8) as in Example 1 except that Liquid Crystal Compositions 22 to 24 shown in the following tables were sandwiched therein. The resulting liquid crystal display devices were tested for VHR and were evaluated for alignment unevenness and image-sticking. The results are shown in the following tables.

TABLE 51

| Liquid Crystal | | Liquid Crystal | | Liquid Crystal | |
|---|---|---|---|---|---|
| Composition 22 | | Composition 23 | | Composition 24 | |
| T_{NI}/° C. | 75.5 | T_{NI}/° C. | 80.3 | T_{NI}/° C. | 85.0 |
| Δn | 0.102 | Δn | 0.101 | Δn | 0.102 |
| Δε | −2.8 | Δε | −2.9 | Δε | −3.0 |
| η/mPa · s | 22.2 | η/mPa · s | 22.0 | η/mPa · s | 22.7 |
| γ₁/mPa · s | 121 | γ₁/mPa · s | 118 | γ₁/mPa · s | 122 |
| γ₁/Δn² × 10⁻² | 117 | γ₁/Δn² × 10⁻² | 117 | γ₁/Δn² × 10⁻² | 118 |
| 3-Cy-Cy-2 | 14% | 3-Cy-Cy-2 | 17% | 3-Cy-Cy-2 | 16% |
| 3-Cy-Cy-4 | 12% | 3-Cy-Cy-4 | 12% | 3-Cy-Cy-4 | 12% |
| 3-Cy-Cy-5 | 5% | 3-Cy-Cy-5 | 5% | 3-Cy-Cy-5 | 5% |
| 3-Cy-Ph-O1 | 7% | 3-Cy-Ph-O1 | 6% | 3-Cy-Ph-O1 | 5% |
| 2-Cy-Ph5-O2 | 7% | 2-Cy-Ph5-O2 | 12% | 2-Cy-Ph5-O2 | 12% |
| 3-Cy-Ph5-O4 | 7% | 2-Cy-Ph-Ph5-O2 | 9% | 2-Cy-Ph-Ph5-O2 | 9% |
| 2-Cy-Ph-Ph5-O2 | 8% | 3-Cy-Ph-Ph5-O2 | 9% | 3-Cy-Ph-Ph5-O2 | 9% |
| 3-Cy-Ph-Ph5-O2 | 8% | 3-Cy-Cy-Ph5-O3 | 6% | 3-Cy-Cy-Ph5-O3 | 6% |
| 3-Cy-Cy-Ph5-O3 | 6% | 4-Cy-Cy-Ph5-O2 | 8% | 4-Cy-Cy-Ph5-O2 | 8% |
| 4-Cy-Cy-Ph5-O2 | 7% | 5-Cy-Cy-Ph5-O2 | 6% | 5-Cy-Cy-Ph5-O2 | 6% |
| 5-Cy-Cy-Ph5-O2 | 6% | 3-Ph-Ph5-Ph-2 | 3% | 3-Ph-Ph5-Ph-2 | 3% |
| 3-Ph-Ph5-Ph-2 | 3% | 4-Ph-Ph5-Ph-2 | 3% | 4-Ph-Ph5-Ph-2 | 3% |
| 4-Ph-Ph5-Ph-2 | 3% | 5-Ph-Ph-1 | 4% | 5-Ph-Ph-1 | 3% |
| 5-Ph-Ph-1 | 6% | | | 3-Cy-Cy-Ph-1 | 3% |
| 3-Cy-Cy-Ph-1 | 1% | | | | |

TABLE 52

| | Example 169 | Example 170 | Example 171 | Example 172 | Example 173 |
|---|---|---|---|---|---|
| Liquid crystal | Liquid Crystal | Liquid Crystal | Liquid Crystal | Liquid Crystal | Liquid Crystal |
| composition | Composition 22 | Composition 22 | Composition | Composition | Composition |
| | | | 22 | 22 | 22 |
| Sealant | Sealant (1) | Sealant (2) | Sealant (3) | Sealant (4) | Sealant 5) |
| VHR | 99.0 | 99.2 | 99.5 | 99.2 | 99.4 |
| Alignment | B | A | A | A | A |
| unevenness | | | | | |
| Image- | B | B | A | B | B |
| sticking | | | | | |

TABLE 53

| | Example 174 | Example 175 | Example 176 |
|---|---|---|---|
| Liquid crystal | Liquid Crystal | Liquid Crystal | Liquid Crystal |
| composition | Composition 22 | Composition 22 | Composition 22 |
| Sealant | Sealant (6) | Sealant (7) | Sealant (8) |
| VHR | 99.3 | 99.5 | 99.3 |
| Alignment | A | A | A |
| unevenness | | | |
| Image-sticking | B | A | A |

TABLE 54

| | Example 177 | Example 178 | Example 179 | Example 180 | Example 181 |
|---|---|---|---|---|---|
| Liquid crystal | Liquid Crystal | Liquid Crystal | Liquid Crystal | Liquid Crystal | Liquid Crystal |
| composition | Composition 23 | Composition 23 | Composition | Composition | Composition |
| | | | 23 | 23 | 23 |
| Sealant | Sealant (1) | Sealant (2) | Sealant (3) | Sealant (4) | Sealant (5) |
| VHR | 99.1 | 99.2 | 99.5 | 99.1 | 99.4 |
| Alignment | A | B | A | B | A |
| unevenness | | | | | |
| Image- | B | A | A | B | A |
| sticking | | | | | |

TABLE 55

| | Example 182 | Example 183 | Example 184 |
|---|---|---|---|
| Liquid crystal | Liquid Crystal | Liquid Crystal | Liquid Crystal |
| composition | Composition 23 | Composition 23 | Composition 23 |
| Sealant | Sealant (6) | Sealant (7) | Sealant (8) |
| VHR | 99.3 | 99.5 | 99.3 |
| Alignment | A | A | A |
| unevenness | | | |
| Image-sticking | B | A | B |

TABLE 56

| | Example 185 | Example 186 | Example 187 | Example 188 | Example 189 |
|---|---|---|---|---|---|
| Liquid crystal | Liquid Crystal | Liquid Crystal | Liquid Crystal | Liquid Crystal | Liquid Crystal |
| composition | Composition 24 | Composition 24 | Composition | Composition | Composition |
| | | | 24 | 24 | 24 |
| Sealant | Sealant (1) | Sealant (2) | Sealant (3) | Sealant (4) | Sealant (5) |
| VHR | 99.3 | 99.4 | 99.7 | 99.3 | 99.6 |
| Alignment | B | B | A | B | A |
| unevenness | | | | | |
| Image- | B | A | A | A | A |
| sticking | | | | | |

TABLE 57

| | Example 190 | Example 191 | Example 192 |
|---|---|---|---|
| Liquid crystal | Liquid Crystal | Liquid Crystal | Liquid Crystal |
| composition | Composition 24 | Composition 24 | Composition 24 |
| Sealant | Sealant (6) | Sealant (7) | Sealant (8) |
| VHR | 99.5 | 99.7 | 99.5 |
| Alignment | A | A | B |
| unevenness | | | |
| Image-sticking | A | A | A |

Liquid Crystal Compositions 22 to 24 were found to have practical liquid crystal layer temperature limits for television applications, large absolute values of dielectric anisotropy, low viscosities, and suitable Δn.

The liquid crystal display devices of Examples 169 to 192 had high VHRs and exhibited no or only slight and acceptable alignment unevenness and image-sticking.

### Examples 193 to 216

Liquid crystal display devices of Examples 193 to 216 were fabricated using Sealants (1) to (8) as in Example 1 except that Liquid Crystal Compositions 25 to 27 shown in the following tables were sandwiched therein. The resulting liquid crystal display devices were tested for VHR and were evaluated for alignment unevenness and image-sticking. The results are shown in the following tables.

TABLE 58

| Liquid Crystal | | Liquid Crystal | | Liquid Crystal | |
|---|---|---|---|---|---|
| Composition 25 | | Composition 26 | | Composition 27 | |
| T_{NI}/°C. | 75.6 | T_{NI}/°C. | 81.1 | T_{NI}/°C. | 85.7 |
| Δn | 0.104 | Δn | 0.105 | Δn | 0.105 |
| Δε | −2.8 | Δε | −2.8 | Δε | −2.9 |
| η/mPa · s | 20.2 | η/mPa · s | 20.8 | η/mPa · s | 21.0 |
| γ₁/mPa · s | 117 | γ₁/mPa · s | 119 | γ₁/mPa · s | 92 |
| γ₁/Δn² × 10⁻² | 107 | γ₁/Δn² × 10⁻² | 107 | γ₁/Δn² × 10⁻² | 82 |
| 3-Cy-Cy-2 | 25% | 3-Cy-Cy-2 | 25% | 3-Cy-Cy-2 | 25% |
| 3-Cy-Cy-4 | 10% | 3-Cy-Cy-4 | 10% | 3-Cy-Cy-4 | 12% |
| 3-Cy-Ph-O1 | 4% | 3-Cy-Ph-O1 | 4% | 2-Cy-Ph5-O2 | 12% |
| 2-Cy-Ph5-O2 | 7% | 2-Cy-Ph5-O2 | 12% | 2-Cy-Ph-Ph5-O2 | 5% |
| 3-Cy-Ph5-O4 | 8% | 2-Cy-Ph-P5-O2 | 5% | 3-Cy-Ph-Ph5-O2 | 6% |
| 2-Cy-Ph-Ph5-O2 | 5% | 3-Cy-Ph-Ph5-O2 | 6% | 3-Cy-Cy-Ph5-O3 | 7% |
| 3-Cy-Ph-Ph5-O2 | 6% | 3-Cy-Cy-Ph5-O3 | 7% | 4-Cy-Cy-Ph5-O2 | 8% |
| 3-Cy-Cy-Ph5-O3 | 6% | 4-Cy-Cy-Ph5-O2 | 8% | 5-Cy-Cy-Ph5-O2 | 7% |
| 4-Cy-Cy-Ph5-O2 | 7% | 5-Cy-Cy-Ph5-O2 | 7% | 3-Ph-Ph5-Ph-2 | 8% |
| 5-Cy-Cy-Ph5-O2 | 6% | 3-Ph-Ph5-Ph-2 | 8% | 4-Ph-Ph5-Ph-2 | 8% |
| 3-Ph-Ph5-Ph-2 | 8% | 4-Ph-Ph5-Ph-2 | 8% | 3-Cy-Cy-Ph-1 | 2% |
| 4-Ph-Ph5-Ph-2 | 8% | | | | |

TABLE 59

| | Example 193 | Example 194 | Example 195 | Example 196 | Example 197 |
|---|---|---|---|---|---|
| Liquid crystal | Liquid Crystal | Liquid Crystal | Liquid Crystal | Liquid Crystal | Liquid Crystal |
| composition | Composition 25 | Composition 25 | Composition | Composition | Composition |
| | | | 25 | 25 | 25 |
| Sealant | Sealant (1) | Sealant (2) | Sealant (3) | Sealant (4) | Sealant (5) |
| VHR | 99.4 | 99.5 | 99.8 | 99.5 | 99.6 |
| Alignment | A | A | A | B | A |
| unevenness | | | | | |
| Image- | B | B | A | B | B |
| sticking | | | | | |

TABLE 60

| | Example 198 | Example 199 | Example 200 |
|---|---|---|---|
| Liquid crystal | Liquid Crystal | Liquid Crystal | Liquid Crystal |
| composition | Composition 25 | Composition 25 | Composition 25 |
| Sealant | Sealant (6) | Sealant (7) | Sealant (8) |
| VHR | 99.6 | 99.7 | 99.5 |
| Alignment | A | A | B |
| unevenness | | | |
| Image-sticking | B | A | A |

TABLE 61

| | Example 201 | Example 202 | Example 203 | Example 204 | Example 205 |
|---|---|---|---|---|---|
| Liquid crystal | Liquid Crystal | Liquid Crystal | Liquid Crystal | Liquid Crystal | Liquid Crystal |
| composition | Composition 26 | Composition 26 | Composition | Composition | Composition |
| | | | 26 | 26 | 26 |
| Sealant | Sealant (1) | Sealant (2) | Sealant (3) | Sealant (4) | Sealant (5) |
| VHR | 99.2 | 99.4 | 99.6 | 99.3 | 99.5 |
| Alignment | B | B | A | A | A |
| unevenness | | | | | |
| Image- | B | A | A | B | A |
| sticking | | | | | |

TABLE 62

| | Example 206 | Example 207 | Example 208 |
|---|---|---|---|
| Liquid crystal | Liquid Crystal | Liquid Crystal | Liquid Crystal |
| composition | Composition 26 | Composition 26 | Composition 26 |
| Sealant | Sealant (6) | Sealant (7) | Sealant (8) |
| VHR | 99.5 | 99.6 | 99.4 |
| Alignment | A | A | B |
| unevenness | | | |
| Image-sticking | A | A | A |

TABLE 63

| | Example 209 | Example 210 | Example 211 | Example 212 | Example 213 |
|---|---|---|---|---|---|
| Liquid | Liquid Crystal | Liquid Crystal | Liquid Crystal | Liquid Crystal | Liquid Crystal |
| crystal | Composition 27 | Composition 27 | Composition 27 | Composition 27 | Composition 27 |
| composition | | | | | |
| Sealant | Sealant (1) | Sealant (2) | Sealant (3) | Sealant (4) | Sealant (5) |
| VHR | 99.1 | 99.2 | 99.5 | 99.1 | 99.4 |
| Alignment | A | A | A | B | A |
| unevenness | | | | | |
| Image- | B | B | A | B | A |
| sticking | | | | | |

TABLE 64

| | Example 214 | Example 215 | Example 216 |
|---|---|---|---|
| Liquid | Liquid Crystal | Liquid Crystal | Liquid Crystal |
| crystal | Composition 27 | Composition 27 | Composition 27 |
| composition | | | |
| Sealant | Sealant (6) | Sealant (7) | Sealant (8) |
| VHR | 99.3 | 99.4 | 99.3 |
| Alignment | B | A | A |
| unevenness | | | |
| Image- | A | A | A |
| sticking | | | |

Liquid Crystal Compositions 25 to 27 were found to have practical liquid crystal layer temperature limits for television applications, large absolute values of dielectric anisotropy, low viscosities, and suitable Δn.

The liquid crystal display devices of Examples 193 to 216 had high VHRs and exhibited no or only slight and acceptable alignment unevenness and image-sticking.

### Examples 217 to 224

Liquid Crystal Composition 1 was mixed with 0.3% by mass of 4-{2-[4-(2-acryloyloxyethyl)phenoxycarbonyl]ethyl}biphenyl-4′-yl 2-methylacrylate to obtain Liquid Crystal Composition 28. Liquid Crystal Composition 28 was sandwiched and sealed using one of Sealants (1) to (8) as in Example 1. The liquid crystal composition was polymerized by exposure to UV radiation for 600 seconds (3.0 J/cm²) with a drive voltage being applied across the electrodes. In this way, PSVA liquid crystal display devices of Examples 217 to 224 were fabricated. The resulting liquid crystal display devices were tested for VHR and were evaluated for alignment unevenness and image-sticking. The results are shown in the following tables.

TABLE 65

| | Example 217 | Example 218 | Example 219 | Example 220 | Example 221 |
|---|---|---|---|---|---|
| Liquid | Liquid Crystal | Liquid Crystal | Liquid Crystal | Liquid Crystal | Liquid Crystal |
| crystal | Composition 28 | Composition 28 | Composition 28 | Composition 28 | Composition 28 |
| composition | | | | | |
| Sealant | Sealant (1) | Sealant (2) | Sealant (3) | Sealant (4) | Sealant (5) |
| VHR | 99.0 | 99.2 | 99.4 | 99.1 | 99.4 |
| Alignment | B | A | A | A | B |
| unevenness | | | | | |
| Image- | B | B | A | B | A |
| sticking | | | | | |

TABLE 66

| | Example 222 | Example 223 | Example 224 |
|---|---|---|---|
| Liquid | Liquid Crystal | Liquid Crystal | Liquid Crystal |
| crystal | Composition 28 | Composition 28 | Composition 28 |
| composition | | | |
| Sealant | Sealant (6) | Sealant (7) | Sealant (8) |
| VHR | 99.3 | 99.4 | 99.2 |
| Alignment | A | A | B |
| unevenness | | | |
| Image- | A | A | B |
| sticking | | | |

The liquid crystal display devices of Examples 217 to 224 had high VHRs and exhibited no or only slight and acceptable alignment unevenness and image-sticking.

### Examples 225 to 232

Liquid Crystal Composition 13 was mixed with 0.3% by mass of biphenyl-4,4′-diyl bismethacrylate to obtain Liquid Crystal Composition 29. Liquid Crystal Composition 29 was sandwiched and sealed using one of Sealants (1) to (8) as in Example 1. The liquid crystal composition was polymerized by exposure to UV radiation for 600 seconds (3.0 J/cm²) with a drive voltage being applied across the electrodes. In this way, PSVA liquid crystal display devices of Examples 225 to 232 were fabricated. The resulting liquid crystal display devices were tested for VHR and were evaluated for alignment unevenness and image-sticking. The results are shown in the following tables.

TABLE 67

| | Example 225 | Example 226 | Example 227 | Example 228 | Example 229 |
|---|---|---|---|---|---|
| Liquid | Liquid Crystal | Liquid Crystal | Liquid Crystal | Liquid Crystal | Liquid Crystal |
| crystal | Composition 29 | Composition 29 | Composition 29 | Composition 29 | Composition 29 |
| composition | | | | | |
| Sealant | Sealant (1) | Sealant (2) | Sealant (3) | Sealant (4) | Sealant (5) |
| VHR | 99.1 | 99.2 | 99.5 | 99.2 | 99.5 |
| Alignment | A | A | A | A | A |
| unevenness | | | | | |
| Image- | B | B | A | B | A |
| sticking | | | | | |

TABLE 68

| | Example 230 | Example 231 | Example 232 |
|---|---|---|---|
| Liquid | Liquid Crystal | Liquid Crystal | Liquid Crystal |
| crystal | Composition 29 | Composition 29 | Composition 29 |
| composition | | | |
| Sealant | Sealant (6) | Sealant (7) | Sealant (8) |
| VHR | 99.4 | 99.5 | 99.3 |
| Alignment | B | A | B |
| unevenness | | | |
| Image- | A | A | A |
| sticking | | | |

The liquid crystal display devices of Examples 225 to 232 had high VHRs and exhibited no or only slight and acceptable alignment unevenness and image-sticking.

### Examples 233 to 240

Liquid Crystal Composition 19 was mixed with 0.3% by mass of 3-fluorobiphenyl-4,4′-diyl bismethacrylate to obtain Liquid Crystal Composition 30. Liquid Crystal Composition 30 was sandwiched and sealed using one of Sealants (1) to (8) as in Example 1. The liquid crystal composition was polymerized by exposure to UV radiation for 600 seconds (3.0 J/cm²) with a drive voltage being applied across the electrodes. In this way, PSVA liquid crystal display devices of Examples 233 to 240 were fabricated. The resulting liquid crystal display devices were tested for VHR and were evaluated for alignment unevenness and image-sticking. The results are shown in the following tables.

TABLE 69

| | Example 233 | Example 234 | Example 235 | Example 236 | Example 237 |
|---|---|---|---|---|---|
| Liquid | Liquid Crystal | Liquid Crystal | Liquid Crystal | Liquid Crystal | Liquid Crystal |
| crystal | Composition 30 | Composition 30 | Composition 30 | Composition 30 | Composition 30 |
| composition | | | | | |
| Sealant | Sealant (1) | Sealant (2) | Sealant (3) | Sealant (4) | Sealant (5) |
| VHR | 99.2 | 99.3 | 99.6 | 99.3 | 99.5 |
| Alignment | B | A | A | A | A |
| unevenness | | | | | |
| Image- | B | B | A | B | A |
| sticking | | | | | |

TABLE 70

| | Example 238 | Example 239 | Example 240 |
|---|---|---|---|
| Liquid | Liquid Crystal | Liquid Crystal | Liquid Crystal |
| crystal | Composition 30 | Composition 30 | Composition 30 |
| composition | | | |
| Sealant | Sealant (6) | Sealant (7) | Sealant (8) |
| VHR | 99.4 | 99.6 | 99.4 |
| Alignment | A | A | A |
| unevenness | | | |
| Image- | A | A | B |
| sticking | | | |

The liquid crystal display devices of Examples 233 to 240 had high VHRs and exhibited no or only slight and acceptable alignment unevenness and image-sticking.

### Examples 241 to 264

Liquid crystal display devices of Examples 241 to 264 were fabricated using Sealants (1) to (8) as in Example 1 except that Liquid Crystal Compositions 31 to 33 shown in the following tables were sandwiched therein. The resulting liquid crystal display devices were tested for VHR and were evaluated for alignment unevenness and image-sticking. The results are shown in the following tables.

TABLE 71
Liquid Crystal Composition 31

| | |
|---|---|
| TNI/° C. | 75.5 |
| Δn | 0.103 |
| Δ∈ | −3.1 |
| η/mPa · s | 15.8 |
| γ1/mPa · s | 113 |
| γ1/Δn2 × 10−2 | 113 |
| 3-Cy-Cy-2 | 13% |
| 3-Cy-Cy-V1 | 12% |
| 3-Cy-Cy-4 | 5% |
| 3-Ph—Ph-1 | 3% |
| 5-Ph—Ph-1 | 12% |
| 3-Cy-Cy-Ph-1 | 3% |
| V-Cy-Ph—Ph-3 | 6% |
| 3-Cy-1O—Ph5—O2 | 11% |
| 2-Cy-Cy-1O—Ph5—O2 | 12% |
| 3-Cy-Cy-1O—Ph5—O2 | 12% |
| 4-Cy-Cy-1O—Ph5—O2 | 2% |
| V-Cy-Cy-1O—Ph5—O2 | 3% |
| 1V-Cy-Cy-1O—Ph5—O2 | 6% |

Liquid Crystal Composition 32

| | |
|---|---|
| TNI/° C. | 75.4 |
| Δn | 0.109 |
| Δ∈ | −3.1 |
| η/mPa · s | 14.9 |
| γ1/mPa · s | 110 |
| γ1/Δn2 × 10−2 | 92 |
| 2-Cy-Cy-V1 | 20% |
| 3-Cy-Cy-V1 | 13% |
| 3-Ph—Ph-1 | 10% |
| 5-Ph—Ph-1 | 5% |
| 3-Cy-Ph—Ph-2 | 6% |
| 1V-Cy-1O—Ph5—O2 | 8% |
| 2-Cy-Cy-1O—Ph5—O2 | 10% |
| 3-Cy-Cy-1O—Ph5—O2 | 10% |
| V-Cy-Cy-1O—Ph5—O2 | 10% |
| 1V-Cy-Cy-1O—Ph5—O2 | 4% |
| 3-Ph—Ph5—Ph-2 | 4% |

Liquid Crystal Composition 33

| | |
|---|---|
| TNI/° C. | 83.1 |
| Δn | 0.114 |
| Δ∈ | −2.9 |
| η/mPa · s | 14.8 |
| γ1/mPa · s | 92 |
| γ1/Δn2 × 10−2 | 71 |
| V2—Ph—Ph-1 | 5% |
| 3-Cy-Cy-V | 39% |
| 3-Cy-1O—Ph5—O2 | 5% |
| 2-Cy-Cy-1O—Ph5—O2 | 11% |
| 3-Cy-Cy-1O—Ph5—O1 | 11% |
| 3-Cy-Cy-1O—Ph5—O2 | 6% |
| 2-Cy-Ph—Ph5—O2 | 6% |
| 3-Ph—Ph5—Ph-1 | 8% |
| 3-Ph—Ph5—Ph-2 | 9% |

TABLE 72

| | Example 241 | Example 242 | Example 243 | Example 244 | Example 245 |
|---|---|---|---|---|---|
| Liquid | Liquid Crystal | Liquid Crystal | Liquid Crystal | Liquid Crystal | Liquid Crystal |
| crystal | Composition 31 | Composition 31 | Composition 31 | Composition 31 | Composition 31 |
| composition | | | | | |
| Sealant | Sealant (1) | Sealant (2) | Sealant (3) | Sealant (4) | Sealant (5) |
| VHR | 99.1 | 99.2 | 99.6 | 99.1 | 99.5 |
| Alignment | A | A | A | B | A |
| unevenness | | | | | |
| Image- | B | B | A | B | A |
| sticking | | | | | |

TABLE 73

| | Example 246 | Example 247 | Example 248 |
|---|---|---|---|
| Liquid | Liquid Crystal | Liquid Crystal | Liquid Crystal |
| crystal | Composition 31 | Composition 31 | Composition 31 |
| composition | | | |
| Sealant | Sealant (6) | Sealant (7) | Sealant (8) |
| VHR | 99.4 | 99.6 | 99.3 |
| Alignment | A | A | A |
| unevenness | | | |
| Image- | A | A | B |
| sticking | | | |

TABLE 74

| | Example 249 | Example 250 | Example 251 | Example 252 | Example 253 |
|---|---|---|---|---|---|
| Liquid | Liquid Crystal | Liquid Crystal | Liquid Crystal | Liquid Crystal | Liquid Crystal |
| crystal | Composition 32 | Composition 32 | Composition 32 | Composition 32 | Composition 32 |
| composition | | | | | |
| Sealant | Sealant (1) | Sealant (2) | Sealant (3) | Sealant (4) | Sealant (5) |
| VHR | 99.2 | 99.2 | 99.5 | 99.2 | 99.4 |
| Alignment | A | B | A | A | A |
| unevenness | | | | | |
| Image- | B | B | A | B | B |
| sticking | | | | | |

TABLE 75

| | Example 254 | Example 255 | Example 256 |
|---|---|---|---|
| Liquid | Liquid Crystal | Liquid Crystal | Liquid Crystal |
| crystal | Composition 32 | Composition 32 | Composition 32 |
| composition | | | |
| Sealant | Sealant (6) | Sealant (7) | Sealant (8) |
| VHR | 99.3 | 99.5 | 99.3 |
| Alignment | A | A | B |
| unevenness | | | |
| Image- | B | A | A |
| sticking | | | |

TABLE 76

| | Example 257 | Example 258 | Example 259 | Example 260 | Example 261 |
|---|---|---|---|---|---|
| Liquid | Liquid Crystal | Liquid Crystal | Liquid Crystal | Liquid Crystal | Liquid Crystal |
| crystal | Composition 33 | Composition 33 | Composition 33 | Composition 33 | Composition 33 |
| composition | | | | | |
| Sealant | Sealant (1) | Sealant (2) | Sealant (3) | Sealant (4) | Sealant (5) |
| VHR | 98.9 | 99.1 | 99.4 | 99.0 | 99.3 |
| Alignment | B | B | A | B | A |
| unevenness | | | | | |
| Image- | B | B | A | A | B |
| sticking | | | | | |

TABLE 77

| | Example 262 | Example 263 | Example 264 |
|---|---|---|---|
| Liquid | Liquid Crystal | Liquid Crystal | Liquid Crystal |
| crystal | Composition 33 | Composition 33 | Composition 33 |
| composition | | | |
| Sealant | Sealant (6) | Sealant (7) | Sealant (8) |
| VHR | 99.2 | 99.3 | 99.2 |
| Alignment | A | A | A |
| unevenness | | | |
| Image- | B | B | B |
| sticking | | | |

The liquid crystal display devices of Examples 241 to 264 had high VHRs and exhibited no or only slight and acceptable alignment unevenness and image-sticking.

### Examples 265 to 280

Liquid crystal display devices of Examples 265 to 280 were fabricated as in Example 1 except that the liquid crystal composition and polymerizable liquid crystal composition shown in the following tables were used. The resulting liquid crystal display devices were tested for VHR and ID and were evaluated for image-sticking. The results are shown in the following tables.

TABLE 78

| Liquid Crystal Composition 34 | | Liquid Crystal Composition 35 | |
|---|---|---|---|
| TNI/° C. | 76.3 | TNI/° C. | 76.6 |
| Δn | 0.106 | Δn | 0.109 |
| Δε | −3.0 | Δε | −3.2 |
| η/mPa · s | 16.6 | η/mPa · s | 13.9 |
| γ1/mPa · s | 106 | γ1/mPa · s | 95 |
| γ1/Δn2 × 10−2 | 95 | γ1/Δn2 × 10−2 | 80 |
| 3-Cy-Cy-2 | 17% | 1V-Cy-1O-Ph5-O2 | 12% |
| 3-Cy-Ph-Ph-2 | 12% | 1V-Cy-Cy-1O-Ph5-O2 | 12% |
| 3-Cy-1O-Ph5-O1 | 11% | 3-Cy-1O-Ph5-O2 | 2% |
| 3-Cy-1O-Ph5-O2 | 17% | 2-Cy-Cy-1O-Ph5-O2 | 5% |
| 3-Nd-Ph5-Ph-2 | 4% | 3-Cy-Cy-1O-Ph5-O2 | 4% |
| 3-Cy-Cy-V | 5% | 3-Cy-Ph-Ph5-O2 | 4% |
| 3-Cy-Cy-V1 | 10% | 3-Cy-Cy-V | 38% |
| V-Cy-Ph-Ph-3 | 12% | 3-Cy-Cy-V1 | 3% |
| V-Cy-Cy-1O-Ph5-O3 | 12% | 3-Ph-Ph-1 | 3% |
| | | V2-Ph-Ph5-Ph-2V | 12% |
| | | 1V2-Ph-Ph5-Ph2-V1 | 5% |

TABLE 79

| | Example 265 | Example 266 | Example 267 | Example 268 | Example 269 |
|---|---|---|---|---|---|
| Liquid crystal | Liquid Crystal | Liquid Crystal | Liquid Crystal | Liquid Crystal | Liquid Crystal |
| composition | Composition 34 | Composition 34 | Composition | Composition | Composition |
| | | | 34 | 34 | 34 |
| Sealant | Sealant (1) | Sealant (2) | Sealant (3) | Sealant (4) | Sealant (5) |
| VHR | 99.1 | 99.2 | 99.5 | 99.2 | 99.4 |
| Alignment | B | A | A | B | A |
| unevenness | | | | | |
| Image- | B | B | A | B | A |
| sticking | | | | | |

TABLE 80

| | Example 270 | Example 271 | Example 272 |
|---|---|---|---|
| Liquid crystal | Liquid Crystal | Liquid Crystal | Liquid Crystal |
| composition | Composition 34 | Composition 34 | Composition 34 |
| Sealant | Sealant (6) | Sealant (7) | Sealant (8) |
| VHR | 99.3 | 99.5 | 99.3 |
| Alignment | B | A | B |
| unevenness | | | |
| Image-sticking | A | A | A |

TABLE 81

| | Example 273 | Example 274 | Example 275 | Example 276 | Example 277 |
|---|---|---|---|---|---|
| Liquid crystal | Liquid Crystal | Liquid Crystal | Liquid Crystal | Liquid Crystal | Liquid Crystal |
| composition | Composition 35 | Composition 35 | Composition | Composition | Composition |
| | | | 35 | 35 | 35 |
| Sealant | Sealant (1) | Sealant (2) | Sealant (3) | Sealant (4) | Sealant (5) |
| VHR | 99.0 | 99.1 | 99.4 | 99.1 | 99.4 |
| Alignment | B | A | A | B | A |
| unevenness | | | | | |
| Image- | B | B | A | B | A |
| sticking | | | | | |

TABLE 82

| | Example 278 | Example 279 | Example 280 |
|---|---|---|---|
| Liquid crystal | Liquid Crystal | Liquid Crystal | Liquid Crystal |
| composition | Composition 35 | Composition 35 | Composition 35 |
| Sealant | Sealant (6) | Sealant (7) | Sealant (8) |
| VHR | 99.3 | 99.4 | 99.2 |
| Alignment | A | A | A |
| unevenness | | | |
| Image-sticking | B | A | B |

The liquid crystal display devices of Examples 265 to 280 had high VHRs and exhibited no or only slight and acceptable alignment unevenness and image-sticking.

### Comparative Examples 1 to 15

VA liquid crystal display devices of Comparative Examples 1 to 15 were fabricated as in Example 1 except that Liquid Crystal Composition 1 was replaced with Comparative Liquid Crystal Compositions 1 to 3 shown in the following tables. The resulting liquid crystal display devices were tested for VHR and were evaluated for alignment unevenness and image-sticking. The results are shown in the following tables.

TABLE 83

| Comparative | | Comparative | | Comparative | |
|---|---|---|---|---|---|
| Liquid Crystal | | Liquid Crystal | | Liquid Crystal | |
| Composition 1 | | Composition 2 | | Composition 3 | |
| 3-Cy-Cy-2 | 4% | 3-Cy-Cy-2 | 4% | 3-Cy-Cy-2 | 4% |
| 3-Cy-Cy-4 | 4% | 3-Cy-Cy-4 | 4% | 3-Cy-Cy-4 | 4% |
| 3-Cy-Ph5-O2 | 7% | 3-Cy-Ph5-O2 | 7% | 3-Cy-Ph5- | 7% |
| | | | | O2 | |
| 3-Cy-Ph5-O4 | 8% | 3-Cy-Ph5-O4 | 8% | 3-Cy-Ph5- | 8% |
| | | | | O4 | |
| 2-Cy-Ph-Ph5-O2 | 4% | 2-Cy-Ph-Ph5-O2 | 5% | 2-Cy-Ph- | 6% |
| | | | | Ph5-O2 | |
| 3-Cy-Ph-Ph5-O2 | 5% | 3-Cy-Ph-Ph5-O2 | 6% | 3-Cy-Ph- | 7% |
| | | | | Ph5-O2 | |
| 3-Cy-Cy-Ph5-O3 | 8% | 3-Cy-Cy-Ph5-O3 | 7% | 3-Cy-Cy- | 7% |
| | | | | Ph5-O3 | |
| 4-Cy-Cy-Ph5-O2 | 10% | 4-Cy-Cy-Ph5-O2 | 9% | 4-Cy-Cy- | 7% |
| | | | | Ph5-O2 | |
| 5-Cy-Cy-Ph5-O2 | 8% | 5-Cy-Cy-Ph5-O2 | 7% | 5-Cy-Cy- | 7% |
| | | | | Ph5-O2 | |
| 3-Ph-Ph5-Ph-2 | 4% | 3-Ph-Ph5-Ph-2 | 4% | 3-Ph-Ph5- | 4% |
| | | | | Ph-2 | |
| 4-Ph-Ph5-Ph-2 | 4% | 4-Ph-Ph5-Ph-2 | 4% | 4-Ph-Ph5- | 4% |
| | | | | Ph-2 | |
| 5-Ph-Ph-1 | 25% | 5-Ph-Ph-1 | 22% | 5-Ph-Ph-1 | 19% |
| 3-Cy-Cy-Ph-1 | 9% | 3-Cy-Cy-Ph-1 | 13% | 3-Cy-Cy- | 16% |
| | | | | Ph-1 | |

TABLE 84

| | Comparative | Comparative | Comparative | Comparative | Comparative |
|---|---|---|---|---|---|
| | Example 1 | Example 2 | Example 3 | Example 4 | Example 5 |
| Liquid crystal | Comparative | Comparative | Comparative | Comparative | Comparative |
| composition | Liquid Crystal | Liquid Crystal | Liquid Crystal | Liquid Crystal | Liquid Crystal |
| | Composition 1 | Composition 1 | Composition 1 | Composition 1 | Composition 1 |
| Sealant | Sealant (1) | Sealant (2) | Sealant (3) | Sealant (4) | Sealant (5) |
| VHR | 97.3 | 97.5 | 98.0 | 97.4 | 97.8 |
| Alignment | D | D | C | D | C |
| unevenness | | | | | |
| Image- | D | D | C | D | D |
| sticking | | | | | |

TABLE 85

| | Comparative | Comparative | Comparative |
|---|---|---|---|
| | Example 6 | Example 7 | Example 8 |
| Liquid crystal | Comparative | Comparative | Comparative |
| composition | Liquid Crystal | Liquid Crystal | Liquid Crystal |
| | Composition 1 | Composition 1 | Composition 1 |
| Sealant | Sealant (6) | Sealant (7) | Sealant (8) |
| VHR | 97.7 | 97.8 | 97.5 |
| Alignment | C | C | C |
| unevenness | | | |
| Image-sticking | D | C | D |

TABLE 86

| | Comparative | Comparative | Comparative | Comparative | Comparative |
|---|---|---|---|---|---|
| | Example 9 | Example 10 | Example 11 | Example 12 | Example 13 |
| Liquid crystal | Comparative | Comparative | Comparative | Comparative | Comparative |
| composition | Liquid Crystal | Liquid Crystal | Liquid Crystal | Liquid Crystal | Liquid Crystal |
| | Composition 2 | Composition 2 | Composition 2 | Composition 2 | Composition 2 |
| Sealant | Sealant (1) | Sealant (2) | Sealant (3) | Sealant (4) | Sealant (5) |
| VHR | 97.4 | 97.5 | 98.1 | 97.5 | 97.9 |
| Alignment | D | D | C | D | D |
| unevenness | | | | | |
| Image- | D | D | C | D | C |
| sticking | | | | | |

TABLE 87

| | Comparative | Comparative | Comparative |
|---|---|---|---|
| | Example 14 | Example 15 | Example 16 |
| Liquid crystal | Comparative | Comparative | Comparative |
| composition | Liquid Crystal | Liquid Crystal | Liquid Crystal |
| | Composition 2 | Composition 2 | Composition 2 |
| Sealant | Sealant (6) | Sealant (7) | Sealant (8) |
| VHR | 97.7 | 98.0 | 97.6 |
| Alignment | D | C | D |
| unevenness | | | |
| Image-sticking | D | D | D |

TABLE 88

| | Comparative | Comparative | Comparative | Comparative | Comparative |
|---|---|---|---|---|---|
| | Example 17 | Example 18 | Example 19 | Example 20 | Example 21 |
| Liquid crystal | Comparative | Comparative | Comparative | Comparative | Comparative |
| composition | Liquid Crystal | Liquid Crystal | Liquid Crystal | Liquid Crystal | Liquid Crystal |
| | Composition 3 | Composition 3 | Composition 3 | Composition 3 | Composition 3 |
| Sealant | Sealant (1) | Sealant (2) | Sealant (3) | Sealant (4) | Sealant (5) |
| VHR | 97.2 | 97.5 | 98.1 | 97.3 | 97.9 |
| Alignment | D | C | C | D | C |
| unevenness | | | | | |
| Image- | D | D | C | D | D |
| sticking | | | | | |

TABLE 89

| | Comparative | Comparative | Comparative |
|---|---|---|---|
| | Example 22 | Example 23 | Example 24 |
| Liquid crystal | Comparative | Comparative | Comparative |
| composition | Liquid Crystal | Liquid Crystal | Liquid Crystal |
| | Composition 3 | Composition 3 | Composition 3 |
| Sealant | Sealant (6) | Sealant (7) | Sealant (8) |
| VHR | 97.8 | 98.0 | 97.6 |
| Alignment | C | C | D |
| unevenness | | | |
| Image-sticking | D | C | D |

The liquid crystal display devices of Comparative Examples 1 to 24 had lower VHRs than those according to the present invention and exhibited unacceptable alignment unevenness and image-sticking.

### Comparative Examples 25 to 48

VA liquid crystal display devices of Comparative Examples 25 to 48 were fabricated as in Comparative Example 1 except that Comparative Liquid Crystal Composition 1 was replaced with Comparative Liquid Crystal Compositions 4 to 6 shown in the following tables. The resulting liquid crystal display devices were tested for VHR and were evaluated for alignment unevenness and image-sticking. The results are shown in the following tables.

TABLE 90

| Comparative Liquid Crystal | | Comparative Liquid Crystal | | Comparative Liquid Crystal | |
|---|---|---|---|---|---|
| Composition 4 | | Composition 5 | | Composition 6 | |
| T_{NI}/° C. | 73.6 | T_{NI}/° C. | 80.9 | T_{NI}/° C. | 84.7 |
| Δn | 0.099 | Δn | 0.094 | Δn | 0.085 |
| Δε | −2.15 | Δε | −2.16 | Δε | −2.13 |
| η/mPa · s | 17.7 | η/mPa · s | 17.0 | η/mPa · s | 17.5 |
| γ₁/mPa · s | 104 | γ₁/mPa · s | 97 | γ₁/mPa · s | 98 |
| γ₁/Δn² × 10⁻² | 106 | γ₁/Δn² × 10⁻² | 109 | γ₁/Δn² × 10⁻² | 136 |
| 3-Cy-Cy-2 | 20% | 3-Cy-Cy-2 | 24% | 3-Cy-Cy-2 | 21% |
| 3-Cy-Cy-4 | 12% | 3-Cy-Cy-4 | 12% | 3-Cy-Cy-4 | 15% |
| 3-Cy-Cy-5 | 7% | 3-Cy-Cy-5 | 15% | 3-Cy-Cy-5 | 15% |
| 3-Cy-Ph-O1 | 12% | 3-Cy-Ph5-O2 | 5% | 3-Cy-Ph5-O2 | 5% |
| 3-Cy-Ph5-O2 | 5% | 3-Cy-Ph5-O4 | 5% | 3-Cy-Ph5-O4 | 5% |
| 3-Cy-Ph5-O4 | 5% | 2-Cy-Ph-Ph5-O2 | 11% | 2-Cy-Ph-Ph5-O2 | 4% |
| 2-Cy-Ph-Ph5-O2 | 11% | 3-Cy-Ph-Ph5-O2 | 11% | 3-Cy-Ph-Ph5-O2 | 5% |
| 3-Cy-Ph-Ph5-O2 | 11% | 3-Cy-Cy-Ph5-O3 | 3% | 3-Cy-Cy-Ph5-O3 | 7% |
| 3-Cy-Cy-Ph5-O3 | 3% | 4-Cy-Cy-Ph5-O2 | 3% | 4-Cy-Cy-Ph5-O2 | 8% |
| 4-Cy-Cy-Ph5-O2 | 3% | 5-Cy-Cy-Ph5-O2 | 3% | 5-Cy-Cy-Ph5-O2 | 7% |
| 5-Cy-Cy-Ph5-O2 | 3% | 3-Ph-Ph5-Ph-2 | 4% | 3-Ph-Ph5-Ph-2 | 4% |
| 3-Ph-Ph5-Ph-2 | 4% | 4-Ph-Ph5-Ph-2 | 4% | 4-Ph-Ph5-Ph-2 | 4% |
| 4-Ph-Ph5-Ph-2 | 4% | | | | |

TABLE 91

| | Comparative | Comparative | Comparative | Comparative | Comparative |
|---|---|---|---|---|---|
| | Example 25 | Example 26 | Example 27 | Example 28 | Example 29 |
| Liquid crystal | Comparative | Comparative | Comparative | Comparative | Comparative |
| composition | Liquid Crystal | Liquid Crystal | Liquid Crystal | Liquid Crystal | Liquid Crystal |
| | Composition 4 | Composition 4 | Composition 4 | Composition 4 | Composition 4 |
| Sealant | Sealant (1) | Sealant (2) | Sealant (3) | Sealant (4) | Sealant (5) |
| VHR | 97.1 | 97.2 | 98.0 | 97.1 | 97.7 |
| Alignment | D | D | C | D | C |
| unevenness | | | | | |
| Image- | D | D | C | C | D |
| sticking | | | | | |

TABLE 92

| | Comparative | Comparative | Comparative |
|---|---|---|---|
| | Example 30 | Example 31 | Example 32 |
| Liquid crystal | Comparative | Comparative | Comparative |
| composition | Liquid Crystal | Liquid Crystal | Liquid Crystal |
| | Composition 4 | Composition 4 | Composition 4 |
| Sealant | Sealant (6) | Sealant (7) | Sealant (8) |
| VHR | 97.6 | 97.8 | 97.4 |
| Alignment | C | C | D |
| unevenness | | | |
| Image-sticking | D | D | C |

TABLE 93

| | Comparative | Comparative | Comparative | Comparative | Comparative |
|---|---|---|---|---|---|
| | Example 33 | Example 34 | Example 35 | Example 36 | Example 37 |
| Liquid crystal | Comparative | Comparative | Comparative | Comparative | Comparative |
| composition | Liquid Crystal | Liquid Crystal | Liquid Crystal | Liquid Crystal | Liquid Crystal |
| | Composition 5 | Composition 5 | Composition 5 | Composition 5 | Composition 5 |
| Sealant | Sealant (1) | Sealant (2) | Sealant (3) | Sealant (4) | Sealant (5) |
| VHR | 97.2 | 97.3 | 98.1 | 97.3 | 97.8 |
| Alignment | D | C | C | D | C |
| unevenness | | | | | |
| Image- | D | D | C | D | D |
| sticking | | | | | |

TABLE 94

| | Comparative | Comparative | Comparative |
|---|---|---|---|
| | Example 38 | Example 30 | Example 40 |
| Liquid crystal | Comparative | Comparative | Comparative |
| composition | Liquid Crystal | Liquid Crystal | Liquid Crystal |
| | Composition 5 | Composition 5 | Composition 5 |
| Sealant | Sealant (6) | Sealant (7) | Sealant (8) |
| VHR | 97.7 | 98.0 | 97.5 |
| Alignment | C | C | C |
| unevenness | | | |
| Image-sticking | D | C | D |

TABLE 95

| | Comparative | Comparative | Comparative | Comparative | Comparative |
|---|---|---|---|---|---|
| | Example 41 | Example 42 | Example 43 | Example 44 | Example 45 |
| Liquid crystal | Comparative | Comparative | Comparative | Comparative | Comparative |
| composition | Liquid Crystal | Liquid Crystal | Liquid Crystal | Liquid Crystal | Liquid Crystal |
| | Composition 6 | Composition 6 | Composition 6 | Composition 6 | Composition 6 |
| Sealant | Sealant (1) | Sealant (2) | Sealant (3) | Sealant (4) | Sealant (5) |
| VHR | 97.1 | 97.2 | 97.9 | 97.1 | 97.6 |
| Alignment | D | D | C | D | C |
| unevenness | | | | | |
| Image- | D | D | C | D | C |
| sticking | | | | | |

TABLE 96

| | Comparative | Comparative | Comparative |
|---|---|---|---|
| | Example 46 | Example 47 | Example 48 |
| Liquid crystal | Comparative | Comparative | Comparative |
| composition | Liquid Crystal | Liquid Crystal | Liquid Crystal |
| | Composition 6 | Composition 6 | Composition 6 |
| Sealant | Sealant (6) | Sealant (7) | Sealant (8) |
| VHR | 97.5 | 97.8 | 97.3 |
| Alignment | C | C | C |
| unevenness | | | |
| Image-sticking | D | C | D |

The liquid crystal display devices of Comparative Examples 25 to 48 had lower VHRs than those according to the present invention and exhibited unacceptable alignment unevenness and image-sticking.

### Comparative Examples 49 to 72

VA liquid crystal display devices of Comparative Examples 49 to 72 were fabricated as in Comparative Example 1 except that Comparative Liquid Crystal Composition 1 was replaced with Comparative Liquid Crystal Compositions 7 to 9 shown in the following tables. The resulting liquid crystal display devices were tested for VHR and were evaluated for alignment unevenness and image-sticking. The results are shown in the following tables.

TABLE 97

| Comparative | | Comparative | | Comparative | |
|---|---|---|---|---|---|
| Liquid Crystal | | Liquid Crystal | | Liquid Crystal | |
| Composition 7 | | Composition 8 | | Composition 9 | |
| 3-Cy-Cy-2 | 28% | 3-Cy-Cy-2 | 25% | 3-Cy-Cy-2 | 28% |
| 3-Cy-Cy-4 | 10% | 3-Cy-Cy-4 | 9% | 3-Cy-Cy-4 | 8% |
| 3-Cy-Ph-O1 | 7% | 3-Cy-Ph-O1 | 6% | 3-Cy-Ph-O1 | 7% |
| 2-Cy-Ph5-O2 | 2% | 2-Cy-Ph5-O2 | 2% | 2-Cy-Ph5- | 2% |
| | | | | O2 | |
| 3-Cy-Ph5-O4 | 2% | 3-Cy-Ph5-O4 | 2% | 3-Cy-Ph5- | 2% |
| | | | | O4 | |
| 2-Cy-Ph-Ph5-O2 | 5% | 2-Cy-Ph-Ph5-O2 | 5% | 2-Cy-Ph- | 5% |
| | | | | Ph5-O2 | |
| 3-Cy-Ph-Ph5-O2 | 5% | 3-Cy-Ph-Ph5-O2 | 5% | 3-Cy-Ph- | 5% |
| | | | | Ph5-O2 | |
| 3-Cy-Cy-Ph5-O3 | 5% | 3-Cy-Cy-Ph5-O3 | 5% | 3-Cy-Cy- | 5% |
| | | | | Ph5-O3 | |
| 4-Cy-Cy-Ph5-O2 | 5% | 4-Cy-Cy-Ph5-O2 | 5% | 4-Cy-Cy- | 5% |
| | | | | Ph5-O2 | |
| 5-Cy-Cy-Ph5-O2 | 5% | 5-Cy-Cy-Ph5-O2 | 5% | 5-Cy-Cy- | 5% |
| | | | | Ph5-O2 | |
| 3-Ph-Ph5-Ph-2 | 2% | 3-Ph-Ph5-Ph-2 | 2% | 3-Ph-Ph5- | 2% |
| | | | | Ph-2 | |
| 4-Ph-Ph5-Ph-2 | 2% | 4-Ph-Ph5-Ph-2 | 2% | 4-Ph-Ph5- | 2% |
| | | | | Ph-2 | |
| 5-Ph-Ph-1 | 22% | 5-Ph-Ph-1 | 19% | 5-Ph-Ph-1 | 15% |
| | | 3-Cy-Cy-Ph-1 | 8% | 3-Cy-Cy- | 9% |
| | | | | Ph-1 | |

TABLE 98

| | Comparative | Comparative | Comparative | Comparative | Comparative |
|---|---|---|---|---|---|
| | Example 49 | Example 50 | Example 51 | Example 52 | Example 53 |
| Liquid crystal | Comparative | Comparative | Comparative | Comparative | Comparative |
| composition | Liquid Crystal | Liquid Crystal | Liquid Crystal | Liquid Crystal | Liquid Crystal |
| | Composition 7 | Composition 7 | Composition 7 | Composition 7 | Composition 7 |
| Sealant | Sealant (1) | Sealant (2) | Sealant (3) | Sealant (4) | Sealant (5) |
| VHR | 97.0 | 97.1 | 97.7 | 97.0 | 97.5 |
| Alignment | D | D | C | C | C |
| unevenness | | | | | |
| Image- | D | D | C | D | C |
| sticking | | | | | |

TABLE 99

| | Comparative | Comparative | Comparative |
|---|---|---|---|
| | Example 54 | Example 55 | Example 56 |
| Liquid crystal | Comparative | Comparative | Comparative |
| composition | Liquid Crystal | Liquid Crystal | Liquid Crystal |
| | Composition 7 | Composition 7 | Composition 7 |
| Sealant | Sealant (6) | Sealant (7) | Sealant (8) |
| VHR | 97.4 | 97.8 | 97.2 |
| Alignment | D | C | C |
| unevenness | | | |
| Image-sticking | D | C | D |

TABLE 100

| | Comparative | Comparative | Comparative | Comparative | Comparative |
|---|---|---|---|---|---|
| | Example 57 | Example 58 | Example 59 | Example 60 | Example 61 |
| Liquid crystal | Comparative | Comparative | Comparative | Comparative | Comparative |
| composition | Liquid Crystal | Liquid Crystal | Liquid Crystal | Liquid Crystal | Liquid Crystal |
| | Composition 8 | Composition 8 | Composition 8 | Composition 8 | Composition 8 |
| Sealant | Sealant (1) | Sealant (2) | Sealant (3) | Sealant (4) | Sealant (5) |
| VHR | 97.2 | 97.4 | 98.0 | 97.3 | 97.7 |
| Alignment | D | D | C | D | C |
| unevenness | | | | | |
| Image- | D | D | C | D | D |
| sticking | | | | | |

TABLE 101

| | Comparative | Comparative | Comparative |
|---|---|---|---|
| | Example 62 | Example 63 | Example 64 |
| Liquid crystal | Comparative | Comparative | Comparative |
| composition | Liquid Crystal | Liquid Crystal | Liquid Crystal |
| | Composition 8 | Composition 8 | Composition 8 |
| Sealant | Sealant (6) | Sealant (7) | Sealant (8) |
| VHR | 97.7 | 97.9 | 97.5 |
| Alignment | D | C | D |
| unevenness | | | |
| Image-sticking | C | D | C |

TABLE 102

| | Comparative | Comparative | Comparative | Comparative | Comparative |
|---|---|---|---|---|---|
| | Example 65 | Example 66 | Example 67 | Example 68 | Example 69 |
| Liquid crystal | Comparative | Comparative | Comparative | Comparative | Comparative |
| composition | Liquid Crystal | Liquid Crystal | Liquid Crystal | Liquid Crystal | Liquid Crystal |
| | Composition 9 | Composition 9 | Composition 9 | Composition 9 | Composition 9 |
| Sealant | Sealant (1) | Sealant (2) | Sealant (3) | Sealant (4) | Sealant (5) |
| VHR | 97.3 | 97.4 | 98.1 | 97.4 | 97.8 |
| Alignment | D | D | C | D | C |
| unevenness | | | | | |
| Image- | D | D | C | D | C |
| sticking | | | | | |

TABLE 103

| | Comparative | Comparative | Comparative |
|---|---|---|---|
| | Example 70 | Example 71 | Example 72 |
| Liquid crystal | Cornparative | Comparative | Comparative |
| composition | Liquid Crystal | Liquid Crystal | Liquid Crystal |
| | Composition 9 | Composition 9 | Composition 9 |
| Sealant | Sealant (6) | Sealant (7) | Sealant (8) |
| VHR | 97.6 | 97.9 | 97.5 |
| Alignment | C | C | C |
| unevenness | | | |
| Image-sticking | D | D | D |

The liquid crystal display devices of Comparative Examples 49 to 72 had lower VHRs than those according to the present invention and exhibited unacceptable alignment unevenness and image-sticking.

### Comparative Examples 73 to 88

VA liquid crystal display devices of Comparative Examples 73 to 88 were fabricated as in Comparative Example 1 except that Comparative Liquid Crystal Composition 1 was replaced with Comparative Liquid Crystal Compositions 10 and 11 shown in the following tables. The resulting liquid crystal display devices were tested for VHR and were evaluated for alignment unevenness and image-sticking. The results are shown in the following tables.

TABLE 104

| | |
|---|---|
| Comparative Liquid Crystal | Comparative Liquid Crystal |
| Composition 10 | Composition 11 |

| | | | |
|---|---|---|---|
| 3-Cy-Cy-2 | 10% | 3-Cy-Cy-4 | 11% |
| 3-Cy-Cy-4 | 3% | 3-Cy-Cy-5 | 5% |
| 3-Cy-Cy-5 | 2% | 2-Cy-Ph5-O2 | 16% |
| 3-Cy-Ph-O1 | 2% | 3-Cy-Ph5-O4 | 16% |
| 2-Cy-Ph5-O2 | 16% | 2-Cy-Ph-Ph5-O2 | 12% |
| 3-Cy-Ph5-O4 | 16% | 3-Cy-Ph-Ph5-O2 | 12% |
| 2-Cy-Ph-Ph5-O2 | 12% | 3-Cy-Cy-Ph5-O3 | 9% |
| 3-Cy-Ph-Ph5-O2 | 11% | 4-Cy-Cy-Ph5-O2 | 9% |
| 3-Cy-Cy-Ph5-O3 | 9% | 5-Cy-Cy-Ph5-O2 | 8% |
| 4-Cy-Cy-Ph5-O2 | 9% | 3-Cy-Cy-Ph-1 | 2% |
| 5-Cy-Cy-Ph5-O2 | 9% | | |
| 3-Cy-Cy-Ph-1 | 1% | | |

TABLE 105

| | Comparative | Comparative | Comparative | Comparative | Comparative |
|---|---|---|---|---|---|
| | Example 73 | Example 74 | Example 75 | Example 76 | Example 77 |
| Liquid crystal | Comparative | Comparative | Comparative | Comparative | Comparative |
| composition | Liquid Crystal | Liquid Crystal | Liquid Crystal | Liquid Crystal | Liquid Crystal |
| | Composition 10 | Composition 10 | Composition | Composition | Composition |
| | | | 10 | 10 | 10 |
| Sealant | Sealant (1) | Sealant (2) | Sealant (3) | Sealant (4) | Sealant (5) |
| VHR | 97.2 | 97.3 | 98.0 | 97.3 | 97.8 |
| Alignment | C | D | C | D | C |
| unevenness | | | | | |
| Image- | D | D | C | D | C |
| sticking | | | | | |

TABLE 106

| | Comparative | Comparative | Comparative |
|---|---|---|---|
| | Example 78 | Example 79 | Example 80 |
| Liquid crystal | Comparative | Comparative | Comparative |
| composition | Liquid Crystal | Liquid Crystal | Liquid Crystal |
| | Composition 10 | Composition 10 | Composition 10 |
| Sealant | Sealant (6) | Sealant (7) | Sealant (8) |
| VHR | 97.6 | 97.7 | 97.5 |
| Alignment | D | C | D |
| unevenness | | | |
| Image-sticking | C | C | C |

TABLE 107

| | Comparative | Comparative | Comparative | Comparative | Comparative |
|---|---|---|---|---|---|
| | Example 81 | Example 82 | Example 83 | Example 84 | Example 85 |
| Liquid crystal | Comparative | Comparative | Comparative | Comparative | Comparative |
| composition | Liquid Crystal | Liquid Crystal | Liquid Crystal | Liquid Crystal | Liquid Crystal |
| | Composition 11 | Composition 11 | Composition | Composition | Composition |
| | | | 11 | 11 | 11 |
| Sealant | Sealant (1) | Sealant (2) | Sealant (3) | Sealant (4) | Sealant (5) |
| VHR | 97.0 | 97.2 | 97.9 | 97.1 | 97.6 |
| Alignment | D | D | C | D | C |
| unevenness | | | | | |
| Image- | D | D | C | C | C |
| sticking | | | | | |

TABLE 108

| | Comparative | Comparative | Comparative |
|---|---|---|---|
| | Example 86 | Example 87 | Example 88 |
| Liquid crystal | Comparative | Comparative | Comparative |
| composition | Liquid Crystal | Liquid Crystal | Liquid Crystal |
| | Composition 11 | Composition 11 | Composition 11 |
| Sealant | Sealant (6) | Sealant (7) | Sealant (8) |
| VHR | 97.5 | 97.7 | 97.4 |
| Alignment | C | C | C |
| unevenness | | | |
| Image-sticking | D | D | D |

The liquid crystal display devices of Comparative Examples 73 to 88 had lower VHRs than those according to the present invention and exhibited unacceptable alignment unevenness and image-sticking.

### Comparative Examples 89 to 112

VA liquid crystal display devices of Comparative Examples 89 to 112 were fabricated as in Comparative Example 1 except that Comparative Liquid Crystal Composition 1 was replaced with Comparative Liquid Crystal Compositions 12 to 14 shown in the following tables. The resulting liquid crystal display devices were tested for VHR and were evaluated for alignment unevenness and image-sticking. The results are shown in the following tables.

TABLE 109

| Comparative | | Comparative | | Comparative | |
|---|---|---|---|---|---|
| Liquid Crystal | | Liquid Crystal | | Liquid Crystal | |
| Composition 12 | | Composition 13 | | Composition 14 | |
| 3-Cy-Cy-2 | 25% | 3-Cy-Cy-2 | 27% | 3-Cy-Cy-2 | 30% |
| 3-Cy-Cy-4 | 12% | 3-Cy-Cy-4 | 12% | 3-Cy-Cy-4 | 12% |
| 3-Cy-Cy-5 | 7% | 3-Cy-Cy-5 | 6% | 3-Cy-Cy-5 | 9% |
| 3-Cy-Ph-O1 | 11% | 3-Cy-Ph-O1 | 9% | 2-Cy-Ph5-O2 | 4% |
| 2-Cy-Ph5-O2 | 5% | 2-Cy-Ph5-O2 | 5% | 3-Cy-Ph5-O4 | 4% |
| 3-Cy-Ph5-O4 | 5% | 3-Cy-Ph5-O4 | 5% | 2-Cy-Ph-Ph5-O2 | 5% |
| 2-Cy-Ph- | 4% | 2-Cy-Ph- | 4% | 3-Cy-Ph-Ph5-O2 | 5% |
| Ph5-O2 | | Ph5-O2 | | | |
| 3-Cy-Ph- | 4% | 3-Cy-Ph- | 3% | 3-Cy-Cy-Ph5-O3 | 3% |
| Ph5-O2 | | Ph5-O2 | | | |
| 3-Cy-Cy- | 2% | 3-Cy-Cy- | 3% | 4-Cy-Cy-Ph5-O2 | 3% |
| Ph5-O3 | | Ph5-O3 | | | |
| 4-Cy-Cy- | 2% | 4-Cy-Cy- | 2% | 5-Cy-Cy-Ph5-O2 | 3% |
| Ph5-O2 | | Ph5-O2 | | | |
| 5-Cy-Cy- | 2% | 5-Cy-Cy- | 2% | 3-Ph-Ph5-Ph-2 | 3% |
| Ph5-O2 | | Ph5-O2 | | | |
| 3-Ph-Ph5-Ph-2 | 5% | 3-Ph-Ph5-Ph-2 | 6% | 4-Ph-Ph5-Ph-2 | 3% |
| 4-Ph-Ph5-Ph-2 | 5% | 4-Ph-Ph5-Ph-2 | 4% | 3-Cy-Cy-Ph-1 | 16% |
| 3-Cy-Cy-Ph-1 | 11% | 3-Cy-Cy-Ph-1 | 12% | | |

TABLE 110

| | Comparative | Comparative | Comparative | Comparative | Comparative |
|---|---|---|---|---|---|
| | Example 89 | Example 90 | Example 91 | Example 92 | Example 93 |
| Liquid crystal | Comparative | Comparative | Comparative | Comparative | Comparative |
| composition | Liquid Crystal | Liquid Crystal | Liquid Crystal | Liquid Crystal | Liquid Crystal |
| | Composition 12 | Composition 12 | Composition | Composition | Composition |
| | | | 12 | 12 | 12 |
| Sealant | Sealant (1) | Sealant (2) | Sealant (3) | Sealant (4) | Sealant (5) |
| VHR | 96.9 | 97.1 | 97.8 | 97.0 | 97.5 |
| Alignment | D | C | C | D | D |
| unevenness | | | | | |
| Image- | D | D | C | D | C |
| sticking | | | | | |

TABLE 111

| | Comparative | Comparative | Comparative |
|---|---|---|---|
| | Example 94 | Example 95 | Example 96 |
| Liquid crystal | Comparative | Comparative | Comparative |
| composition | Liquid Crystal | Liquid Crystal | Liquid Crystal |
| | Composition 12 | Composition 12 | Composition 12 |
| Sealant | Sealant (6) | Sealant (7) | Sealant (8) |
| VHR | 97.3 | 97.6 | 97.3 |
| Alignment | C | C | D |
| unevenness | | | |
| Image-sticking | C | C | C |

TABLE 112

| | Comparative | Comparative | Comparative | Comparative | Comparative |
|---|---|---|---|---|---|
| | Example 97 | Example 98 | Example 99 | Example 100 | Example 101 |
| Liquid crystal | Comparative | Comparative | Comparative | Comparative | Comparative |
| composition | Liquid Crystal | Liquid Crystal | Liquid Crystal | Liquid Crystal | Liquid Crystal |
| | Composition 13 | Composition 13 | Composition | Composition | Composition |
| | | | 13 | 13 | 13 |
| Sealant | Sealant (1) | Sealant (2) | Sealant (3) | Sealant (4) | Sealant (5) |
| VHR | 97.2 | 97.3 | 97.9 | 97.2 | 97.7 |
| Alignment | D | D | D | C | D |
| unevenness | | | | | |
| Image- | D | D | C | D | C |
| sticking | | | | | |

TABLE 113

| | Comparative | Comparative | Comparative |
|---|---|---|---|
| | Example 102 | Example 103 | Example 104 |
| Liquid crystal | Comparative | Comparative | Comparative |
| composition | Liquid Crystal | Liquid Crystal | Liquid Crystal |
| | Composition 13 | Composition 13 | Composition 13 |
| Sealant | Sealant (6) | Sealant (7) | Sealant (8) |
| VHR | 97.6 | 97.9 | 97.4 |
| Alignment | C | C | C |
| unevenness | | | |
| Image-sticking | C | C | C |

TABLE 114

| | Comparative | Comparative | Comparative | Comparative | Comparative |
|---|---|---|---|---|---|
| | Example 105 | Example 106 | Example 107 | Example 108 | Example 109 |
| Liquid crystal | Comparative | Comparative | Comparative | Comparative | Comparative |
| composition | Liquid Crystal | Liquid Crystal | Liquid Crystal | Liquid Crystal | Liquid Crystal |
| | Composition 14 | Composition 14 | Composition | Composition | Composition |
| | | | 14 | 14 | 14 |
| Sealant | Sealant (1) | Sealant (2) | Sealant (3) | Sealant (4) | Sealant (5) |
| VHR | 97.0 | 97.2 | 98.0 | 97.1 | 97.7 |
| Alignment | D | C | C | D | C |
| unevenness | | | | | |
| Image- | D | D | C | D | D |
| sticking | | | | | |

TABLE 115

| | Comparative | Comparative | Comparative |
|---|---|---|---|
| | Example 110 | Example 111 | Example 112 |
| Liquid crystal | Comparative | Comparative | Comparative |
| composition | Liquid Crystal | Liquid Crystal | Liquid Crystal |
| | Composition 14 | Composition 14 | Composition 14 |
| Sealant | Sealant (6) | Sealant (7) | Sealant (8) |
| VHR | 97.7 | 97.9 | 97.4 |
| Alignment | C | C | D |
| unevenness | | | |
| Image-sticking | D | C | D |

The liquid crystal display devices of Comparative Examples 89 to 112 had lower VHRs than those according to the present invention and exhibited unacceptable alignment unevenness and image-sticking.

### Comparative Examples 113 to 120

VA liquid crystal display devices of Comparative Examples 113 to 120 were fabricated as in Comparative Example 1 except that Comparative Liquid Crystal Composition 1 was replaced with Comparative Liquid Crystal Composition 15 shown in the following table. The resulting liquid crystal display devices were tested for VHR and were evaluated for alignment unevenness and image-sticking. The results are shown in the following tables.

TABLE 116
Comparative Liquid Crystal
Composition 15

| | |
|---|---|
| 3-Cy-Cy-2 | 14% |
| 3-Cy-Ph-O1 | 4% |
| 2-Cy-Ph5-O2 | 3% |
| 2-Cy-Ph-Ph5-O2 | 13% |
| 3-Cy-Ph-Ph5-O2 | 13% |
| 3-Cy-Cy-Ph5-O3 | 12% |
| 4-Cy-Cy-Ph5-O2 | 12% |
| 5-Cy-Cy-Ph5-O2 | 12% |
| 3-Ph-Ph5-Ph-2 | 8% |
| 4-Ph-Ph5-Ph-2 | 8% |
| 5-Ph-Ph-1 | 1% |

TABLE 117

| | Comparative | Comparative | Comparative | Comparative | Comparative |
|---|---|---|---|---|---|
| | Example 113 | Example 114 | Example 115 | Example 116 | Example 117 |
| Liquid crystal | Comparative | Comparative | Comparative | Comparative | Comparative |
| composition | Liquid Crystal | Liquid Crystal | Liquid Crystal | Liquid Crystal | Liquid Crystal |
| | Composition 15 | Composition 15 | Composition | Composition | Composition |
| | | | 15 | 15 | 15 |
| Sealant | Sealant (1) | Sealant (2) | Sealant (3) | Sealant (4) | Sealant (5) |
| VHR | 97.3 | 97.4 | 97.9 | 97.3 | 97.7 |
| Alignment | D | C | C | D | C |
| unevenness | | | | | |
| Image- | D | D | D | D | C |
| sticking | | | | | |

TABLE 118

| | Comparative | Comparative | Comparative |
|---|---|---|---|
| | Example 118 | Example 119 | Example 120 |
| Liquid crystal | Comparative | Comparative | Comparative |
| composition | Liquid Crystal | Liquid Crystal | Liquid Crystal |
| | Composition 15 | Composition 15 | Composition 15 |
| Sealant | Sealant (6) | Sealant (7) | Sealant (8) |
| VHR | 97.5 | 97.7 | 97.6 |
| Alignment | D | C | D |
| unevenness | | | |
| Image-sticking | C | C | D |

The liquid crystal display devices of Comparative Examples 113 to 120 had lower VHRs than those according to the present invention and exhibited unacceptable alignment unevenness and image-sticking.

### Comparative Examples 121 to 136

Liquid crystal display devices of Comparative Examples 121 to 136 were fabricated as in Examples 1, 6, 36, 61, 66, 91, 96, and 126 except that the sealant was replaced with Comparative Sealants (C1) and (C2). The resulting liquid crystal display devices were tested for VHR and were evaluated for alignment unevenness and image-sticking. The results are shown in the following tables.

TABLE 119

| | Comparative | Comparative | Comparative | Comparative |
|---|---|---|---|---|
| | Example 121 | Example 122 | Example 123 | Example 124 |
| Liquid crystal | Liquid Crystal | Liquid Crystal | Liquid Crystal | Liquid Crystal |
| composition | Composition 1 | Composition 2 | Composition 8 | Composition 13 |
| Sealant | Comparative | Comparative | Comparative | Comparative |
| | Sealant (C1) | Sealant (C1) | Sealant (C1) | Sealant (C1) |
| VHR | 98.0 | 97.9 | 97.5 | 97.5 |
| Alignment | C | C | D | D |
| unevenness | | | | |
| Image-sticking | D | D | D | D |

TABLE 120

| | Comparative | Comparative | Comparative | Comparative |
|---|---|---|---|---|
| | Example 125 | Example 126 | Example 127 | Example 128 |
| Liquid crystal | Liquid Crystal | Liquid Crystal | Liquid Crystal | Liquid Crystal |
| composition | Composition 14 | Composition 19 | Composition 20 | Composition 26 |
| Sealant | Comparative | Comparative | Comparative | Comparative |
| | Sealant (C1) | Sealant (C1) | Sealant (C1) | Sealant (C1) |
| VHR | 97.6 | 97.7 | 97.6 | 97.4 |
| Alignment | D | D | D | D |
| unevenness | | | | |
| Image-sticking | D | D | D | D |

TABLE 121

| | Comparative | Comparative | Comparative | Comparative |
|---|---|---|---|---|
| | Example 129 | Example 130 | Example 131 | Example 132 |
| Liquid crystal | Liquid Crystal | Liquid Crystal | Liquid Crystal | Liquid Crystal |
| composition | Composition 1 | Composition 2 | Composition 8 | Composition 13 |
| Sealant | Comparative | Comparative | Comparative | Comparative |
| | Sealant (C2) | Sealant (C2) | Sealant (C2) | Sealant (C2) |
| VHR | 97.5 | 97.6 | 97.2 | 97.3 |
| Alignment | D | C | D | D |
| unevenness | | | | |
| Image-sticking | D | D | D | D |

TABLE 122

| | Comparative | Comparative | Comparative | Comparative |
|---|---|---|---|---|
| | Example 133 | Example 134 | Example 135 | Example 136 |
| Liquid crystal | Liquid Crystal | Liquid Crystal | Liquid Crystal | Liquid Crystal |
| composition | Composition 14 | Composition 19 | Composition 20 | Composition 26 |
| Sealant | Comparative | Comparative | Comparative | Comparative |
| | Sealant (C2) | Sealant (C2) | Sealant (C2) | Sealant (C2) |
| VHR | 97.4 | 97.4 | 97.4 | 97.2 |
| Alignment | D | D | D | D |
| unevenness | | | | |
| Image-sticking | D | D | D | D |

The liquid crystal display devices of Comparative Examples 121 to 136 had lower VHRs than those according to the present invention and exhibited unacceptable alignment unevenness and image-sticking.

1. A liquid crystal display device comprising a first substrate, a second substrate, a liquid crystal layer comprising a liquid crystal composition between the first and second substrates, and a cured product of a thermally curable resin composition joining together the first and second substrates,
the liquid crystal composition comprising:
10% to 50% of a compound represented by general formula (I): 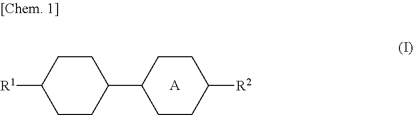
(wherein R¹ and R² are each independently an alkyl group of 1 to 8 carbon atoms, an alkenyl group of 2 to 8 carbon atoms, an alkoxy group of 1 to 8 carbon atoms, or an alkenyloxy group of 2 to 8 carbon atoms; and A is 1,4-phenylene or trans-1,4-cyclohexylene); and
35% to 80% by weight of a compound represented by general formula (II): 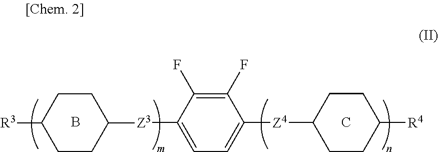
(wherein R³ and R⁴ are each independently an alkyl group of 1 to 8 carbon atoms, an alkenyl group of 2 to 8 carbon atoms, an alkoxy group of 1 to 8 carbon atoms, or an alkenyloxy group of 2 to 8 carbon atoms; Z³ and Z⁴ are each independently a single bond, —CH═CH—, —C≡C—, —CH₂CH₂—, —(CH₂)₄—, —COO—, —OCO—, —OCH₂—, —CH₂O—, —OCF₂—, or —CF₂O—; B and C are each independently optionally fluorinated 1,4-phenylene or trans-1,4-cyclohexylene; and m and n are each independently an integer of 0 to 4, wherein m+n=1 to 4),
the curable resin composition comprising a compound containing at least one epoxy group per molecule and having a weight average molecular weight of 300 to 10,000.

2. The liquid crystal display device according to claim 1, wherein the curable resin composition further comprises a thermal curing agent.

3. The liquid crystal display device according to claim 1, wherein the curable resin composition further comprises a silane coupling agent.

4. The liquid crystal display device according to claim 1, wherein the curable resin composition further comprises a filler.

5. The liquid crystal display device according to claim 1, wherein the curable resin composition further comprises resin particles.

6. The liquid crystal display device according to claim 1, wherein the curable resin composition has a hydrogen-bonding functional group value of 1×10⁴ to 5×10² mol/g.

7. The liquid crystal display device according to claim 1, wherein the compound containing at least one epoxy group per molecule and having a weight average molecular weight of 300 to 10,000 further contains at least one ethylenically unsaturated bond per molecule.

8. The liquid crystal display device according to claim 7, wherein the compound containing at least one epoxy group per molecule and having a weight average molecular weight of 300 to 10,000 contains at least one (meth)acrylic group per molecule.

9. The liquid crystal display device according to claim 8, wherein the compound containing at least one (meth)acrylic group and at least one epoxy group per molecule is a (meth)acrylic-modified epoxy resin and/or a urethane-modified (meth)acrylic epoxy resin.

10. The liquid crystal display device according to claim 1, wherein the curable resin composition further comprises a compound containing an ethylenically unsaturated bond.

11. The liquid crystal display device according to claim 10, wherein the curable resin composition comprises a compound containing a (meth)acryloyloxy group.

12. The liquid crystal display device according to claim 7, wherein the curable resin composition has a carbon-carbon double bond content of 1×10⁻³ to 5×10⁻³ mol/g.

13. The liquid crystal display device according to claim 8, wherein the curable resin composition has an epoxy-to-(meth)acrylic equivalent ratio of 15:85 to 95:5.

14. The liquid crystal display device according to claim 1, wherein the liquid crystal composition further comprises a compound represented by general formula (III): 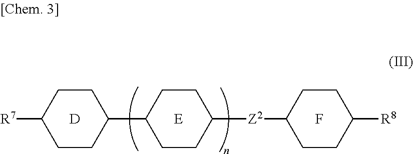
(wherein R⁷ and R⁸ are each independently an alkyl group of 1 to 8 carbon atoms, an alkenyl group of 2 to 8 carbon atoms, an alkoxy group of 1 to 8 carbon atoms, or an alkenyloxy group of 2 to 8 carbon atoms; D, E, and F are each independently optionally fluorinated 1,4-phenylene or trans-1,4-cyclohexylene; Z² is a single bond, —OCH₂—, —OCO—, —CH₂O—, or —COO—; and n is 0, 1, or 2, with the proviso that compounds represented by general formulas (I), (II-1), and (II-2) are excluded).

15. The liquid crystal display device according to claim 1, wherein the liquid crystal composition comprises at least one compound represented by general formula (I) wherein A is trans-1,4-cyclohexylene and at least one compound represented by general formula (I) wherein A is 1,4-phenylene.

16. The liquid crystal display device according to claim 1, wherein the liquid crystal composition comprises a compound represented by general formula (II-1) and/or a compound represented by general formula (II-2): 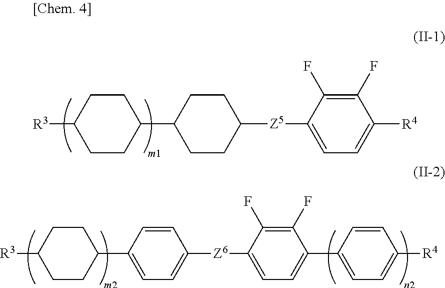
(wherein R³ and R⁴ are each independently an alkyl group of 1 to 8 carbon atoms, an alkenyl group of 2 to 8 carbon atoms, an alkoxy group of 1 to 8 carbon atoms, or an alkenyloxy group of 2 to 8 carbon atoms; Z⁵ and Z⁶ are each independently a single bond, —CH═CH—, —C≡C—, —CH₂CH₂—, —(CH₂)₄—, —COO—, —OCO—, —OCH₂—, —CH₂O—, —OCF₂—, or —CF₂O—; and m1, m2, and n2 are each independently 0 or 1).

17. The liquid crystal display device according to claim 1, wherein the liquid crystal composition has a rotational viscosity of 150 or less, a refractive index anisotropy of 0.08 to 0.13, and a Z of 13,000 or less, wherein Z is represented by the following equation:
Z=γ1/Δn² [Math. 1]
wherein γ1 is the rotational viscosity, and Δn is the refractive index anisotropy.

18. The liquid crystal display device according to claim 1, wherein the liquid crystal composition has an upper nematic liquid crystal phase temperature limit of 60° C. to 120° C., a lower nematic liquid crystal phase temperature limit of −20° C. or lower, and a difference between the upper and lower nematic liquid crystal phase temperature limits of 100 to 150.

19. The liquid crystal display device according to claim 1, wherein the liquid crystal composition has a resistivity of 10¹² Ω·m or more.

20. The liquid crystal display device according to claim 1, wherein the liquid crystal layer comprises a polymer of the liquid crystal composition, the liquid crystal composition further comprising a polymerizable compound represented by general formula (V): 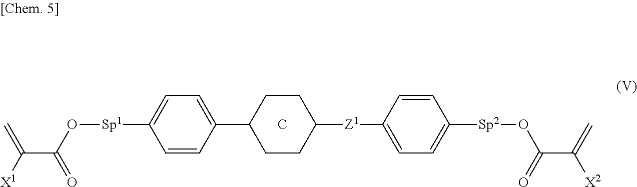
(wherein X¹ and X² are each independently hydrogen or methyl; Sp¹ and Sp² are each independently a single bond, an alkylene group of 1 to 8 carbon atoms, or —O—(CH₂)ₛ— (wherein s is an integer of 2 to 7, and the oxygen atom is attached to the aromatic ring); Z¹ is —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²— (wherein Y¹ and Y² are each independently fluorine or hydrogen), —C═C—, or a single bond; C is 1,4-phenylene, trans-1,4-cyclohexylene, or a single bond; and any hydrogen atom in any 1,4-phenylene group in the formula is optionally replaced with fluorine).

21. The liquid crystal display device according to claim 20, wherein C and Z¹ in general formula (V) are single bonds.
